(19) United States
(12) Patent Application Publication
(10) Pub. No.: US 2025/0106199 A1
(43) Pub. Date: Mar. 27, 2025

(54) SYSTEM, MANAGEMENT SYSTEM AND MANAGEMENT METHOD

(71) Applicant: TOYOTA JIDOSHA KABUSHIKI KAISHA, Toyota-shi (JP)

(72) Inventors: Teruyoshi FUJIWARA, Toyota-shi (JP); Iwao NITTA, Nagoya-shi (JP); Ryota SUZUKI, Ikeda-shi (JP)

(73) Assignee: TOYOTA JIDOSHA KABUSHIKI KAISHA, Toyota-shi (JP)

(21) Appl. No.: 18/815,348

(22) Filed: Aug. 26, 2024

(30) Foreign Application Priority Data
Sep. 22, 2023 (JP) 2023-159261

(51) Int. Cl. H04L 9/40

(52) U.S. Cl. CPC H04L 63/0823; H04L 63/20

(57) ABSTRACT

A management server according to an aspect of the present disclosure receives a first certificate and a second certificate from a terminal according to a use relation occurring between a first target and a second target and receives a first time limit certificate and a second time limit certificate from a server. The management server performs collation of the first certificate and the first time limit certificate and collation of the second certificate and the second time limit certificate to authenticate the targets. When both of the authentications of the first target and the second target are successful, the management server sets a correspondence relation between a first identifier and a second identifier.

### CROSS REFERENCE TO THE RELATED APPLICATION

This application claims the benefit of Japanese Patent Application No. 2023-159261, filed on Sep. 22, 2023, which is hereby incorporated by reference herein in its entirety.

### BACKGROUND

### Technical Field

The present disclosure relates to a management system, a management method, and a program.

### Description of the Related Art

Japanese Patent Application Laid-Open No. 2022-140747 proposes a charge collection system for collecting a charge for a service from a user of a vehicle using a medium such as a card. Specifically, the charge collection system proposed by Japanese Patent Application Laid-Open No. 2022-140747 is configured to allocate billing of a usage fee for a freeway by a target rent-a-car to a target user based on an ID of an ETC (Electronic Toll Collection System) card, a company of the rent-a-car, a date and time of use of the rent-a-car, and a correspondence relation (billing information, registration information, settlement information, and use information) of the user of the rent-a-car.

### SUMMARY

An object of the present disclosure is to provide a technique for, while ensuring security, tracking a use relation between a first target and a second target.

A management system according to a first aspect of the present disclosure includes a first server, a second server, and a management server. The first server is configured to issue a first time limit certificate in relation to a first identifier of a first target and notify the issued first time limit certificate to the management server. The second server is configured to issue a second time limit certificate in relation to a second identifier of a second target and notify the issued second time limit certificate to the management server. The management server is configured to, according to a use relation occurring between the first target and the second target, receive a first certificate corresponding to the first time limit certificate and a second certificate corresponding to the second time limit certificate from at least one of a first terminal of the first target and a second terminal of the second target, collate the received first certificate and the received second certificate and the first time limit certificate and the second time limit certificate notified from the first server and the second server, and set a correspondence relation between the first identifier and the second identifier when the collation is successful. The first time limit certificate and the second time limit certificate are configured to expire when an expiration date elapses.

A management method according to a second aspect of the present disclosure is an information processing method including a management server executing: receiving, from a first server, a first time limit certificate issued in relation to a first identifier of a first target, the first time limit certificate being configured to expire when an expiration date elapses; receiving, from a second server, a second time limit certificate issued in relation to a second identifier of a second target, the second time limit certificate being configured to expire when the expiration date elapses; receiving, according to a use relation occurring between the first target and the second target, a first certificate corresponding to the first time limit certificate and a second certificate corresponding to the second time limit certificate from at least one of a first terminal of the first target and a second terminal of the second target; collating the received first certificate and the received second certificate and the first time limit certificate and the second time limit certificate notified from the first server and the second server; and setting, when the collation is successful, a correspondence relation between the first identifier and the second identifier.

A program according to a third aspect of the present disclosure is a program for causing a first terminal of a first target to execute: transmitting, in relation to a first identifier of the first target, a request for issuance of a first time limit certificate to a first server; receiving the issued first time limit certificate from the first server; giving, in occurrence of a use relation between the first target and a second target, the received first time limit certificate to a second terminal of the second target as a first certificate to thereby cause the second terminal to transmit the first certificate to a management server; acquiring, in relation to a second identifier of the second target, from the second terminal, a second certificate corresponding to a second time limit certificate issued by a second server; and transmitting the acquired second certificate to the management server to request setting of a correspondence relation between the first identifier and the second identifier.

According to the present disclosure, it is possible to provide a technique for, while ensuring security, tracking a use relation between a first target and a second target.

### BRIEF DESCRIPTION OF THE DRAWINGS

FIG. 1 schematically illustrates an example of a scene to which the present disclosure is applied;

FIG. 2 schematically illustrates an example of a scene to which the present disclosure is applied;

FIG. 3A schematically illustrates an example of linking information according to an embodiment;

FIG. 3B schematically illustrates an example of user information according to the embodiment;

FIG. 3C schematically illustrates an example of mobile body information according to the embodiment;

FIG. 4A schematically illustrates an example of a process of linking release according to the embodiment;

FIG. 4B schematically illustrates an example of a simplified process of linking setting according to the embodiment;

FIG. 5 schematically illustrates an example of a use scene of the linking information according to the embodiment;

FIG. 6A schematically illustrates an example of a hardware configuration of a management server according to the embodiment;

FIG. 6B schematically illustrates an example of a hardware configuration of a first server according to the embodiment;

FIG. 6C schematically illustrates an example of a hardware configuration of a second server according to the embodiment;

FIG. 6D schematically illustrates an example of a hardware configuration of a first terminal according to the embodiment;

FIG. 6E schematically illustrates an example of a hardware configuration of a second terminal according to the embodiment;

FIG. 7 schematically illustrates an example of software configurations of the devices according to the embodiment;

FIG. 8A illustrates an example of a processing procedure of linking setting according to the embodiment;

FIG. 8B illustrates an example of a processing procedure of linking setting according to the embodiment;

FIG. 8C illustrates an example of a processing procedure of linking release according to the embodiment;

FIG. 9 schematically illustrates an example of a process of linking setting in a 1-1-th proxy pattern according to the embodiment;

FIG. 10 illustrates an example of a processing procedure of the linking setting in the 1-1-th proxy pattern according to the embodiment;

FIG. 11 schematically illustrates an example of a process of linking setting in a 1-2-th proxy pattern according to the embodiment;

FIG. 12 illustrates an example of a processing procedure of the linking setting in the 1-2-th proxy pattern according to the embodiment;

FIG. 13 schematically illustrates an example of a process of linking setting in a second proxy pattern according to the embodiment;

FIG. 14 illustrates an example of a processing procedure of the linking setting in the second proxy pattern according to the embodiment;

FIG. 15 schematically illustrates an example of a process of linking setting in a third proxy pattern according to the embodiment;

FIG. 16 illustrates an example of a processing procedure of agency imparting in the third proxy pattern according to the embodiment;

FIG. 17 schematically illustrates an example of a process of linking setting according to a modification;

FIG. 18 illustrates an example of a processing procedure of the linking setting according to the modification; and

FIG. 19 schematically illustrates another example of the process of the linking setting according to the modification.

### DESCRIPTION OF THE EMBODIMENTS

With the system proposed by Japanese Patent Application Laid-Open No. 2022-140747, a user can perform payment of a freeway toll by the ETC even if the user does not carry an ETC card of the user. However, the present inventors have found that the system of the related art has the following problems.

According to diversification of MaaS (Mobility as a Service), from the viewpoint of convenience such as efficiency of settlement, a demand for, while ensuring security, tracking use of a mobile body by a user is considered to occur. In contrast, in the system of the related art, a correspondence relation between a date and time of use and a user can be retained as use information according to a contrast or a reservation of a rent-a-car. However, since the date and time of use depends on the contract or the reservation, the use information does not always match an actual use of the rent-a-car by the user. In addition, in a vehicle (for example, a private vehicle) used without involving a contrast or a reservation, generation of use information is not assumed in the first place. Therefore, with the system of the related art, it is difficult to, while ensuring security, track use of the mobile body by the user. Note that this problem occurs not only in a scene in which a vehicle is used. The same problem can occur in a scene in which a mobile body (for example, an aircraft or a ship) other than the vehicle is used and a scene in which a plurality of types of mobile bodies are used. Further, the same problem can occur in all use scenes other than the use of the mobile body.

In contrast, a management system according to a first aspect of the present disclosure includes a first server, a second server, and a management server. The first server is configured to issue a first time limit certificate in relation to a first identifier of a first target and notify the issued first time limit certificate to the management server. The second server is configured to issue a second time limit certificate in relation to a second identifier of a second target and notify the issued second time limit certificate to the management server. The management server is configured to, according to a use relation occurring between the first target and the second target, receive a first certificate corresponding to the first time limit certificate and a second certificate corresponding to the second time limit certificate from at least one of a first terminal of the first target and a second terminal of the second target, collate the received first certificate and the received second certificate and the first time limit certificate and the second time limit certificate notified from the first server and the second server, and set a correspondence relation between the first identifier and the second identifier when the collation is successful. The first time limit certificate and the second time limit certificate are configured to expire when an expiration date elapses.

In the first aspect of the present disclosure, the authentications for the respective first and the second targets are performed using the time limit certificates according to the use relation occurring between the first target and the second target. The time limit certificates are configured to expire when the expiration date elapses. For that reason, it is possible to prevent the same certificates from being permanently used. Accordingly, it can be expected to ensure security. When both of the authentications for the first target and the second target are successful, a correspondence relation (linking) between the first identifier and the second identifier is set. By recording the linking setting, it is possible to track the use relation between the first target and the second target. Therefore, according to the first aspect of the present disclosure, it is possible to, while ensuring security, track the use relation between the first target and the second target.

Note that a mode of the present disclosure may not be limited to the example explained above. As another mode of the management system according to the aspect, an aspect of the present disclosure may be an information processing device, an information processing method, a program, or a storage medium storing such a program and readable by a machine such as a computer that implement all or some of the constituent elements explained above. Here, the storage medium readable by the machine is a medium that accumulates information such as a program with electrical, magnetic, optical, mechanical, or chemical action. The information processing device may be at least any one of the management server, the first server, and the second server according to the aspect explained above. An aspect of the present disclosure may be one of the first terminal and the second terminal relating to the management system according to the aspect explained above. At least one of the first terminal and the second terminal may be included in the management system according to the aspect explained above. Further, one aspect of the present disclosure may be an information processing method, a program, or a storage medium storing such a program that concern one of the first terminal and the second terminal.

For example, a management method according to a second aspect of the present disclosure may be an information processing method including a management server executing: receiving, from a first server, a first time limit certificate issued in relation to a first identifier of a first target, the first time limit certificate being configured to expire when an expiration date elapses; receiving, from a second server, a second time limit certificate issued in relation to a second identifier of a second target, the second time limit certificate being configured to expire when the expiration date elapses; receiving, according to a use relation occurring between the first target and the second target, a first certificate corresponding to the first time limit certificate and a second certificate corresponding to the second time limit certificate from at least one of a first terminal of the first target and a second terminal of the second target; collating the received first certificate and the received second certificate and the first time limit certificate and the second time limit certificate notified from the first server and the second server; and setting, when the collation is successful, a correspondence relation between the first identifier and the second identifier.

For example, a program according to a third aspect of the present disclosure may be a program for causing a first terminal of a first target to execute: transmitting, in relation to a first identifier of the first target, a request for issuance of a first time limit certificate to a first server; receiving the issued first time limit certificate from the first server; giving, in occurrence of a use relation between the first target and a second target, the received first time limit certificate to a second terminal of the second target as a first certificate to thereby cause the second terminal to transmit the first certificate to a management server; acquiring, in relation to a second identifier of the second target, from the second terminal, a second certificate corresponding to a second time limit certificate issued by a second server; and transmitting the acquired second certificate to the management server to request setting of a correspondence relation between the first identifier and the second identifier.

An embodiment according to an aspect of the present disclosure (hereinafter described as “the present embodiment” as well) is explained below with reference to the drawings. However, the present embodiment explained below is merely exemplification of the present disclosure in all points. Various improvements or modifications may be made without departing from the scope of the present disclosure. In implementation of the present disclosure, a specific configuration corresponding to the embodiment may be adopted as appropriate. Note that data appearing in the present embodiment is explained by a natural language. However, more specifically, the data is designated by a pseudo language, a command, a parameter, a machine language, or the like recognizable by a computer.

### 1 Application Example

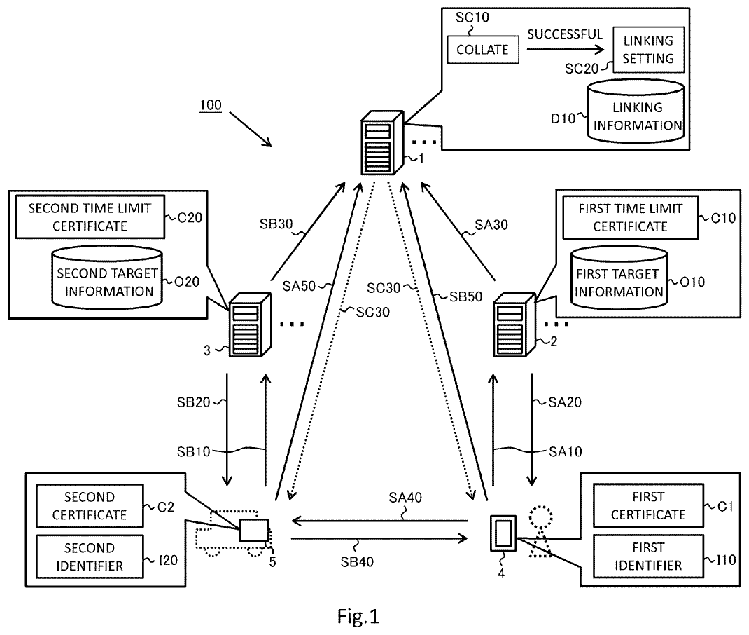

FIG. 1 schematically illustrates an example of a scene to which the present disclosure is applied. A management system 100 according to the present embodiment includes a management server 1, a first server 2, and a second server 3. The management server 1 is one or more computers configured to record a correspondence relation (linking) between a first target and a second target. The first server 2 is one or more computers configured to issue a time limit certificate of the first target. The second server 3 is one or more computers configured to issue a time limit certificate of the second target. The first server 2 and the second server 3 may be respectively referred to as authentication server, ID (Identification) server, or the like.

In the present embodiment, a first terminal 4 of the first target transmits a request for issuance of a first time limit certificate C10 to the first server 2 in relation to a first identifier I10 of the first target (step SA10). In response to reception of the request, the first server 2 issues the first time limit certificate C10 in relation to the first identifier I10 and returns the issued first time limit certificate C10 to the first terminal 4 (step SA20). In response to the return, the first terminal 4 receives the issued first time limit certificate C10 from the first server 2. The first terminal 4 stores the received first time limit certificate C10 to be usable as a first certificate C1. The first server 2 notifies the issued first time limit certificate C10 to the management server 1 as well (step SA30).

A second terminal 5 of the second target transmits a request for issuance of a second time limit certificate C20 to the second server 3 in relation to a second identifier I20 of the second target (step SB10). In response to reception of the request, the second server 3 issues the second time limit certificate C20 in relation to the second identifier I20 and returns the issued second time limit certificate C20 to the second terminal 5 (step SB20). In response to the return, the second terminal 5 receives the issued second time limit certificate C20 from the second server 3. The second terminal 5 stores the received second time limit certificate C20 to be usable as a second certificate C2. The second server 3 notifies the issued second time limit certificate C20 to the management server 1 as well (step SB30).

The first time limit certificate C10 and the second time limit certificate C20 are provided with an expiration date and are configured to expire when the expiration date elapses. Note that the time limit certificates (C10 and C20) may not always be issued in response to the requests (demands) from the terminals (4 and 5). The servers (2 and 3) may spontaneously generate the time limit certificates (C10 and C20). In this case, the processing in step SA10 and step SB10 may be omitted.

In the present embodiment, in occurrence of a use relation between the first target and the second target, data exchange is executed between the first terminal 4 and the second terminal 5 (step SA40 and step SB40). As a request for linking setting, the first certificate C1 and the second certificate C2 are submitted from at least one of the first terminal 4 and the second terminal 5 to the management server 1 to correspond to the first time limit certificate C10 and the second time limit certificate C20. Accordingly, the management server 1 receives, according to a use relation occurring between the first target and the second target, from at least one of the first terminal 4 and the second terminal 5, the first certificate C1 corresponding to the first time limit certificate C10 and the second certificate C2 corresponding to the second time limit certificate C20 (step SA50 and step SB50).

The management server 1 collates the received first certificate C1 and the received second certificate C2 and the first time limit certificate C10 and the second time limit certificate C20 notified from the first server 2 and the second server 3 (step SC10). Accordingly, the management server 1 executes authentication processing for the first target and the second target. When the collation is successful (that is, both of authentications for the first target and the second target are successful), the management server 1 sets a correspondence relation (linking) between the first identifier I10 and the second identifier I20 (step SC20). In an example, the management server 1 generates linking information D10 indicating the setting of the correspondence relation between the first identifier I10 and the second identifier I20 and stores the generated linking information D10. On the other hand, when the authentication for at least one of the first target and the second target is unsuccessful, the management server 1 may not set a correspondence relation between the first identifier I10 and the second identifier I20 and may omit processing for setting the correspondence relation. The management server 1 may return a result of the linking processing to at least one of the first terminal 4 and the second terminal 5 (step SC30). Note that a series of processing from the data exchange between the terminals (4 and 5) to the linking setting may be executed in real time according to occurrence of a use relation. The set linking (correspondence relation) may be released as appropriate according to extinction of the use relation between the first target and the second target. The setting a correspondence relation between the first identifier I10 and the second identifier I20 may be treated as setting a correspondence relation between the first target and the second target.

As explained above, in the present embodiment, the authentications for the respective first and the second targets are performed using the time limit certificates (C10 and C20) according to the use relation occurring between the first target and the second target (step SC10). The time limit certificates are configured to expire when the expiration date elapses. For that reason, it is possible to prevent the same certificates from being permanently used. Accordingly, it can be expected to ensure security. When both of the authentications for the first target and the second target are successful, a correspondence relation (linking) between the first identifier and the second identifier is set (step SC20). By recording the linking setting, it is possible to track a use relation between the first target and the second target. Therefore, according to the present embodiment, it is possible to, while ensuring security, track the use relation between the first target and the second target.

### (Targets)

If the use relation can be established, the first target and the second target may not be particularly limited and may be selected as appropriate according to an embodiment. The first target and the second target may be respectively any things such as objects, humans, or other organisms. Any things may include virtual things. The use relation being established may be a realistic or virtual relation occurring between at least two things, for example, one using the other, one owning the other, one being coupled to the other, or one being connected to the other. The management system 100 of the present disclosure may be used in any scene in which a correspondence relation between two or more things is tracked.

### (Terminals)

The terminals (4 and 5) relate to the targets. A relation between the terminals (4 and 5) and the targets may not be particularly limited and may be determined as appropriate according to an embodiment. In an example, one of the first terminal 4 and the second terminal 5 may be carried by the target corresponding thereto. One of the first terminal 4 and the second terminal 5 may be loaded on the target corresponding thereto. The being loaded may include, besides being always placed on the target, at least temporarily being placed on the target when the target is used. The loading may include a user of the target carrying the target. One of the first terminal 4 and the second terminal 5 may be the target itself.

Note that, concerning the terminals (4 and 5), a plurality of terminals may be used as terminals of the same target, for example, one user may share an account among the plurality of terminals. In this case, different terminals may be used when the time limit certificates are issued and when the linking is set. Among the plurality of terminals used as the terminals of the same target, a terminal that requests issuance of the time limit certificate may be different from a terminal that uses the time limit certificate as a certificate in the linking. The received time limit certificate may be shared among the plurality of terminals as appropriate (for example, downloaded from a server).

### (Time Limit Certificates)

The time limit certificates (C10 and C20) are configured to expire when the expiration date elapses. If it is possible to control the expiration due to the elapse of the expiration date, the configuration of the time limit certificates (C10 and C20) may not be particularly limited and may be selected as appropriate according to the embodiment. The time limit certificates (C10 and C20) may include any information. In an example, the time limit certificates (C10 and C20) may be configured by random numbers, timestamps, hash values, or the like. The time limit certificates (C10 and C20) may be configured by temporary information such as one-time passwords.

The expiration date of the time limit certificates (C10 and C20) may be managed as appropriate. The expiration due to the elapse of the expiration date may be specified as appropriate. For example, according to a deadline set in a time limit certificate having elapsed, a time limit certificate being added to an expiration list, a time limit certificate being deleted from an effective list, a time limit certificate being updated to a new time limit certificate, or information indicating expiration (for example, a timestamp) being imparted, it may be specified whether a time limit certificate of a target has been expired. When reference information such as the expiration list or the effective list is used for the management of the expiration date, the reference information may be stored in any main memory accessible from the management system 100. Typically, reference information of the time limit certificates (C10 and C20) may be stored in the servers (2 and 3) corresponding thereto.

Note that the issuance of the time limit certificate (C10 and C20) (steps SA10 to SA30 and steps SB10 to SB30) may be executed at any timing before the request for the linking setting (step SA50 and step SB50). In an example, the issuance of the time limit certificates (C10 and C20) may be executed beforehand before the data exchange between the first terminal 4 and the second terminal 5 is executed (step SA40 and step SB40) (see FIG. 1). In another example, the issuance of the time limit certificates (C10 and C20) may be executed at timing before the request for linking setting is transmitted after the data exchange between the first terminal 4 and the second terminal 5 is started. From the viewpoint of reducing the number of processes in the linking setting, the issuance of the time limit certificates (C10 and C20) is preferably executed at the former timing.

The certificates (C1 and C2) correspond to the time limit certificates (C10 and C20). A method of collating a certificate and a time limit certificate may be selected as appropriate according to a relation between the certificate and the time limit certificate. In an example, the time limit certificates (C10 and C20) may be directly used as the certificates (C1 and C2). In this case, success of the collation in the authentication may be determined according to whether the time limit certificates (C10 and C20) and the certificates (C1 and C2) coincide. In the present embodiment, a mode in which the time limit certificates (C10 and C20) are directly used as the certificates (C1 and C2) is explained. However, a mode of the certificates (C1 and C2) may not be limited to such an example. In another example, the time limit certificates (C10 and C20) may be optionally converted and the time limit certificates (C10 and C20) after the conversion may be used as the certificates (C1 and C2). In this case, success of the collation in the authentication may be determined according to whether a predetermined relationship is established between the time limit certificates (C10 and C20) and the certificates (C1 and C2). For example, the first time limit certificate C10 may be converted into a hash value and the obtained hash value may be used as the first certificate C1. Accordingly, whether the relationship is established may be determined according to whether the hash value of the first time limit certificate C10 and the first certificate C1 coincide. The conversion may include data operation such as deletion and addition. At least one of the first time limit certificate C10 and the second time limit certificate C20 may be directly used as a certificate and the other may be used as a certificate after being converted. Note that the conversion processing may be executed by the terminals (4 and 5) or may be executed by the servers (2 and 3). When the conversion processing is executed by the servers (2 and 3), the terminals (4 and 5) may receive the time limit certificates (C10 and C20) after the conversion from the servers (2 and 3).

### (Identifiers)

The identifiers (I10 and I20) are used to identify the targets. If the targets can be identified, a data format and a configuration of the identifiers (I10 and I20) are not particularly limited and may be selected as appropriate according to an embodiment. In an example, the identifiers (I10 and I20) may be configured by symbol strings including numbers and characters.

As the identifiers (I10 and I20), information such as identification information uniquely imparted to the targets or information deriving from the terminals may be used. The uniquely imparted identification information may be, for example, a car registration number, a vehicle identification number (VIN), or a personal ID number. When IC tags are imparted to the targets, the uniquely imparted identification information may include information retained by the IC tags. The information deriving from the terminals may be, for example, a MAC address (Media Access Control address) or terminal identification information (IMEI: International Mobile Equipment Identifier, IMSI: International Mobile Subscriber Identity, MEID: Mobile Equipment Identifier, ICCID: Integrated Circuit Card ID, another serial number, or the like).

The identifiers (I10 and I20) may be acquired as appropriate. In an example, at least one of the first identifier I10 and the second identifier I20 may be retained in advance in the terminal corresponding thereto. In another example, at least one of the first identifier I10 and the second identifier I20 may be acquired by any device such as an input device or a sensor. For example, the identifier may be acquired by input via the input device. For example, the identifier may be converted into a code. The identifier may be obtained by reading (decoding) the code.

### (First Server/Second Server)

The first server 2 and the second server 3 may each be configured by one or more server devices. The first server 2 and the second server 3 may be respectively configured to be accessible to target information (O10 and O20) concerning the targets. The respective kinds of target information (O10 and O20) may be retained in one or more main memories disposed on at least one of the inside and the outside of the servers (2 and 3). The respective kinds of target information (O10 and O20) may be managed by the servers (2 and 3).

In an example, the issued time limit certificates (C10 and C20) may be stored in correlation with the target information (O10 and O20) corresponding thereto. However, the time limit certificates (C10 and C20) do not always have to be stored. The time limit certificates (C10 and C20) may be deleted after being transmitted to the terminals (2 and 3) and the management server 1. One of the first time limit certificate C10 and the second time limit certificate C20 may be stored and the other may be deleted.

A unit for managing the respective kinds of target information (O10 and O20) may not be particularly limited and may be determined as appropriate according to an embodiment. At least one of the first target information O10 and the second target information O20 may be collectively (integrally) managed or may be dispersedly (individually) managed for each certain group. Server devices configuring the servers (2 and 3) may be disposed by one or more operating institutions (entities). At least one of the first server 2 and the second server 3 may be disposed by a plurality of operating institutions. When at least one of the first server 2 and the second server 3 is disposed by the plurality of operating institutions, the target information may be shared (that is, collectively managed) or may be dispersedly managed by each of the operating institutions.

### (Management Server)

The management server 1 may be configured by one or more server devices. The management server 1 of the present disclosure is configured to record, as the linking information D10, information concerning occurrence and extinction of a correspondence relation between the first target and the second target. The linking information D10 may be retained in one or more main memories disposed on at least one of the inside and the outside of the management server 1.

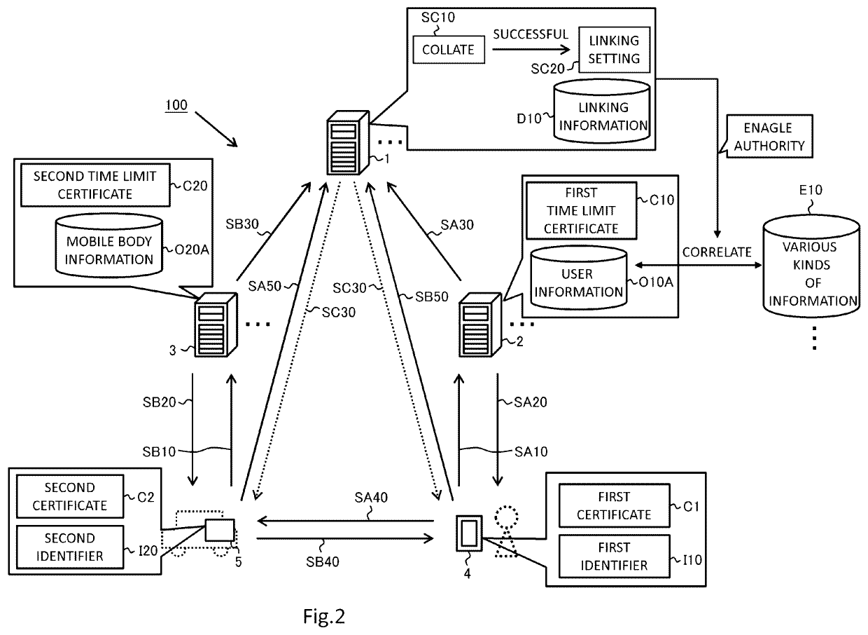

The obtained linking information D10 may be used in various scenes. In an example, the linking information D10 may be used in order to track a relation between the first target and the second target. As a specific example, the linking information D10 may be used to, while a correspondence relation between the first target and the second target is set, make it possible to exercise an authority linked with one of the first target and the second target (the first target information O10 and the second target information O20) from the other. That is, the linking information D10 may be used to enable, according to linking of the first target and the second target, an authority of one of the first target and the second target to be exercised from the other (FIG. 2 referred to later).

In the present embodiment, the linking information D10 includes information concerning the first identifier I10 and the second identifier I20 in order to indicate a combination of the first target and the second target for which a correspondence relation is set. The management server 1 may acquire the identifiers (I10 and I20) of the targets as appropriate. In an example, the management server 1 may not retain, in advance, information concerning the first identifier I10 and the second identifier I20 for which a correspondence relation is set and may acquire the information every time from at least any one of the servers (2 and 3) and the terminals (4 and 5). In another example, the management server 1 may retain, in advance, information concerning at least one of the first identifier I10 and the second identifier I20 for which a correspondence relation is set.

Note that a relation between operating institutions of the management server 1 and the servers (2 and 3) may be optional. In an example, the operating institution of the management server 1 may overlap the operating institution of at least one of the first server 2 and the second server 3. In another example, the operating institution of the management server 1 may be different from the operating institutions of the first server 2 and the second server 3. The management system 100 of the present disclosure may be produced by the management server 1 being connected to the servers (2 and 3) and the terminals (4 and 5) via a network and the servers (2 and 3) and the terminals (4 and 5) being respectively disposed in states of capable of executing the information processing explained above according to an intention of the operating institution of the management server 1.

### (Association of the Time Limit Certificates)

In the present embodiment, the management server 1 receives, among data used for authentication for the first target, the first time limit certificate C10 from the first server 2 and receives, among the data, the first certificate C1 from at least one of the first terminal 4 and the second terminal 5. Similarly, the management server 1 receives, among data used for authentication for the second target, the second time limit certificate C20 from the second server 3 and receives, among the data, the second certificate C2 from at least one of the first terminal 4 and the second terminal 5. When a mode in which the time limit certificates (C10 and C20) are transmitted in advance from the servers (2 and 3) to the management server 1 is adopted, the management server 1 may specify, as appropriate, association of data to be collated. The specifying association of data to be collated is discriminating a combination of the first time limit certificate C10 and the first certificate C1 to be collated and a combination of the second time limit certificate C20 and the second certificate C2 to be collated.

In an example, data for receiving the time limit certificates (C10 and C20) in a server route in step SA30 and step SB30 and data for receiving the certificates (C1 and C2) in a terminal route in step SA50 and step SB50 may include shared information for specifying association. The shared information may be configured by information having a relationship of, for example, coinciding or a correspondence relation being established. The management server 1 may specify association of the data according to a relationship being established between the pieces of shared information included in the data received from the routes and collate the associated time limit certificates (C10 and C20) and certificates (C1 and C2) to execute authentication processing for the targets.

The shared information may be optionally configured. In an example, the shared information may be configured by the identifiers (I10 and I20). The first server 2 may transmit the first time limit certificate C10 to the management server 1 with the first identifier I10 added thereto. The second server 3 may transmit the second time limit certificate C20 to the management server 1 with the second identifier I20 added thereto. At least one of the first terminal 4 and the second terminal 5 may transmit the first identifier I10 and the second identifier I20 together with the first certificate C1 and the second certificate C2. The management server 1 may specify, according to coincidence of the first identifiers I10 included in the data received from the server route and the terminal route, a combination of the first time limit certificate C10 and the first certificate C1 to be collated. Similarly, the management server 1 may specify, according to coincidence of the second identifiers I20 included in the data received from the server route and the terminal route, a combination of the second time limit certificate C20 and the second certificate C2 to be collated. In another example, the shared information may be configured by any information other than the identifiers (I10 and I20). For example, the shared information may be configured by temporary information such as rando numbers, timestamps, or hash values. The shared information may be shared at any timing. In a typical example, the shared information may be shared between the terminals (4 and 5) and the servers (2 and 3) when the time limit certificates (C10 and C20) are issued. The management server 1 may specify association according to a relationship being established between the pieces of shared information included in the data received from the routes. The shared information may be configured by the identifiers (I10 and I20) and any other information.

An entity that executes the association may not be limited to the management server 1. At least one of the first time limit certificate C10 and the second time limit certificate C20 may be transmitted from the server (2 or 3) corresponding thereto to the management server 1 (step SA30 and step SB30) after the management server 1 receives the certificate (C1 or C2) corresponding thereto (step SA50 or step SB50). In this case, the association may be executed on the corresponding server (2 or 3) side. As an example, after receiving the first certificate C1 from at least one of the first terminal 4 and the second terminal 5, the management server 1 may transmit an inquiry including, as a query, shared information added to the first certificate C1 to the first server 2. The shared information may be the same as the shared information explained above. The first server 2 may retain the first time limit certificate C10 in correlation with the shared information. For example, when the shared information includes the first identifier I10, the first server 2 may retain the first time limit certificate C10 in correlation with the first target information O10. The first server 2 may extract the relevant first time limit certificate C10 in response to the inquiry from the management server 1 and return the extracted first time limit certificate C10 to the management server 1. This extracting processing is an example of association. Accordingly, the management server 1 may acquire the first time limit certificate C10 to be collated with the first certificate C1. The same applies to the second time limit certificate C20 and the second certificate C2.

Note that this association processing may not always be executed. In another example, the management server 1 may retain, as a date group, the time limit certificates (C10 and C20) notified from the servers (2 and 3). The management server 1 may extract, from the data group, the first time limit certificate C10 successfully collated with the received first certificate C1 and may determine success of the collation concerning the first target according to whether the first time limit certificate C10 is extracted. The management server 1 may extract, from the data group, the second time limit certificate C20 successfully collated with the received second certificate C2 and may determine success of the collation concerning the second target according to whether the second time limit certificate C20 is extracted.

### (Operation Cases)

In an example, one of the first target and the second target may be a user. Of the first terminal 4 and the second terminal 5, one terminal corresponding to the user may be a user terminal relating to the user. The other of the first target and the second target may be an object to be used by the user. Of the first terminal 4 and the second terminal 5, one terminal corresponding to the object to be used may be a loading terminal loaded on the object to be used. According to an example of the present embodiment, it is possible to, while ensuring security, track a use relation between the user and the object to be used.

If the object to be used can be used by the user, a type of the object to be used may not be particularly limited and may be selected as appropriate according to an embodiment. In an example, the object to be used may be a mobile body (mobility). According to an example of the present embodiment, a use relation between the user and the mobile body can be tracked. Note that a type of the mobile body may be selected as appropriate. The mobile body may be, for example, a vehicle, a railroad vehicle, an aircraft (an airplane, a drone, or the like), or a ship. The mobile body may be at least one of a manned aircraft that is manually controlled and an unmanned aircraft that is automatically controlled. When the mobile body is a vehicle, a type of the vehicle may be optionally selected. The type of the vehicle may be selected from, for example, a motorcycle, a tricycle, and a four-wheeled vehicle. The vehicle may include a private vehicle, a rent-a-car, a shared car, a taxi, and a bus. The vehicle may be at least one of an automatic driving vehicle and a manual driving vehicle. The loading terminal may be called a mobile body terminal.

FIG. 2 schematically illustrates an example of a scene to which the management system 100 of the present disclosure is applied. In the example illustrated in FIG. 2, the first target is the user and the second target is the mobile body. In the following explanation concerning a case of FIG. 2, for convenience, “first” is treated as relating to the user and “second” is treated as relating to the mobile body. However, a correspondence relation between the “first” and the “second” may not be limited to the example illustrated in FIG. 2. The “first” and the “second” may be changed. That is, the second target may be the user and the first target may be the mobile body.

When the first target is the user, an example of the first terminal 4 is a user terminal. The user terminal may be any computer such as a portable terminal (a smartphone or the like), a dedicated device (an electronic key device or the like), or another computer device. Typically, the user terminal may be carried by a user who is a linking target (a first target). An account of the user may be shared among a plurality of computers. Accordingly, the computers sharing the account may be used as user terminals (first terminals 4) of the same user.

An example of the first identifier I10 is a user identifier (a user ID or a My ID). The user identifier may be, for example, an ID of a user account, a personal ID number, or identification information (for example, a MAC address or terminal identification information) of a user terminal.

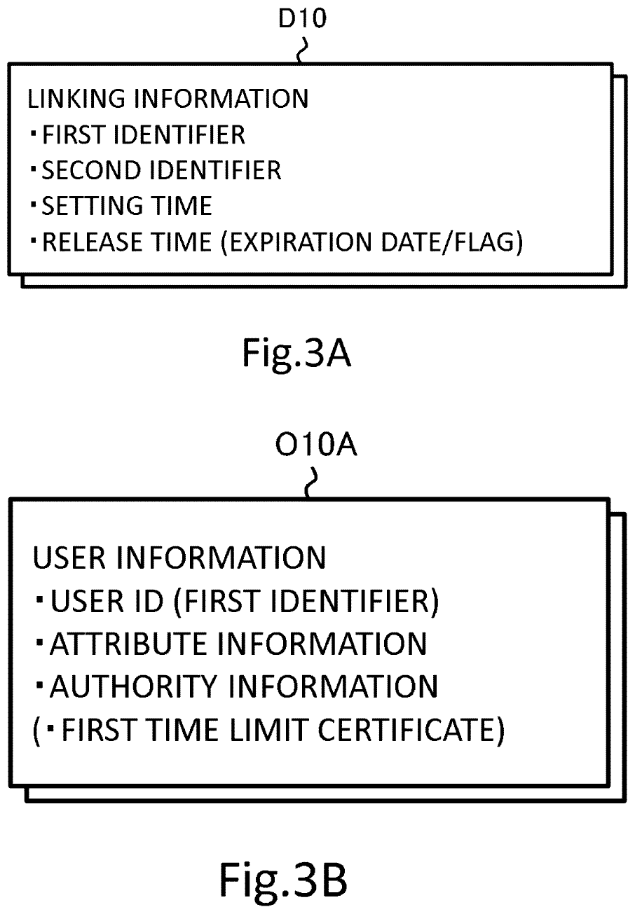

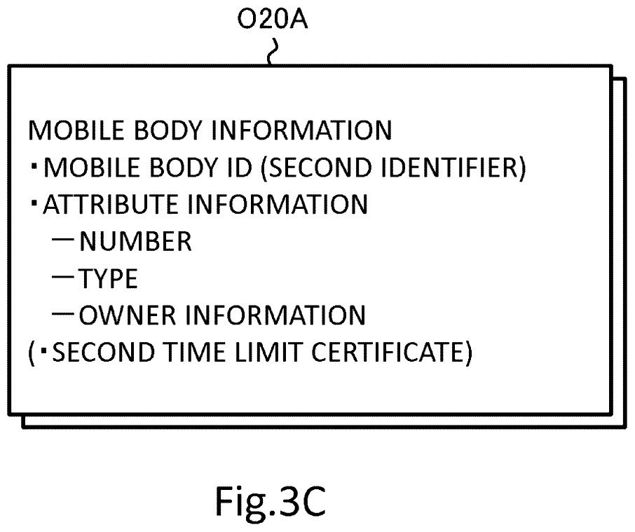

An example of the first target information O10 is user information O10A. The user information O10A may include any information concerning the user (FIG. 3B referred to later). In an example, the user information O10A may include information concerning an authority of the user corresponding thereto to be correlated with various kinds of information E10 for exercising the authority. The various kinds of information E10 may include, for example, information of public personal authentication, settlement information, and other service system information. The information of the public personal authentication may include, for example, a personal ID number. The settlement information may include, for example, information of a credit card, information of Internet banking, and information of electronic settlement. The other service system information may include, for example, information concerning an electronic prescription (an insurer number, prescription information, and the like). The various kinds of information E10 may be managed by an external system or may be managed in the management system 100. Note that the first server 2 may be disposed by a public institution, a neutral institution, companies (a vehicle manufacturer, a service operation company, and the like), or the like. The first server 2 may be called a user ID server, a My ID server, or the like.

On the other hand, when the second target is the mobile body, an example of the second terminal 5 is a mobile body terminal (a loading terminal). The mobile body terminal may be, for example, a terminal attached to the inside or the outside of the mobile body, a terminal carried by a human (for example, a driver or a conductor) involved in operation of the mobile body, or equipment (for example, a ticket gate) disposed in a facility of the mobile body. When the mobile body is a vehicle, the mobile body terminal may be called an in-vehicle terminal.

An example of the second identifier I20 is a mobile body identifier (a mobile body ID or a car ID). The mobile body identifier may be, for example, an ID of a mobile body account, identification information (for example, a car registration number or vehicle identification information) uniquely imparted to a target mobile body, or identification information of a mobile body terminal.

An example of the second target information O20 is mobile body information O20A. The mobile body information O20A may include any information concerning a mobile body (FIG. 3C referred to later). In the example illustrated in FIG. 2, according to linking setting between the user and the mobile body, at least some of authorities of the various kinds of information E10 correlated with the user information O10A being exercised by the mobile body may be enabled (activated). Note that the second server 3 may be disposed by a public institution, a neutral institution, companies (a vehicle manufacturer, a service operation company, and the like), or the like. The second server 3 may be called a mobile body ID server, a car ID server, or the like.

The mobile body is an example of an object to be used. A mode illustrated in FIG. 2 may be applied to any case in which a user (an occupant) of the object to be used dynamically fluctuates. The object to be used may be, other than the mobile body, for example, a rental thing or a lodging facility. The rental thing may include a rental office and a rental space.

The management system 100 may be configured to set linking between the first identifier I10 and the second identifier I20 according to a use start of the object to be used and release the linking according to a use end. The start and the end of the use may be detected by any method at timing such as timing of getting in and out of the vehicle or lending and returning of the object to be used. In an example, at least one of the start and the end of the use may be detected according to execution of data exchange between the first terminal 4 and the second terminal 5.

Note that the object to be used can be divided into at least two types including an object that can be repeatedly used for a long time and an object that can be temporarily used. For convenience of explanation, the former is referred to as “object to be always used” and the latter is referred to as “object to be temporarily used”. An example of the object to be always used is a property of the user such as a private car. An example of the object to be temporarily used is an object owned by a person other than the user such as a rent-a-car, a shared car, a mobile body of a public transportation, a rental thing, or a lodging facility. The mobile body of the public transportation is, for example, a taxi, a bus, a railroad vehicle, an airplane, or a ship.

In the management system 100, the type (the object to be always used or the object to be temporarily used) of the object to be used may be distinguished or may not be distinguished. When the type of the object to be used is distinguished, the management system 100 may discriminate the type of the object to be used with any method. In an example, the target information (the mobile body information or the like) may include information indicating the type of the object to be used. The management system 100 may discriminate the type of the object to be used with this information. In another example, the type of the object to be used may be discriminated from an identifier. In another example, the information indicating the type of the object to be used may be included in information transmitted from at least one of the first terminal 4 and the second terminal 5 to the management server 1. The management system 100 may discriminate the type of the object to be used with this information. In another example, when an operating institution of a server (in the example illustrated in FIG. 2, the second server 3) that treats information concerning the object to be used is determined according to the type of the object to be used, the type of the object to be used may be discriminated according to a department of the operating institution of the server.

The management system 100 may switch, for example, processing of linking setting, a condition for linking release, a management method for the linking information D10, and a mode of authentication processing or the like according to the discriminated type of the object to be used. In an example, the management system 100 may be configured to execute the linking setting on objects to be used of some of types according to the authentication processing of the present disclosure and execute the linking setting on objects to be used of the remaining types according to authentication processing different from the authentication processing of the present disclosure.

Note that an application scene of the management system 100 of the present disclosure may not be limited to the scene in which the relation between the user and the object to be used is tracked. In another example, both of the first target and the second target may be robot devices configured to autonomously operate according to automatic control. The robot device may include mobile bodies such as an automatic driving vehicle and a drone. In a scene in which two or more robot devices autonomously perform interaction, the management system 100 of the present disclosure may be used to track occurrence and extinction of a relation among the robot devices.

As a specific example, one of the first target and the second target may be a large automatic driving vehicle and the other may be a small automatic driving vehicle. The large automatic driving vehicle may be configured to be capable of housing a plurality of small automatic driving vehicles. The large automatic driving vehicle may collect, transport, and release the small automatic driving vehicles as appropriate. The small automatic driving vehicles may be operated as appropriate at release destinations. In this case, the management system 100 of the present disclosure may be configured to perform setting and release of a correspondence relation between the large automatic driving vehicle and the small automatic driving vehicles to track whether the small automatic driving vehicles are being transported (have been collected).

### (Transmission Forms of Respective Kinds of Information)

In an example, at least one of the first terminal 4 and the second terminal 5 may transmit the identifiers (I10 and I20) together with the certificates (C1 and C2) in order to designate the first target and the second target for which the linking setting is requested. That is, receiving the first certificate C1 and the second certificate C2 from at least one of the first terminal 4 and the second terminal 5 may include receiving the first identifier I10 and the second identifier I20 from at least one of the first terminal 4 and the second terminal 5. In this case, sharing of data transmission of the first identifier I10, the first certificate C1, the second identifier I20, and the second certificate C2 may not be particularly limited and may be determined as appropriate according to an embodiment.

### (A) Divided Transmission

### (A-1) Divided Pattern

In an example, the first terminal 4 may transmit some of the first certificate C1, the second identifier I20, and the second certificate C2 and the second terminal 5 may transmit the remainder. Accordingly, since the terminals (4 and 5) dividedly take charge of the data transmission, efficiency of the data transmission can be expected. Note that transmission items of the terminals (4 and 5) may be selected as appropriate according to an embodiment. In the present embodiment, as a typical example, at least any one of the following four patterns may be adopted.

### (A-1-1) First Pattern

In a first pattern, the first terminal 4 may transmit the second identifier I20 and the second certificate C2 and the second terminal 5 may transmit the first identifier I10 and the first certificate C1. That is, receiving the first certificate C1 and the second certificate C2 from at least one of the first terminal 4 and the second terminal 5 may be configured by receiving the second identifier I20 and the second certificate C2 from the first terminal 4 and receiving the first identifier I10 and the first certificate C1 from the second terminal 5.

Note that in the examples illustrated FIG. 1 and FIG. 2, it is assumed that, as the processing in step SA40, the second terminal 5 acquires the first identifier I10 and the first certificate C1 and, as the processing in step SA50, the second terminal 5 transmits the first identifier I10 and the first certificate C1. It is assumed that, as the processing in step SB40, the first terminal 4 acquires the second identifier I20 and the second certificate C2 and, as the processing in step SB50, the first terminal 4 transmits the second identifier I20 and the second certificate C2.

In the occurrence of the use relation between the first target and the second target, during data exchange with the second terminal 5, in relation to the first identifier I10, the first terminal 4 may give the first time limit certificate C10 issued by the first server 2 to the second terminal 5 as the first certificate C1 (step SA40). The first terminal 4 may give the first identifier I10 to the second terminal 5 (step SA40). Accordingly, the first terminal 4 may cause the second terminal 5 to transmit the first identifier I10 and the first certificate C1 to the management server 1 (step SA50). During the data exchange, in relation to the second identifier I20, the first terminal 4 may acquire, from the second terminal 5, the second certificate C2 corresponding to the second time limit certificate C20 issued by the second server 3 (step SB40). The first terminal 4 may acquire the second identifier I20 from the second target (step SB40). The first terminal 4 may transmit the acquired second identifier I20 and the acquired second certificate C2 to the management server 1 (step SB50). Accordingly, the first terminal 4 may request the management server 1 to set a correspondence relation (linking) between the first identifier I10 and the second identifier I20. That is, the first terminal 4 may cause the management server 1 to attempt authentication for the first target by collation of the first certificate C1 and authentication for the second target by collation of the second certificate C2 (step SC10) and, when both of the authentications (collations) for the first target and the second target are successful, cause the management server 1 to set a correspondence relation between the first identifier I10 and the second identifier I20 (step SC20).

In the occurrence of the use relation between the first target and the second target, during data exchange with the first terminal 4, in relation to the second identifier I20, the second terminal 5 may give the second time limit certificate C20 issued by the second server 3 to the first terminal 4 as the second certificate C2. The second terminal 5 may give the second identifier I20 to the first terminal 4. Accordingly, the second terminal 5 may cause the first terminal 4 to transmit the second identifier I20 and the second certificate C2 to the management server 1. During the data exchange, in relation to the first identifier I10, the second terminal 5 may acquire, from the first terminal 4, the first certificate C1 corresponding to the first time limit certificate C10 issued by the first server 2. The second terminal 5 may acquire the first identifier I10 from the first target. The second terminal 5 may transmit the acquired first identifier I10 and the acquired first certificate C1 to the management server 1. Accordingly, the second terminal 5 may request the management server 1 to set a correspondence relation between the first identifier I10 and the second identifier I20. That is, the second terminal 5 may cause the management server 1 to attempt authentication for the first target by collation of the first certificate C1 and authentication for the second target by collation of the second certificate C2 and, when both of the authentications for the first target and the second target are successful, cause the management server 1 to set a correspondence relation between the first identifier I10 and the second identifier I20.

In an example of the present embodiment, the second terminal 5 takes charge of transmission of data concerning the first target and the first terminal 4 takes charge of transmission of data concerning the second target. Accordingly, by causing the terminals (4 and 5) to acquire information concerning a counterparty of the use relation, it is possible to improve likelihood of the use relation occurring between the first target and the second target and, as a result, it is possible to expect improvement of the reliability of the linking information D10.

### (A-1-2) Second Pattern

In a second pattern, the first terminal 4 may transmit the first identifier I10 and the second certificate C2 and the second terminal 5 may transmit the second identifier I20 and the first certificate C1. That is, receiving the first certificate C1 and the second certificate C2 from at least one of the first terminal 4 and the second terminal 5 is configured by receiving the first identifier I10 and the second certificate C2 from the first terminal 4 and receiving the second identifier I20 and the first certificate C1 from the second terminal 5.

In the occurrence of the use relation between the first target and the second target, during data exchange with the second terminal 5, the first terminal 4 may give the first time limit certificate C10 to the second terminal 5 as the first certificate C1. Accordingly, the first terminal 4 may cause the second terminal 5 to transmit the first certificate C1 (and the second identifier I20) to the management server 1. During the data exchange, the first terminal 4 may acquire the second certificate C2 corresponding to the second time limit certificate C20 from the second terminal 5. The first terminal 4 may transmit the acquired second certificate C2 (and the first identifier I10) to the management server 1. Accordingly, the first terminal 4 may request the management server 1 to set a correspondence relation between the first identifier I10 and the second identifier I20.

In the occurrence of the use relation between the first target and the second target, during data exchange with the first terminal 4, the second terminal 5 may give the second time limit certificate C20 to the first terminal 4 as the second certificate C2. Accordingly, the second terminal 5 may cause the first terminal 4 to transmit the second certificate C2 (and the first identifier I10) to the management server 1. During the data exchange, the second terminal 5 may acquire the first certificate C1 corresponding to the first time limit certificate C10 from the first terminal 4. The second terminal 5 may transmit the acquired first certificate C1 (and the second identifier I20) to the management server 1. Accordingly, the second terminal 5 may request the management server 1 to set a correspondence relation between the first identifier I10 and the second identifier I20.

In an example of the present embodiment, as in the first pattern explained above, since the second terminal 5 takes charge of transmission of a part of data concerning the first target and the first terminal 4 takes charge of transmission of a part of data concerning the second target, it is possible to improve likelihood of a use relation occurring between the first target and the second target. As a result, it is possible to expect improvement of the reliability of the linking information D10.

In addition, in an example of the present embodiment, the second identifier I20 may be prevented from being transmitted from the first terminal 4 to the management server 1 and the first identifier I10 may be prevented from being transmitted from the second terminal 5 to the management server 1. Accordingly, it is possible to avoid data transmission by a format indicating a correspondence relation between data used for authentications for the targets (“the first identifier I10 and the first certificate C1” and “the second identifier I20 and the second certificate C2”). As a result, the correspondence relation between the data used for the authentications for the targets cannot be specified only from one of the data transmission of the first terminal 4 and the data transmission of the second terminal 5. Therefore, it is possible to expect further improvement of security.

### (A-1-3) Third Pattern

In a third pattern, the first terminal 4 may transmit the second identifier I20 and the first certificate C1 and the second terminal 5 may transmit the first identifier I10 and the second certificate C2. That is, receiving the first certificate C1 and the second certificate C2 from at least one of the first terminal 4 and the second terminal 5 may be configured by receiving the second identifier I20 and the first certificate C1 from the first terminal 4 and receiving the first identifier I10 and the second certificate C2 from the second terminal 5.

In the occurrence of the use relation between the first target and the second target, during data exchange with the second terminal 5, the first terminal 4 may give the first identifier I10 to the second terminal 5. Accordingly, the first terminal 4 may cause the second terminal 5 to transmit the first identifier I10 (and the second certificate C2) to the management server 1. The first terminal 4 may acquire the second identifier I20 from the second target during the data exchange. The first terminal 4 may transmit the acquired second identifier I20 (and the first certificate C1) to the management server 1. Accordingly, the first terminal 4 may request the management server 1 to set a correspondence relation between the first identifier I10 and the second identifier I20.

In the occurrence of the use relation between the first target and the second target, during data exchange with the first terminal 4, the second terminal 5 may give the second identifier I20 to the first terminal 4. Accordingly, the second terminal 5 may cause the first terminal 4 to transmit the second identifier I20 (and the first certificate C1) to the management server 1. The second terminal 5 may acquire the first identifier I10 from the first target during the data exchange. The second terminal 5 may transmit the acquired first identifier I10 (and the second certificate C2) to the management server 1. Accordingly, the second terminal 5 may request the management server 1 to set a correspondence relation between the first identifier I10 and the second identifier I20.

In an example of the present embodiment, as in the first pattern explained above, since the second terminal 5 takes charge of transmission of a part of data concerning the first target and the first terminal 4 takes charge of transmission of a part of data concerning the second target, it is possible to improve likelihood of a use relation occurring between the first target and the second target. As a result, it is possible to expect improvement of the reliability of the linking information D10.

In addition, in an example of the present embodiment, the first identifier I10 may be prevented from being transmitted from the first terminal 4 to the management server 1 and the second identifier I20 may be prevented from being transmitted from the second terminal 5 to the management server 1. Accordingly, as in the second pattern, it is possible to avoid data transmission by a format indicating a correspondence relation between data used for authentications for the targets. As a result, the correspondence relation between the data used for the authentications for the targets cannot be specified only from one of the data transmission of the first terminal 4 and the data transmission of the second terminal 5. Therefore, it is possible to expect further improvement of security.

### (A-1-4) Fourth Pattern

In a fourth pattern, the first terminal 4 may transmit the first identifier I10 and the first certificate C1 and the second terminal 5 may transmit the second identifier I20 and the second certificate C2. That is, receiving the first certificate C1 and the second certificate C2 from at least one of the first terminal 4 and the second terminal 5 may be configured by receiving the first identifier I10 and the first certificate C1 from the first terminal 4 and receiving the second identifier I20 and the second certificate C2 from the second terminal 5.

In the occurrence of the use relation between the first target and the second target, according to data exchange with the second terminal 5, the first terminal 4 may cause the second terminal 5 to transmit the second identifier I20 and the second certificate C2 to the management server 1. The first terminal 4 may transmit the first identifier I10 and the first certificate C1 to the management server 1. Accordingly, the first terminal 4 may request the management server 1 to set a correspondence relation between the first identifier I10 and the second identifier I20.

In the occurrence of the use relation between the first target and the second target, according to data exchange with the first terminal 4, the second terminal 5 may cause the first terminal 4 to transmit the first identifier I10 and the first certificate C1 to the management server 1. The second terminal 5 may transmit the second identifier I20 and the second certificate C2 to the management server 1. Accordingly, the second terminal 5 may request the management server 1 to set a correspondence relation between the first identifier I10 and the second identifier I20.

According to an example of the present embodiment, since the first terminal 4 takes charge of transmission of data concerning the first target and the second terminal 5 takes charge of transmission of data concerning the second target, it is possible to expect efficiency of data transmission.

### (A-1-5) Others

Note that the transmission items of the terminals (4 and 5) may not be limited to the four patterns explained above. In another example, one of the first terminal 4 and the second terminal 5 may transmit the first certificate C1 and the second certificate C2 and the other may transmit the first identifier I10 and the second identifier I20. A transmission unit of the terminals (4 and 5) may not always coincide with a unit of the identifiers (I10 and I20) and the certificates (C1 and C2). For example, the first terminal 4 and the second terminal 5 may divide and transmit data concerning at least any one of the items, for example, one of the first terminal 4 and the second terminal 5 may transmit a part of the first certificate C1 and the other may transmit the remainder of the first certificate C1.

### (A-2) Association Method

When the mode of the divided transmission is adopted, a part of date used for authentication for the first target and the second target is transmitted from the first terminal 4 and the remaining data is transmitted from the second terminal 5. In order to specify a combination of the first target and the second target actually requesting setting of a correspondence relation, the management server 1 specifies association of the data (that is, discriminates a combination of corresponding data). When the authentication (collation) for the first target and the second target is successful by the associated data, a correspondence relation of the associated data is set between the first target and the second target.

Like the association of the certificates explained above, the association of the data may be specified by any method. In an example, data transmitted from the terminals (4 and 5) may include shared information for specifying association of the data. The shared information may be configured by information having a relationship of, for example, coinciding or a correspondence relation being established. The management server 1 may specify association of the data according to a relationship being established between the shared information included in the data received from one of the first terminal 4 and the second terminal 5 and the shared information included in the data received from the other.

The shared information may be optionally configured. In an example, the shared information may be configured by a combination of the first identifier I10 and the second identifier I20. In this case, the management server 1 may specify association of the data according to coincidence of a combination of the identifiers (I10 and I20) included in the data received from the first terminal 4 and a combination of the identifiers (I10 and I20) included in the data received from the second terminal 5. In another example, the shared information may be configured by temporary information such as random numbers, timestamps, or hash values. In this case, the management server 1 may specify association of the data according to a relationship being established between temporary information included in the data received from the first terminal 4 and temporary information included in the data received from the second terminal 5. In the second pattern and the third pattern, it is possible to expect further improvement of security by adopting the latter.

Note that the shared information may be shared at any timing between the first terminal 4 and the second terminal 5. In a typical example, the first terminal 4 and the second terminal 5 may share the shared information in the data exchange (step SA40 and step SB40). After receiving the data from one of the first terminal 4 and the second terminal 5, when data does not arrive from the other within a predetermined period, the management server 1 may notify, with any method, an inquiry for requesting transmission of the remaining data to at least one of the first terminal 4 and the second terminal 5. Typically, the management server 1 may notify the inquiry to one terminal that has received data. When the other terminal that has not received the data is specified, the management server 1 may notify the inquiry to the other terminal.

### (B) Collective Transmission

In an example, one of the first terminal 4 and the second terminal 5 may transmit the first identifier I10, the first certificate C1, the second identifier I20, and the second certificate C2. That is, receiving the first certificate C1 and the second certificate C2 from at least one of the first terminal 4 and the second terminal 5 may be configured by receiving the first certificate C1 and the second certificate C2 from one of the first terminal 4 and the second terminal 5.

When the first identifier I10, the first certificate C1, the second identifier I20, and the second certificate C2 are collectively transmitted from the second terminal 5, in the occurrence of the use relation between the first target and the second target, the first terminal 4 may give the first certificate C1 to the second terminal 5 during data exchange with the second terminal 5. Accordingly, the first terminal 4 may cause the second terminal 5 to transmit the first certificate C1 and the second certificate C2 to the management server 1. In an example, the first terminal 4 may further give the first identifier I10 to the second terminal 5 during the data exchange. Accordingly, the first terminal 4 may cause the second terminal 5 to further transmit the first identifier I10 and the second identifier I20 to the management server 1. With the data transmission, the first terminal 4 may request, via the second terminal 5, the management server 1 to set a correspondence relation between the first identifier I10 and the second identifier I20.

When the first identifier I10, the first certificate C1, the second identifier I20, and the second certificate C2 are collectively transmitted from the first terminal 4, in the occurrence of the use relation between the first target and the second target, the second terminal 5 may give the second certificate C2 to the first terminal 4 during data exchange with the first terminal 4. Accordingly, the second terminal 5 may cause the first terminal 4 to transmit the first certificate C1 and the second certificate C2 to the management server 1. In an example, the second terminal 5 may further give the second identifier I20 to the first terminal 4 during the data exchange. Accordingly, the second terminal 5 may cause the first terminal 4 to further transmit the first identifier I10 and the second identifier I20 to the management server 1. With the data transmission, the second terminal 5 may request, via the first terminal 4, the management server 1 to set a correspondence relation between the first identifier I10 and the second identifier I20.

In an example of the present embodiment, the second terminal 5 takes charge of transmission of data concerning the first target or the first terminal 4 takes charge of transmission of data concerning the second target. Accordingly, it is possible to improve likelihood of the use relation occurring between the first target and the second target. As a result, it is possible to expect improvement of the reliability of the linking information D10.

(Data exchange)

In the present embodiment, a series of processing concerning the linking setting may be started with the data exchange between the first terminal 4 and the second terminal 5 (step SA40 and step SB40) as a trigger. A method of the data exchange may not be particularly limited and may be selected as appropriate according to an embodiment.

In an example, the data exchange between the first terminal 4 and the second terminal 5 may be performed by wireless or wired data communication. The wireless communication may be performed by, for example, NFC (Near Field Communication), Bluetooth (registered trademark), or Wi-fi (registered trademark). The wired communication may be performed by, for example, a wired LAN (Local Area Network) or a USB (Universal Serial Bus). The data communication may be directly performed between the first terminal 4 and the second terminal 5 or may be indirectly performed via another computer. In another example, the data exchange may be performed by a method other than the data communication such as reading of a two-dimensional code. For example, the data exchange may be performed by one of the first terminal 4 and the second terminal 5 displaying data on a display and the other reading the displayed data using a sensor such as an image sensor.

In the data transmission to the management server 1, when one of the first terminal 4 and the second terminal 5 takes charge of transmission of data of the other target (for example, the first to third patterns of the divided transmission and the collective transmission), in this data exchange, one terminal may acquire the data of the other target, the transmission of which one terminal takes charge. That is, at least one of the first terminal 4 giving data of the first target to the second terminal 5 and the second terminal 5 giving data of the second target to the first terminal 4 may be executed in the data exchange. Alternatively, in the data exchange, the first terminal 4 may acquire the data of the second target with a spontaneous operation and the second terminal 5 may acquire the data of the first target with a spontaneous operation.

As a specific example, when the first pattern of the divided transmission is adopted, in the data exchange, the first terminal 4 may acquire the second identifier I20 and the second certificate C2 from the second target. In an example, when the second terminal 5 retains at least one of the second identifier I20 and the second certificate C2, the first terminal 4 may acquire at least one of the second identifier I20 and the second certificate C2 from the second terminal 5 by data communication. In another example, the first terminal 4 may acquire at least one of the second identifier I20 and the second certificate C2 from the second terminal 5 with a method other than the data communication for, for example, reading data displayed by a two-dimensional code in the second terminal 5. In still another example, in the data exchange, the first terminal 4 may acquire at least one of the second identifier I20 and the second certificate C2 from either the second target or the second terminal 5 using a device such as an input device or a sensor. The acquiring at least one of the second identifier I20 and the second certificate C2 from the second target may include acquiring at least one of the second identifier I20 and the second certificate C2 by the first target operating the device by proxy when the first target is a human and the second target is an object. The same applies to acquisition of the first identifier I10 and the first certificate C1 by the second terminal 5.

For example, in the example illustrated in FIG. 2 explained above, the first terminal 4 may perform data communication or read a code to acquire the second identifier I20 (the mobile body identifier) and the second certificate C2 from the second terminal 5. Similarly, the second terminal 5 may perform data communication or read a code to acquire the first identifier I10 (the user identifier) and the first certificate C1 from the first terminal 4. However, a method of acquiring data is not limited to these and may be selected as appropriate according to an embodiment. In another example, at least any one of the first identifier I10, the first certificate C1, the second identifier I20, and the second certificate C2 may be given by operation of the user via the input device. When the second identifier I20 is the car registration number, the first terminal 4 may image a license plate with the image sensor and analyze an obtained image to acquire the second identifier I20.

When the input device is used to acquire data, one terminal acquiring the data from the other target may include one target operating the input device to acquire the data of the other target in addition to the other target operating the input device to acquire the data of the other target. For example, in the example illustrated in FIG. 2 explained above, when the second identifier I20 is the car registration number and the input device is used to acquire the car registration number, the first terminal 4 may acquire the second identifier I20 from the mobile body (the second target) according to input of the car registration number by the user (the first target) via the input device.

Note that the data of the other target being acquired by one terminal may not always be executed in the data exchange. One terminal may acquire the data of the other target at any timing different from timing of the data exchange. Any one of the methods explained above may be adopted as the data acquisition method. When the acquisition of the data of the other target by one target is not executed in the data exchange (including the fourth pattern of the divided transmission explained above), the data exchange between the first terminal 4 and the second terminal 5 may function as a mere trigger for starting a series of processing concerning the linking setting.

In the data transmission to the management server 1, when the first terminal 4 takes charge of transmission of at least a part of the data of the first target, the first terminal 4 may acquire the data of the first target at any timing before the data transmission is executed. Similarly, when the second terminal 5 takes charge of transmission of at least a part of the data of the second target, the second terminal 5 may acquire the data of the second target at any timing before the data transmission is executed. A method of acquiring the data may not be particularly limited and may be selected as appropriate according to an embodiment. In an example, when at least one of the first identifier I10 and the first certificate C1 (the first time limit certificate C10) of the first target is stored in advance in the memory resource of the first terminal 4, the first terminal 4 may acquire at least one of the first identifier I10 and the first certificate C1 of the first target from the memory resource. In another example, the first terminal 4 may acquire at least one of the first identifier I10 and the first certificate C1 of the first target using an input device, a sensor, or the like. The same applies when the second terminal 5 acquires data of the second target.

### (Linking Information)

FIG. 3A schematically illustrates an example of the linking information D10 according to the present embodiment. In the example illustrated in FIG. 3A, the linking information D10 includes the first identifier I10, the second identifier I20, setting time, and release time. The first identifier I10 and the second identifier I20 indicate the first target and the second target for which a correspondence relation (linking) is set. The setting time indicates time when the correspondence relation has been set. The setting time may be configured by a timestamp. The release time indicates time when the correspondence relation has been released. A value of the release time may be added when processing for releasing the correspondence relation is executed. A method of expressing the release may not be limited to such an example. In another example, the release time may be replaced with at least one of an expiration date and a flag. The expiration date indicates a period in which the setting of the correspondence relation is effective. In this case, according to whether the setting of the correspondence relation is before the expiration date, it is indicated whether the setting of the correspondence relation is effective (that is, whether the correspondence relation is set or released). The flag indicates whether the correspondence relation has been released. The flag may be set when the processing for releasing the correspondence relation is executed. In still another example, the linking information D10 may include at least one of the expiration date and the flag together with a field of the release time. Note that, if the setting of the correspondence relation can be indicated, a configuration of the linking information D10 may not be limited to the example illustrated in FIG. 3A and may be changed as appropriate according to an embodiment. In another example, the linking information D10 may further include information indicating a type of an object to be used (whether the object to be used is an object to be always used or an object to be temporarily used). Note that the type of the object to be used may not always be identified by separate information. For example, the type of the object to be used may be identified by information such as an identifier.

A data format of the linking information D10 may not be particularly limited and may be selected as appropriate according to an embodiment. The linking information D10 may be retained by any database base. In an example, the linking information D10 may be retained by a relational database of a table format or the like. In another example, the linking information D10 may be retained by a blockchain base. In this case, transactions of the respective linking setting and release may be accumulated in a block chain as the linking information D10. For example, the transaction of the linking setting may include the first identifier I10, the second identifier I20, and the setting time. The transaction of the linking release may include the first identifier I10, the second identifier I20, and the release time (or the information indicating the release).

### (First Target Information)

The first target information O10 may include any information concerning the first target. The first target information O10 may include, for example, the first identifier I10, attribute information of the first target, and information concerning an authority. The first time limit certificate C10 may be correlated with the first target information O10. The correlating the first time limit certificate C10 with the first target information O10 may include storing the first time limit information C10 as an item of the first target information O10. When the first time limit certificate C10 is stored in correlation with the first target information O10, the first time limit certificate C10 that has expired because the expiration date has elapsed may be deleted as appropriate. In the example illustrated in FIG. 2, the user information O10A is an example of the first target information O10.

FIG. 3B schematically illustrates an example of the user information O10A according to the present embodiment. In the example illustrated in FIG. 3B, the user information O10A includes a user ID (the first identifier I10), attribute information, and authority information. The attribute information may include any information concerning an attribute of a user corresponding thereto. The attribute information may include personal information such as a name, an address, age, sex, and a contact. The authority information relates to an authority of the corresponding user. The authority information may include, for example, information for cooperating with a server that executes information processing concerning an authority of a target and information indicating correlation with various kinds of information E10. The first time limit certificate C10 of the user may be correlated with the user information O10A. Note that a configuration of the user information O10A may not be limited to the example illustrated in FIG. 3 and may be changed as appropriate according to an embodiment.

A data format of the first target information O10 (the user information O10A) may not be particularly limited and may be selected as appropriate according to an embodiment. The first target information O10 (the user information O10A) may be retained by any database base. In an example, the first target information O10 (the user information O10A) may be retained by a relational database of a table format or the like. In another example, the first target information O10 (the user information O10A) may be retained by a block chain base.

### (Second Target Information)

The second target information O20 may include any information concerning the second target. The second target information O20 may include, for example, the second identifier I20, attribute information of the second target, and information concerning an authority. The second time limit certificate C20 may be correlated with the second target information O20. The correlating the second time limit certificate C20 with the second target information O20 may include storing the second time limit certificate C20 as an item of the second target information O20. When the second time limit certificate C20 is stored in correlation with the second target information O20, the second time limit certificate C20 that has expired because the expiration date has elapsed may be deleted as appropriate. In the example illustrated in FIG. 2, the mobile body information O20A is an example of the second target information O20.

FIG. 3C schematically illustrates an example of the mobile body information O20A according to the present embodiment. In the example illustrated in FIG. 3C, the mobile body information O20A includes a mobile body ID (the second identifier I20) and attribute information. The attribute information includes a number, a type, and owner information. When the mobile body is a vehicle, the number may be a car registration number. The type is a car model. When the car registration number is used as the mobile body ID, the number may be omitted from the attribute information. The owner information may include any information concerning an owner of the mobile body. The owner information may include personal information of the owner such as a name, an address, age, sex, and a contact. The owner may be a corporation. Note that the configuration of the mobile body information O20A may not be limited to the example illustrated in FIG. 3C and may be changed as appropriate according to an embodiment. A configuration of the attribute information may be changed as appropriate. For example, the mobile body information O20A may further include information concerning a mobile body terminal such as a contact of the mobile body terminal.

The data format of the second target information O20 (the mobile body information O20A) may not be particularly limited and may be selected as appropriate according to an embodiment. The second target information O20 (the mobile body information O20A) may be retained by any database base. In an example, the second target information O20 (the mobile body information O20A) may be retained by a relational database of a table format or the like. In another example, the second target information O20 (the mobile body information O20A) may be retained by a block chain base.

### (Method of Notifying the Linking Setting)

The management server 1 may transmit notification indicating a result of the linking processing to at least one of the first terminal 4 and the second terminal 5 (step SC30). A transmission route of the notification may not be particularly limited and may be determined as appropriate according to an embodiment. In an example, the management server 1 may directly notify the result to at least one of the first terminal 4 and the second terminal 5 (FIG. 1 and FIG. 2). In another example, the management server 1 may indirectly notify the result to at least one of the first terminal 4 and the second terminal 5 via an external computer such as the servers (2 and 3).

### (Check Processing for Use Continuation)

As one of optional configurations, after setting the correspondence relation between the first target and the second target, the management server 1 may further execute processing (check processing) for checking whether the correspondence relation continues. A method of checking use continuation may be selected as appropriate according to an embodiment.

In an example, the continuation of the correspondence relation may be checked by authenticating at least one of the first target and the second target via at least one of the first terminal 4 and the second terminal 5. Authentication in the check processing may be executed in the same manner as the authentication by the certificates (C1 and C2) or may be executed by a different method. When the authentication by the certificates (C1 and C2) is performed, before the expiration date, the time limit certificates (C10 and C20) used in setting the correspondence relation may be directly used for the authentication for the use continuation or the time limit certificates (C10 and C20) issued anew may be used. As an example of a mode of adopting an authentication method different from the certificates (C1 and C2), in the case of in FIG. 2, the authentication for the user may be performed by a method of, for example, performing face authentication for the user using an image sensor included in the mobile body, performing fingerprint authentication for the user using a fingerprint reading device attached to a steering wheel, or causing the user to utter and performing voiceprint authentication using a microphone included in the mobile body. In order to improve likelihood, as in the first pattern of the divided transmission, the other target may be authenticated via one of the first terminal 4 and the second terminal 5. The authentication processing may be executed by at least any one of the terminals (4 and 5), the servers (2 and 3), and the management server 1. When the authentication processing is executed by the servers (2 and 3), data used for the authentication may be directly transmitted from the terminals (4 and 5) to the servers (2 and 3) or may be indirectly transmitted via the external computer such as the management server 1. The same applies when the authentication processing is executed by the management server 1. The data used for the authentication in the check processing may be the same as or may be different from the certificates (C1 and C2). The management server 1 may acquire an authentication result as appropriate and, when authentication for a target is successful in the acquired authentication result, determine that the correspondence relation continues and, when the authentication is unsuccessful, determine that the correspondence relation does not continue.

In another example, when at least one of the first target and the second target is the user (for example, the case of FIG. 2), the management server 1 may directly or indirectly transmit check notification including operation pieces to at least one of the first terminal 4 and the second terminal 5. The operation pieces may be configured by, for example, a check button, a return button, and links. A transmission destination of the check notification may not always correspond to the user. In the case of FIG. 2, the management server 1 may transmit the check notification to at least one of the first terminal 4 and the second terminal 5. The transmission destination of the check notification may overlap or may be different from a transmission destination of notification indicating a result of the linking processing. The check notification may be configured to directly or indirectly return a response to the management server 1 according to operation of the operation piece by the user. When receiving the response by the operation of the operation piece within a predetermined period, the management server 1 may determine that the correspondence relation continues. When not receiving the response, the management server 1 may determine that the correspondence relation does not continue.

In still another example, when a correspondence relation between the first target and the second target in the real world is tracked, the terminals (4 and 5) may include positioning modules such as GPS (Global Positioning Satellite) modules or GNSS (Global Navigation Satellite System) modules. The first terminal 4 may measure a current position of the first target (the first terminal 4) with the positioning module. The second terminal 5 may measure a current position of the second target (the second terminal 5) with the positioning module. The terminals (4 and 5) may directly transmit the obtained current positions of the targets to the management server 1 or indirectly transmit the obtained current positions to the management server 1 via the external computer such as the servers (2 and 3). The management server 1 may determine, according to whether the received current positions of the targets are close enough to satisfy a predetermined condition of a use relation (for example, the user is riding on the mobile body), whether the correspondence relation continues. That is, when the current positions of the targets are close enough to satisfy the predetermined condition, the management server 1 may determine that the correspondence relation continues and, otherwise, determine that the correspondence relation does not continue. Note that, when this mode is adopted, the management server 1 may store information concerning the obtained current positions of the targets in correlation with the linking information D10. Accordingly, the management server 1 is capable of tracking moving histories of the targets as well together with the correspondence relation between the targets. At least a part of the processing explained above may be executed by a computer other than the management server 1.

When determining that the correspondence relation continues, the management server 1 may maintain the setting of the correspondence relation. On the other hand, when determining that the correspondence relation does not continue, the management server 1 may release the correspondence relation. The management server 1 may be configured to update a state of the correspondence relation by regularly or irregularly repeatedly executing the check processing until the correspondence relation is released after being set.

### (Linking Release)

In the present embodiment, the management server 1 may be configured to release the correspondence relation according to reception of a release request from at least one of the first terminal 4 and the second terminal 5 or satisfaction of a predetermined release condition.

### (I) Release Request

In an example, the release request (demand) for linking includes at least one of the first identifier I10 and the second identifier I20. Simply speaking, the first terminal 4 may transmit a release request including the first identifier I10 and not including the second identifier I20 to the management server 1. Similarly, the second terminal 5 may transmit a release request including the second identifier I20 and not including the first identifier I10 to the management server 1. When overlap of settings of correspondence relations is permitted, the release request may include both of the first identifier I10 and the second identifier I20. In an example, the first terminal 4 or the second terminal 5 may transmit a release request including the first identifier I10 and the second identifier I20 to the management server 1. In another example, the first terminal 4 may transmit a release request including one of the first identifier I10 and the second identifier I20 and the second terminal 5 may transmit a release request including the other. In still another example, the management server 1 may impart an identifier to a set correspondence relation and may notify the imparted identifier to at least one of the first terminal 4 and the second terminal 5 at any timing such as timing of notification indicating a result of linking processing. At least one of the first terminal 4 and the second terminal 5 may transmit a release request including the identifier to the management server 1 to designate a correspondence relation of a release target and cause the management server 1 to release the designated correspondence relation. According to an example of the present embodiment, the first identifier I10 and the second identifier I20 can be omitted from information included in the release request. Accordingly, it is possible to expect efficiency of data communication in the release request.

When the first terminal 4 transmits a release request including the second identifier I20, the first terminal 4 may acquire the second identifier I20 at any timing. In an example, in the request for the linking setting explained above, when a mode in which the first terminal 4 acquires the second identifier I20 is adopted (for example, the first pattern of the divided transmission), the first terminal 4 may store, in the memory resource, as current linking information, the second identifier I20 acquired in the request for the linking setting. Alternatively, when a mode in which the management server 1 transmits a notification indicating a result of the linking processing to the first terminal 4 is adopted, the notification may be configured to include the second identifier I20. The first terminal 4 may store, in the memory resource, as current linking information, the second identifier I20 included in the notification received from the management server 1. In the request for the linking release, the first terminal 4 may acquire the second identifier I20 from the memory resource. Note that the first terminal 4 may acquire the first identifier I10 at any timing. In an example, the first identifier I10 may be stored in the memory resource in advance. When creating current linking information, the first terminal 4 may store the second identifier I20 in correlation with the first identifier I10. When transmitting the release request, the first terminal 4 may acquire the first identifier I10 from the memory resource.

Similarly, when the second terminal 5 transmits a release request including the first identifier I10, the second terminal 5 may acquire the first identifier I10 at any timing. In an example, in the request for the linking setting, when a mode in which the second terminal 5 acquires the first identifier I10 is adopted (for example, the first pattern of the divided transmission), the second terminal 5 may store, in the memory resource, as current linking information, the first identifier I10 acquired in the request for the linking setting. Alternatively, when a mode in which the management server 1 transmits a notification indicating a result of the linking processing to the second terminal 5 is adopted, the notification may be configured to include the first identifier I10. The second terminal 5 may store, in the memory resource, as current linking information, the first identifier I10 included in the notification received from the management server 1. In the request for the linking release, the second terminal 5 may acquire the first identifier I10 from the memory resource. Note that the second terminal 5 may acquire the second identifier I20 at any timing. In an example, the second identifier I20 may be stored in the memory resource in advance. When creating current linking information, the second terminal 5 may store the first identifier I10 in correlation with the second identifier I20. When transmitting the release request, the second terminal 5 may acquire the second identifier I20 from the memory resource.

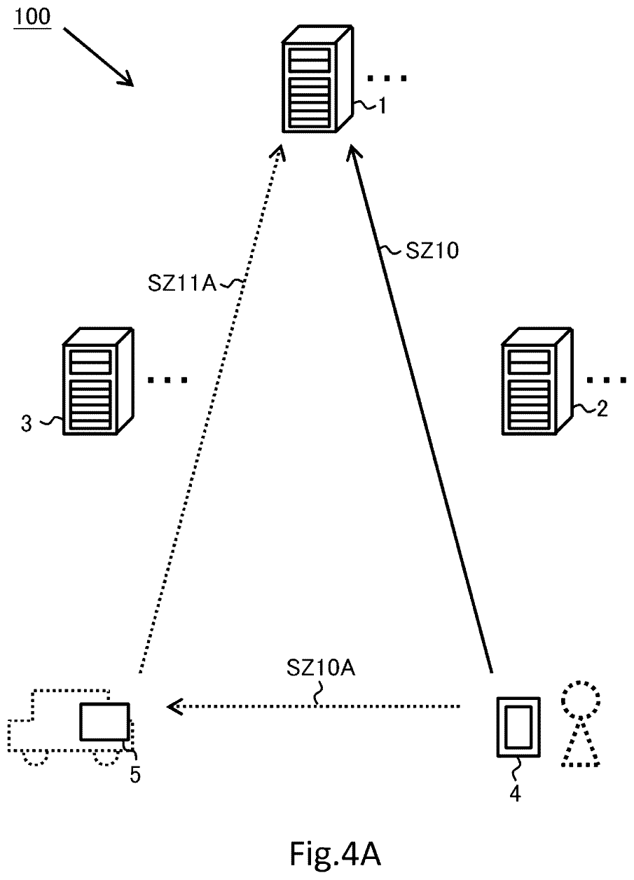

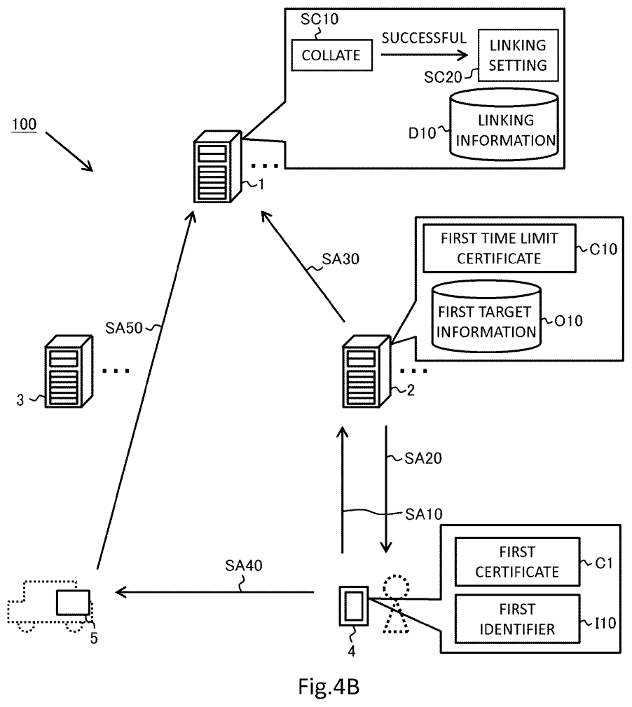

FIG. 4A schematically illustrates an example of a process of linking release according to the present embodiment. In the example illustrated in FIG. 4A, as a first route, the first terminal 4 directly transmits a release request to the management server 1 (step SZ10). As a second route, the first terminal 4 gives an instruction to the second terminal 5 (step SZ10A) and causes the second terminal 5 to directly transmit the release request to the management server 1 (step SZ11A). However, a transmission route of the release request may not be limited to such an example. The first terminal 4 may indirectly transmit the release request to the management server 1 via the external computer such as the first server 2. In the second route, the second terminal 5 may indirectly transmit the release request to the management server 1 via the external computer such as the second server 3. Note that a start point of the release request may not be limited to the first terminal 4. In another example, the second terminal 5 may directly or indirectly transmit the release request to the management server 1. The second terminal 5 may give an instruction to the first terminal 4 and cause the first terminal 4 to directly or indirectly transmit the release request to the management server 1. After receiving the release request, the management server 1 refers to the linking information D10 and releases a correspondence relation designated by an identifier included in the release request. After this release processing, as at the time of the linking setting, the management server 1 may transmit notification indicating a result of the release processing to at least one of the first terminal 4 and the second terminal 5.

In an example, the processing of the release request may include authentication processing for at least one of the first target and the second target. The authentication processing may be the same as the authentication processing in the processing of the linking setting or the check processing for the use continuation explained above. However, in the release request, the authentication processing may not always be executed. In another example, the processing of the release request may be simplified by omitting the authentication processing.

A trigger of the release request may be set as appropriate according to an embodiment. In an example, when at least one of the first target and the second target is the user, the release request may be transmitted from at least one of the first terminal 4 and the second terminal 5 by operation of at least one of the first terminal 4 and the second terminal 5 by the user. That is, the trigger of the release request may be the operation by the user. In another example, any information processing may be executed in at least one of the first terminal 4 and the second terminal 5 according to extinction of a use relation. The release request may be transmitted from at least one of the first terminal 4 and the second terminal 5 with such any information processing as a trigger. For example, such any information processing may be data exchange between the first terminal 4 and the second terminal 5. A method of data exchange in the release request may be the same as the data exchange in the linking setting (step SA40 and step SB40). The data exchange at the time of the linking setting and the data exchange at the time of the release request may be distinguished as appropriate. For example, in the example illustrated in FIG. 2, the second terminal 5 may include different sensor devices at an entrance and an exit such as a doorway of a bus and a ticket gate of a railroad. In this case, the data exchange at the time of the linking setting and the data exchange at the time of the release request may be distinguished according to the sensor device used for the data exchange. For example, when the data exchange is executed by an application of a terminal, the application may be configured to be capable of switching a mode of the application to a linking setting mode and a release request mode. In this case, the linking setting time and the release request time may be distinguished according to the mode of the application.

Besides, according to the processing of the release request, any internal processing may be executed in the terminals (4 and 5). In an example, when current linking information is created in at least one terminal of the first terminal 4 and the second terminal 5, the at least one terminal may update the current linking information to linking information in the past according to the processing of the release request. Update processing may be set as appropriate according to an embodiment. For example, the update processing may be deleting the current linking information. In this case, the current linking information may be completely deleted or may be stored as a linking history in the past. For example, the update processing may be disabling the current linking information by adding disabling information such as setting of end time and an end flag to the current linking information. When a mode in which one terminal of the first terminal 4 and the second terminal 5 transmits the release request is adopted, one terminal may transmit, according to the transmission of the release request or success of the release, to the other terminal, notification for informing linking release. When the current release information is created by the other terminal, the other terminal may execute the update processing according to the notification.

### (II) Release Condition

The release condition indicates a condition for releasing a correspondence relation between targets. The release condition may be defined as appropriate according to an embodiment.

In an example, the release condition may be defined to release the correspondence relation at optionally set release time. The release time may be given by, for example, designation by the user or designation from another application (a scheduler or the like). In this case, the management server 1 may release the correspondence relation between the targets according to arrival of the release time. The release time may be set as the expiration date of the linking information D10 explained above. When the release time is set as the expiration date, the management server 1 may treat the correspondence relation between the targets as being released according to the arrival of the release time.

In another example, when settings of a plurality of correspondence relations overlap with respect to the same target because of interruption of setting of a correspondence relation by at least one of another first target and another second target, the release condition may be defined to release any one of the overlapping correspondence relations. The number of correspondence relations (linking) that can be set for the same target may not be limited to one and may be two or more. When the overlap of the settings of the correspondence relations exceeds a threshold (an upper limit), the management server 1 may release any one of correspondence relations set earlier and maintained. The threshold may be given as appropriate. Which correspondence relation is released may be determined as appropriate according to priority, order, a type of a target, and the like.

For example, a scene in which one of the first target and the second target is the user and the other is the object to be used is assumed. In this case, the number of users who can be linked with the same object to be used may be infinite or may be finite. When the number of users who can be linked is finite, an upper limit value of the number of users who can be linked may be given as appropriate by a threshold. The threshold may be set according to an attribute of the object to be used. When receiving anew setting of a correspondence relation for a target object to be used, the management server 1 may refer to the linking information D10 and extract preceding correspondence relations set for the target object to be used and maintained. When overlap of the settings of the correspondence relations for the target object to be used exceeds the threshold, due to the setting of the correspondence relation received anew, the management server 1 may discard a request for the setting of the correspondence relation received anew or release at least any one of the extracted preceding correspondence relations. When releasing the preceding correspondence relation, the management server 1 may determine, according to priority, order (for example, a correspondence relation set earlier is released), or the like of the user, a correspondence relation to be released.

As a specific example, in the example illustrated in FIG. 2, it is assumed that the mobile body is a private car and the first user and the second user are, for example, a family and, therefore, share a target private car. The private car may be replaced with an object to be always used. For convenience of explanation, it is assumed that the number of users who can be linked with the target private car is one. In this case, while a correspondence relation between one of the first user and the second user and the target private car is set, in response to reception of setting of a correspondence relation between the other and the target private car, the management server 1 may release a preceding correspondence relation (a correspondence relation between the one and the target private car).

Similarly, the number of objects to be used that can be linked with the same user may be infinite or may be finite. When the number of objects to be used that can be linked is finite, an upper limit value of the number of objects to be used that can be linked may be given as appropriate by a threshold. When receiving anew setting of a correspondence relation for a target user, the management server 1 may refer to the linking information D10 and extract preceding correspondence relations set for the target user and maintained. When overlap of settings of correspondence relations for the target user exceeds a threshold, due to the setting of the correspondence relation received anew, the management server 1 may discard a request for setting of a correspondence relation received anew or release at least any one of the extracted preceding correspondence relations. When releasing the preceding correspondence relation, the management server 1 may determine, according to priority, a type (for example, an object to be always used or an object to be temporarily used), a correspondence relation to be released.

As a specific example, in the example illustrated in FIG. 2, it is assumed that the first mobile body is the object to be always used (for example, a private car) and the second mobile body is an object to be temporarily used (for example, a rent-a-car, a shared car, or a mobile body of a public transportation). In this case, the management server 1 may release a preceding correspondence relation (a correspondence relation with the first mobile body) according to setting of a correspondence relation between the target user and the second mobile body being received while a correspondence relation between the target user and the first mobile body is set.

Note that, in this specific example, the management server 1 may set again, according to the correspondence relation with the second mobile body (the object to be temporarily used) being released, a correspondence relation between the first mobile body (the object to be always used) and the target user released earlier. Accordingly, it is possible to quickly recover the setting of the correspondence relation with the object to be always used. When both of the first mobile body and the second mobile body are objects to be always used or objects to be temporarily used, the management server 1 may mediate overlapping settings of correspondence relations as appropriate. For example, as long as a preceding correspondence relation is not released, the management server 1 may discard a request for setting of a correspondence relation received anew.

As explained above, the management server 1 may release the correspondence relation according to the reception of the release request from at least one of the first terminal 4 and the second terminal 5 or the satisfaction of the predetermined release condition. According to an example of the present embodiment, it is possible to track extinction of the use relation between the first target and the second target. Note that the linking information D10 after the correspondence relation is released may be stored as a history.

### (Simplified Processing for Linking Setting)

In an example, during the same combination of the first target and the second target, when occurrence and extinction of a use relation are repeated, the management system 100 may executes authentication processing for the first target and the second target every time and repeat setting and release of a correspondence relation. However, when a frequency of repeating occurrence and extinction of the use relation is high, it is likely to be troublesome to execute the same authentication processing for the first target and the second target every time. In particular, in a case in which one of the first target and the second target is the user and the other is the object to be always used, it can be troublesome to execute authentication for both of the first target and the second target every time.

Thus, in another example, the management system 100 may be configured to omit, for the same combination of the first target and the second target, in the next and subsequent processing of linking setting, authentication processing for at least one of the first target and the second target and set a correspondence relation. That is, the management system 100 may be configured to omit, for a combination of the first target and the second target for which a correspondence relation was set in the past, authentication processing for at least one of the first target and the second target and receive a request for setting a correspondence relation. For convenience of explanation, processing for omitting authentication processing for at least one of the first target and the second target and setting a correspondence relation is referred to as “simplified processing for linking setting” as well and processing of a normal route in which the authentication processing is not omitted is referred to as “normal processing for linking setting” as well. In an example, in the linking setting by the simplified processing, the authentication processing for one of the first target and the second target may be executed. In another example, in the linking setting by the simplified processing, the authentication processing may be omitted for both of the first target and the second target.

Information concerning a combination of the first target and the second target for which a correspondence relation was set in the past may be managed by at least any one of the management server 1, the servers (2 and 3), and the terminals (4 and 5). In an example, the linking information D10 may be maintained as a history even after release of the correspondence relation. The management server 1 may discriminate, with the history of the linking information D10, whether a combination of the first target and the second target for which a request for setting of a correspondence relation is received is a combination for which a correspondence relation was set in the past. When discriminating that the combination of the first target and the second target is a combination for which a correspondence relation was set in the past, the management server 1 may perform the linking setting by the simplified processing. The first terminal 4 may acquire the second identifier I20 of the second target at any timing such as timing of the linking setting and store the acquired second identifier I20 as a counterparty of the simplified processing. The second terminal 5 may also acquire the first identifier I10 of the first target and store the acquired first identifier I10 as a counterparty of the simplified processing. Accordingly, at least one of the first terminal 4 and the second terminal 5 may retain information concerning a counterparty for which a correspondence relation was set in the past and may perform request for linking setting by the simplified processing using the retained information concerning the counterparty. The first server 2 may acquire the second identifier I20 of the second target from at least any one of the management server 1 and the terminals (4 and 5) and store the acquired second identifier I20 as a counterparty of the simplified processing in correlation with the first target information O10 of the first target corresponding thereto. The second server 3 may also acquire the first identifier I10 of the first target from at least any one of the management server 1 and the terminals (4 and 5) and store the acquired first identifier I10 as a counterparty of the simplified processing in correlation with the second target information O20 of the second target. Accordingly, at least one of the first server 2 and the second server 3 may retain information concerning a counterparty for which a correspondence relation was set in the past and cope with the linking setting by the simplified processing using the retained information concerning the counterparty.

The management system 100 may be configured to permit the simplified processing for a part of each of the first target and the second target to, for example, permit the simplified processing for an object to be always used and not permit the simplified processing for an object to be temporarily used and link the object to be temporarily used every time with normal processing. Whether to permit the simplified processing may be switched as appropriate. In an example, whether to permit the simplified processing may be switched according to a type of at least one of the first target and the second target. As a specific example, when one of the first target and the second target is the user and the other is the object to be used, as explained above, whether to permit the simplified processing may be switched according to a type of the object to be used (the object to be always used or the object to be temporarily used).

Whether to permit the simplified processing may be switched by any method. In an example, at least any one of the management server 1, the servers (2 and 3), and the terminals (4 and 5) may identify a type of the object to be used and switch, according to a result of the identification, whether to permit the simplified processing. The type of the object to be used may be identified by individual information included in target information or may be identified by information such as an identifier. In another example, a program including a mode for permitting the simplified processing may be installed only in a terminal of an object to be used for which the simplified processing is permitted such as a terminal of an object to be always used (the second terminal 5 illustrated in FIG. 2). Whether to permit the simplified processing may be switched according to an operation of the terminal. Note that an operation of the mode for permitting the simplified processing may be, for example, storing information concerning a counterparty or transmitting a request for linking setting by the simplified processing.

The request for the linking setting by the simplified processing may be transmitted from at least one of the first terminal 4 and the second terminal 5. At least one of the first terminal 4 and the second terminal 5 may directly transmit the request for the linking setting by the simplified processing to the management server 1 or may indirectly transmit the request for the linking setting by the simplified processing to the management server 1 via the external computer such as the servers (2 and 3). For example, the first terminal 4 may directly transmit the request for the linking setting by the simplified processing to the management server 1 or may indirectly transmit the request for the linking setting by the simplified processing to the management server 1 via the external computer such as the first server 2. The first terminal 4 may give an instruction to the second terminal 5 to cause the second terminal 5 to directly transmit the request for the linking setting by the simplified processing to the management server 1 or may cause the second terminal 5 to indirectly transmit the request for the linking setting by the simplified processing to the management server 1 via the external computer such as the second server 3. Similarly, the second terminal 5 may directly transmit the request for the linking setting by the simplified processing to the management server 1 or may indirectly transmit the request for the linking setting by the simplified processing to the management server 1 via the external computer such as the second server 3. The second terminal 5 may give an instruction to the first terminal 4 to cause the first terminal 4 to directly transmit the request for the linking setting by the simplified processing to the management server 1 or may cause the first terminal 4 to indirectly transmit the request for the linking setting by the simplified processing to the management server 1 via the external computer such as the first server 2.

A request by the simplified processing and a request by the normal processing may be discriminated as appropriate. In an example, the request for the linking setting may include information indicating whether the request is by the simplified processing. The management server 1 may discriminate, according to the information, whether the request is by the simplified processing or the normal processing. In another example, the management server 1 may discriminate, according to information concerning the targets (for example, a combination of the first identifier I10 and the second identifier I20) included in the request for the linking setting, whether the request is by the simplified processing or the normal processing.

Basically, the request for the linking setting by the simplified processing may include the first identifier I10 and the second identifier I20. The first identifier I10 and the second identifier I20 included in the request may be obtained from any one of the terminals (4 and 5) and the servers (2 and 3) in a process of transmission from at least one of the first terminal 4 and the second terminal 5 to the management server 1. However, the request for the linking setting by the simplified processing may not be limited to such a configuration. At least one of the first identifier I10 and the second identifier I20 may be omitted from information included in the request. In another example, as in the example of the release request explained above, in linking setting in the past, the management server 1 may impart an identifier to a correspondence relation between the first identifier I10 and the second identifier I20 to store (register) a combination for which the simplified processing is permitted. The management server 1 may notify the imparted identifier to at least one of the first terminal 4 and the second terminal 5 at any timing such as timing of notification indicating a result of the linking processing. At least one of the first terminal 4 and the second terminal 5 may transmit a request for linking setting including the identifier to the management server 1 to cause the management server 1 to execute the linking setting by the simplified processing. According to an example of the present embodiment, the first identifier I10 and the second identifier I20 can be omitted from the information included in the request. Accordingly, it is possible to expect efficiency of data communication in the request for the linking setting.

In an example, in the simplified processing, when a mode in which the authentication processing for one of the first target and the second target is executed is adopted, the authentication processing for one of the first target and the second target may be executed in the same transmission mode as the transmission mode of the normal processing. For example, when the first pattern of the divided transmission is adopted in the normal processing, the first pattern of the divided transmission may be adopted in the simplified processing as well. However, a mode of the authentication processing in the simplified processing may not be limited to such an example. In another example, as the transmission mode of the authentication processing in the simplified processing, a transmission mode different from the transmission mode adopted in the normal processing among the transmission modes explained above may be adopted. In still another example, at least one of the first terminal 4 and the second terminal 5 may directly transmit an authentication request to the servers (2 and 3). An authentication result may be transmitted from at least any one of the servers (2 and 3) and the terminals (4 and 5) to the management server 1.

Note that, when the mode in which the authentication processing for one of the first target and the second target is executed is adopted, a terminal that transmits the request for the linking setting by the simplified processing may store at least parts of data (an identifier and a certificate) used for authentication for the one. For example, when the first pattern of the divided transmission is adopted, the second terminal 5 may store, in the memory resource, at least one of the first identifier I10 and the first certificate C1 of the first target at any timing such as timing of linking setting in the past. The second terminal 5 may acquire at least one of the first identifier I10 and the first certificate C1 from the memory resource and transmit the data used for the authentication to the management server 1 using the acquired information. Accordingly, it is possible to further reduce troubles in the linking setting.

FIG. 4B schematically illustrates an example of a process of the linking setting by the simplified processing according to the present embodiment. In FIG. 4B, in the example illustrated in FIG. 2, a scene in which the authentication processing for the user (the first target) is executed, the authentication processing for the mobile body (the second target) is omitted, and the first pattern of the divided transmission is adopted for a transmission mode of the authentication processing is assumed. In step SA10 to step SA30, the first time limit certificate C10 is issued and the issued first time limit certificate C10 is notified to the first terminal 4 and the management server 1. In step SA40, in the data exchange, the first terminal 4 gives the issued first time limit certificate C10 to the second terminal 5 as the first certificate C1. The first terminal 4 gives the first identifier I10 to the second terminal 5. The second terminal 5 acquires the first identifier I10 and the first certificate C1 from the user. In step SA50, the second terminal 5 transmits a request for the linking setting by the simplified processing including the first identifier I10 and the first certificate C1 to the management server 1. The request may include the second identifier I20 as well. The management server 1 discriminates, as appropriate, that the request received from the second terminal 5 is a request for the linking setting by the simplified processing. In step SC10, the management server 1 collates the first certificate C1 received from the second terminal 5 and the first time limit certificate C10 corresponding thereto to execute authentication processing for the user. When authentication for the user is successful (the collation is successful), the management server 1 sets a correspondence relation (linking) between the first identifier I10 and the second identifier I20 (step SC20). Note that the processing of the linking setting by the simplified processing may not be limited to the example illustrated in FIG. 4B and may be changed as appropriate according to an embodiment. For example, as explained above, when the mode in which the authentication processing for one of the first target and the second target is executed is adopted, a transmission mode other than the first pattern of the divided transmission may be adopted. The simplified processing may be configured to omit the authentication processing for the user (the first target) and execute the authentication processing for the mobile body (the second target). The request for the linking setting by the simplified processing may be transmitted not from the second terminal 5 but from the first terminal 4. A transmission route of the request by the simplified processing may not be limited to the example illustrated in FIG. 4B. At least one of the first identifier I10 and the second identifier I20 may be omitted from the request for the linking setting by the simplified processing.

Note that, as one of an optional configuration, as registration processing for a target for which the simplified processing is permitted, the management server 1 may acquire identification information (a MAC address, terminal identification information, and the like) of at least one of the first terminal 4 and the second terminal 5 for which the simplified processing is permitted and store the acquired identification information. The registration processing may be executed at any timing such as timing of the linking setting in the past. The management server 1 may be configured to receive the request for the linking setting by the simplified processing only from the terminal identified by the identification information.

A trigger of the request for the linking setting by the simplified processing may be the same as the trigger in the normal processing. That is, at least one of the first terminal 4 and the second terminal 5 may transmit the request for the linking setting by the simplified processing to the management server 1 with the data exchange between the first terminal 4 and the second terminal 5 as a trigger. However, the trigger of the simplified processing may not be limited to such an example. In another example, when at least one of the first target and the second target is the user, the request for the linking setting by the simplified processing may be transmitted from at least one of the first terminal 4 and the second terminal 5 by operation of at least one of the first terminal 4 and the second terminal 5 by the user. That is, a trigger of the request for the linking setting by the simplified processing may be the operation by the user. In another example, a trigger of the request for the linking setting by the simplified processing may be an instruction by another application (a scheduler or the like). In another example, as in the release request explained above, any information processing may be executed by at least one of the first terminal 4 and the second terminal 5 according to occurrence of a correspondence relation. The request for the linking setting by the simplified processing may be transmitted from at least one of the first terminal 4 and the second terminal 5 with such any information processing as a trigger.

Basically, release processing for the correspondence relation set by the simplified processing (release processing for the simplified processing) may be the same as the processing for the linking release in the normal processing explained above (release processing for the normal processing). However, the release processing for the simplified processing may not always coincide with the release processing for the normal processing. The correspondence relation set by the simplified processing may be released as appropriate. In another example, when a transmission route of the setting request for the correspondence relation by the simplified processing and a transmission route of the release request for the normal processing are different, the transmission route of the release request for the simplified may be matched with the transmission route of the setting request for the correspondence relation by the simplified processing.

### (Use Scene of the Linking Information)

As explained above, the linking information D10 may be used in various scenes. In an example, the linking information D10 may be used to simply track occurrence and extinction of a relation between the first target and the second target. In another example, the linking information D10 may be used to make it possible to exercise at least a part of an authority linked with one of the first target and the second target from the other while the correspondence relation is set between the first target and the second target. In the example illustrated in FIG. 2, the linking information D10 may be used to make it possible to exercise, from the mobile body, at least a part of an authority linked with the user while the correspondence relation between the user and the mobile body is set.

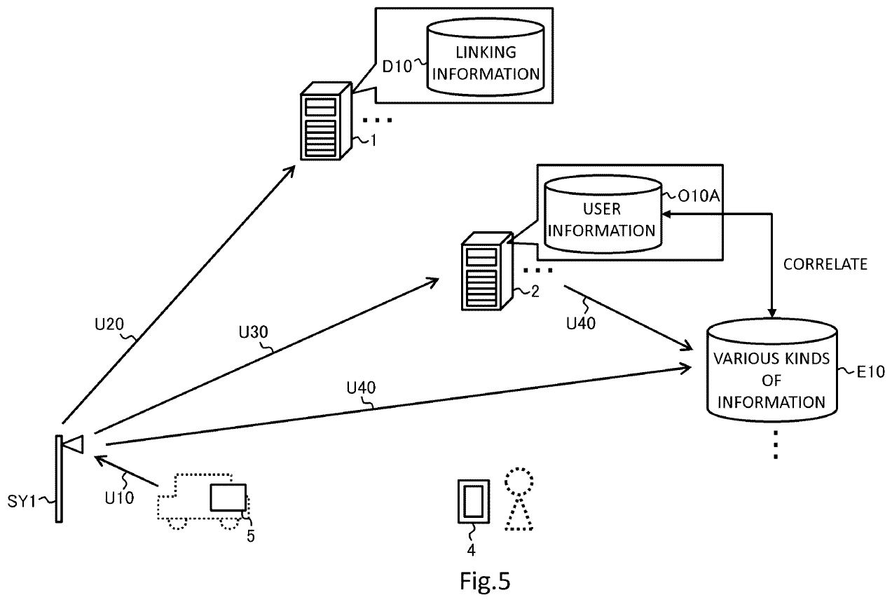

FIG. 5 schematically illustrates an example of a use scene of the linking information D10 according to the present embodiment. In the example illustrated in FIG. 2, FIG. 5 assumes a scene in which an authority linked with the user is exercised from the mobile body. An external system SY1 is disposed in a place (for example, a parking lot) where various services are exercised and is configured to execute information processing for providing a target service to a user having a target authority. The configuration and the service of the external system SY1 may not be particularly limited and may be selected as appropriate according to an embodiment.

First, in step U10, the external system SY1 acquires the second identifier I20 (the mobile body identifier) from a target mobile body. A method of acquiring the second identifier I20 may be selected as appropriate according to an embodiment. In an example, the external system SY1 may exchange data with the second terminal 5 to acquire the second identifier I20 from the second terminal 5. A method of the data exchange may be the same as the method of the data exchange between the first terminal 4 and the second terminal 5. In another example, when the second identifier I20 is a car registration number, the external system SY1 may image a license plate with an image sensor and analyze an obtained image to acquire the second identifier I20.

In step U20, the external system SY1 uses the acquired second identifier I20 as a query and inquires the management server 1 whether a correspondence relation effective at a target date and time is present for the target mobile body. Effective means that setting of a correspondence relation is maintained (is not released) at the target date and time. Basically, the target date and time is the present (immediate time). However, the target date and time may not be limited to this. For example, when settlement processing at a date and time in the past is executed, the target date and time may be the date and time in the past. When an effective correspondence relation is present, the first identifier I10 (a user identifier) of a user linked with the target mobile body is extracted. On the other hand, when an effective correspondence relation is absent and a user linked with the target mobile body is not extracted, this processing may end.

In step U30, the external system SY1 uses the extracted first identifier I10 as a query and inquires the first server 2 about an authority exercisable for the user linked with the target mobile body. The first server 2 refers to the first target information O10 (the user information O10A) and extracts an authority that is correlated with the target user and is exercisable. When an exercisable authority is not extracted, this processing may end. Note that, in the first target information O10 (the user information O10A), whether to permit exercise of an authority by the mobile body may be set for each authority. Exercisable authorities may be extracted according to this setting. When a target authority that the external system SY1 is about to exercise is not included in the exercisable authorities, this processing may also end. The exercise target authority may be designated as appropriate at any timing. In an example, the exercise target authority may be designated in advance in the external system SY1 or may be designated by the user.

In step U40, when the target authority is included in the exercisable authorities, the external system SY1 executes processing for exercising the target authority. Accordingly, an authority linked with the user is exercised from the mobile body. The user can receive a service via the mobile body. For example, when the authority information includes information concerning public personal authentication and the target authority relates to the public personal authentication, the user can receive a public service via the mobile body. For example, when the authority information includes settlement information and the target authority relates to settlement, the user can receive a settlement service via the mobile body. The settlement service may be payment of a fee such as a usage fee of a parking lot, a fee of a freeway, a fee of drive-through, a fee of a public transportation, or a rental fee. For example, when the authority information includes information concerning an electronic prescription and the target authority is reception of a drug prescribed by the electronic prescription, the user can exercise the electronic prescription via the mobile body and receive the drug.

Note that the processing procedure in exercising the authority explained above is only an example. The steps may be changed as much as possible. Concerning the processing procedure, it is possible to omit, substitute, and add steps as appropriate according to an embodiment. In the processing procedure explained above, the user may be replaced with the first target and the mobile body may be replaced with the second target. Further, in the processing procedure explained above, “first” and “second” may be changed.

### (Data Communication Among the Devices)

Data communication among the devices (the management server 1, the first server 2, the second server 3, the first terminal 4, and the second terminal 5) may not be particularly limited and may be selected as appropriate according to an embodiment. A network among the devices may be selected as appropriate from, for example, the Internet, a wireless communication network, a mobile communication network, a telephone network, a dedicated network, and a local area network. The data communication among the devices may be encrypted by a method such as SSL (Secure Socket Layer) or TLS (Transport Layer Security). In an example, the terminals (4 and 5) may include SIMs (Subscriber Identity Modules). Data communication between the management server 1 and the terminals (4 and 5) may be performed by encrypted communication using the SIMS.

### 2 Configuration Example

### [Hardware Configuration Example]

### (Management Server)

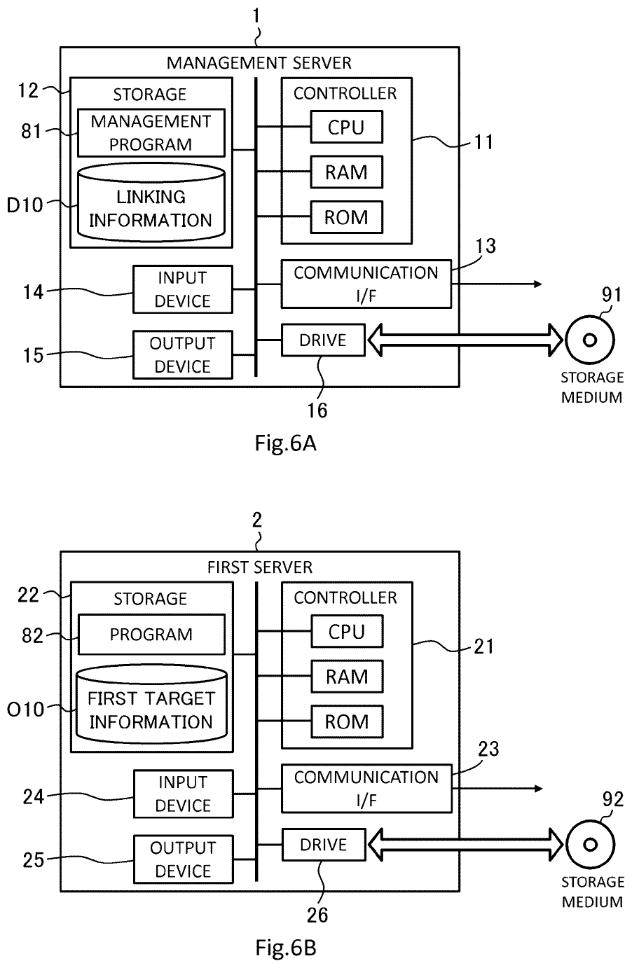

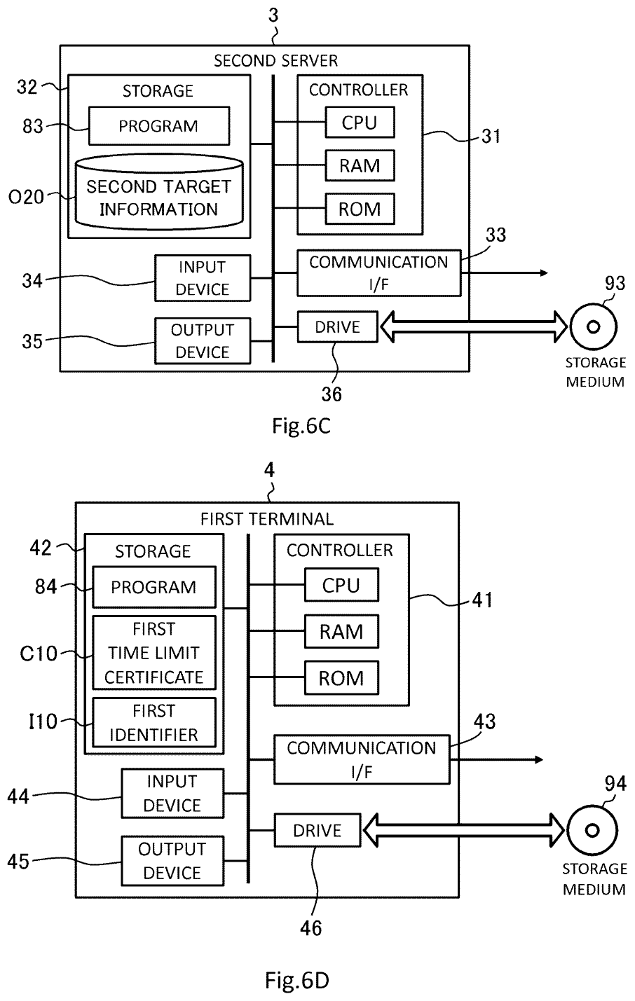

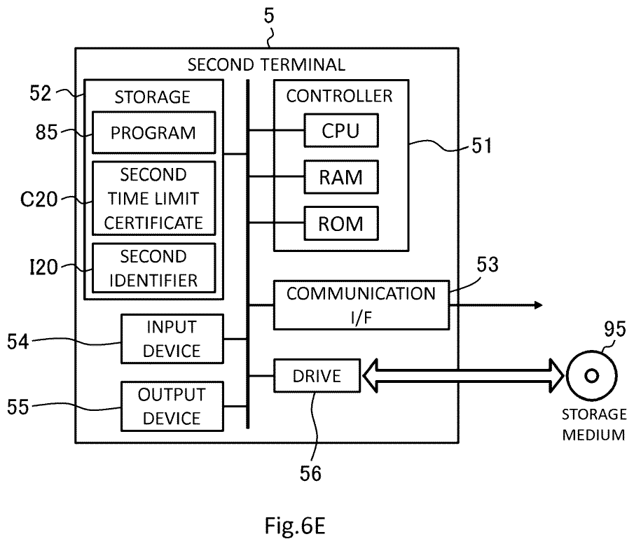

FIG. 6A schematically illustrates an example of a hardware configuration of the management server 1 according to the present embodiment. The management server 1 according to the present embodiment is a computer in which a controller 11, a storage 12, a communication interface 13, an input device 14, an output device 15, and a drive 16 are electrically connected. The controller 11 includes a CPU (Central Processing Unit), which is a hardware processor, a RAM (Random Access Memory), and a ROM (Read Only Memory) and is configured to execute any information processing based on a program and various data. The controller 11 (the CPU) is an example of a processor resource of the management server 1.

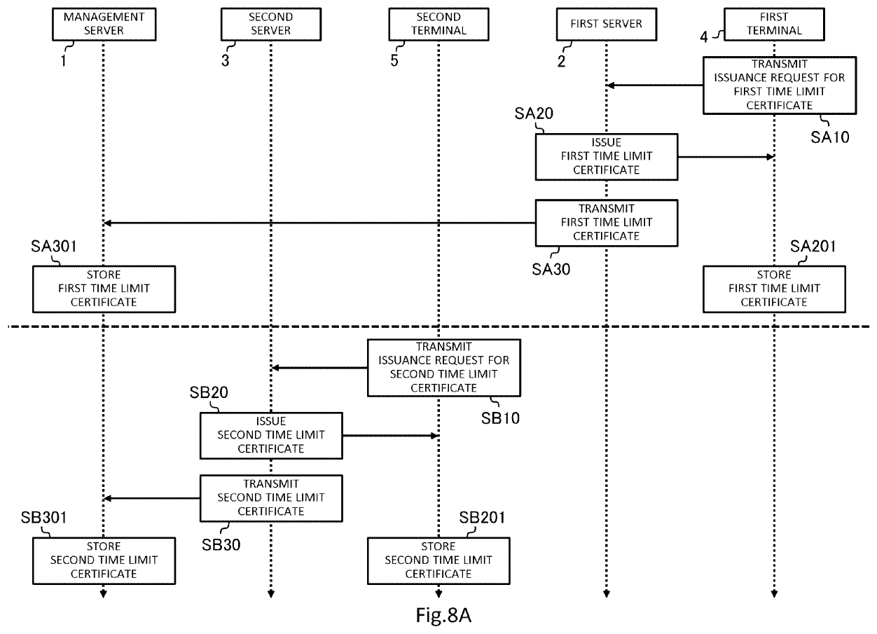

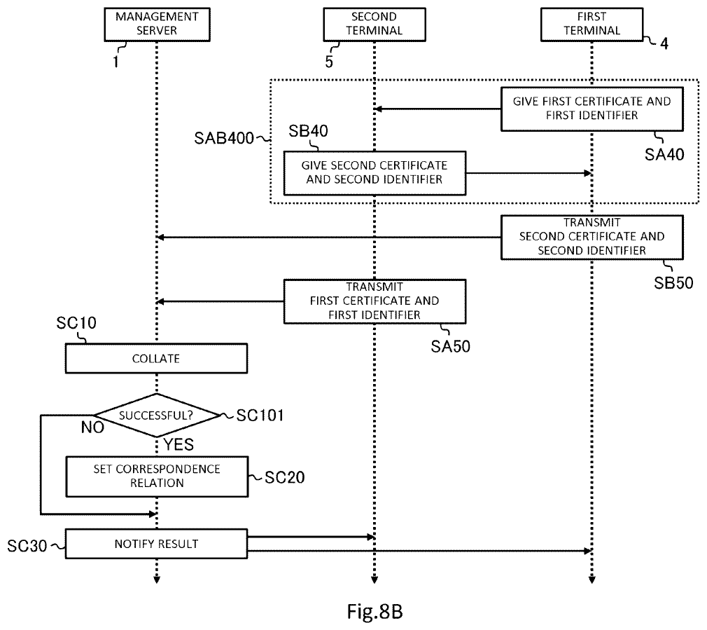

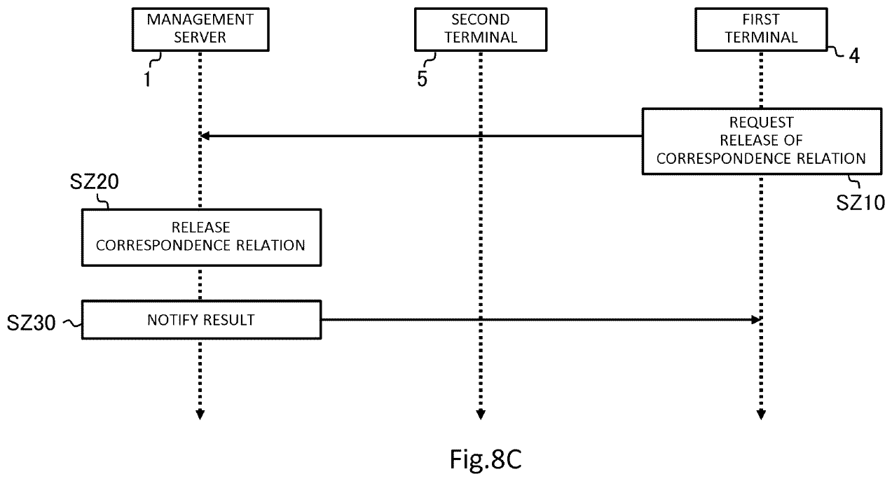

The storage 12 may be configured by, for example, a hard disk drive, a solid state drive, or a semiconductor memory. The storage 12 (and the RAM and the ROM) is an example of a memory resource. In the present embodiment, the storage 12 stores various kinds of information such as a management program 81 and the linking information D10. The management program 81 is a program for causing the management server 1 to execute information processing (FIG. 8A to FIG. 8C and the like referred to later) concerning setting and release of a correspondence relation between the first target and the second target. The management program 81 includes a series of instructions of the information processing.

The communication interface 13 is configured to perform wired or wireless communication via a network. The communication interface 13 may be configured by, for example, a wired LAN (Local Area Network) module or a wireless LAN module. The management server 1 may execute data communication between the management server 1 and other computers (the first server 2, the second server 3, the first terminal 4, and the second terminal 5) via the communication interface 13.

The input device 14 is a device for performing input such as a mouse, a keyboard, or an operation button. The output device 15 is a device for performing output such as a display or a speaker. An operator can operate the management server 1 by using the input device 14 and the output device 15. The input device 14 and the output device 15 may be integrally configured by, for example, a touch panel display. The input device 14 and the output device 15 may be connected via an external interface. The external interface may be configured as appropriate to be connected to an external device by wire or radio by, for example, a USB (Universal Serial Bus) port, a dedicated port, or a wireless communication port.

The drive 16 is a device for reading various kinds of information such as programs stored in a storage medium 91. At least one of the management program 81 and the linking information D10 explained above may be stored in the storage medium 91 instead of the storage 12 or in addition to the storage 12. The storage medium 91 is configured to accumulate, to enable a machine such as a computer to read the various kinds of information (the stored programs and the like), the information with electric, magnetic, optical, mechanical, or chemical action. The management server 1 may acquire at least one of the management program 81 and the linking information D10 explained above from the storage medium 91. Note that the storage medium 91 may be a disk-type storage medium such as a CD or a DVD or may be a storage medium other than the disk type such as a semiconductor memory (for example, a flash memory). A type of the drive 16 may be selected as appropriate according to the type of the storage medium 91. The drive 16 may be connected via the external interface.

Note that, concerning a specific hardware configuration of the management server 1, components can be omitted, substituted, and added according to an embodiment. For example, the controller 11 may include a plurality of hardware processors. The hardware processor may be configured by a microprocessor, an FPGA (field-programmable gate array), a DSP (digital signal processor), a GPU (Graphics Processing Unit), an ASIC (application specific integrated circuit), or the like. At least any one of the input device 14, the output device 15, and the drive 16 may be omitted. The linking information D10 may be stored not in the storage 12 but in an external computer (for example, a NAS: Network Attached Storage) accessible by the management server 1. The management server 1 may be configured by a plurality of computers. In this case, hardware configurations of the computers may coincide or may not coincide. The management server 1 may be a general-purpose server device, a general-purpose computer, or the like besides an information processing device designed exclusively for a service to be provided.

### (First Server)

FIG. 6B schematically illustrates an example of a hardware configuration of the first server 2 according to the present embodiment. The first server 2 according to the present embodiment is a computer in which a controller 21, a storage 22, a communication interface 23, an input device 24, an output device 25, and a drive 26 are electrically connected. The controller 21 to the drive 26 of the first server 2 and a storage medium 92 may be respectively configured the same as the controller 11 to the drive 16 of the management server 1 and the storage medium 91.

The controller 21 (the CPU) is an example of a processor resource of the first server 2. The storage 22 (and the RAM and the ROM) is an example of a memory resource of the first server 2. In the present embodiment, the storage 22 stores various kinds of information such as a program 82 and the first target information O10. The program 82 is a program for causing the first server 2 to execute information processing (FIG. 8A and the like referred to later) concerning issuance of a time limit certificate for the first target. The program 82 includes a series of instructions of the information processing. At least one of the program 82 and the first target information O10 may be stored in the storage medium 92 instead of the storage 22 or in addition to the storage 22. The first server 2 may acquire at least one of the program 82 and the first target information O10 from the storage medium 92. The first server 2 may perform data communication between the first server 2 and other computers (the management server 1, the first terminal 4, and the like) via the communication interface 23. The first server 2 may be operated via the input device 24 and the output device 25.

Note that, concerning a specific hardware configuration of the first server 2, components can be omitted, substituted, and added as appropriate according to an embodiment. For example, the controller 21 may include a plurality of hardware processors. The hardware processor may be configured by a microprocessor, a FPGA, a DSP, a GPU, an ASIC, or the like. At least any one of the input device 24, the output device 25, and the drive 26 may be omitted. The first target information O10 may be stored not in the storage 22 but in an external computer (for example, a NAS) accessible by the first server 2. The first server 2 may be configured by a plurality of computers. In this case, hardware configurations of the computers may coincide or may not coincide. The first server 2 may be a general-purpose server device, a general-purpose computer, or the like besides an information processing device designed exclusively for a service to be provided.

### (Second Server)

FIG. 6C schematically illustrates an example of a hardware configuration of the second server 3 according to the present embodiment. The second server 3 according to the present embodiment is a computer in which a controller 31, a storage 32, a communication interface 33, an input device 34, an output device 35, and a drive 36 are electrically connected. The controller 31 to the drive 36 of the second server 3 and a storage medium 93 may be respectively configured the same as the controller 11 to the drive 16 of the management server 1 and the storage medium 91.

The controller 31 (the CPU) is an example of a processor resource of the second server 3. The storage 32 (and the RAM and the ROM) is an example of a memory resource of the second server 3. In the present embodiment, the storage 32 stores various kinds of information such as a program 83 and the second target information O20. The program 83 is a program for causing the second server 3 to execute information processing concerning issuance of a time limit certificate for the second target (FIG. 8A and the like referred to later). The program 83 includes a series of instructions of the information processing. At least one of the program 83 and the second target information O20 may be stored in the storage medium 93 instead of the storage 32 or in addition to the storage 32. The second server 3 may acquire at least one of the program 83 and the second target information O20 from the storage medium 93. The second server 3 may perform data communication between the second server 3 and other computers (the management server 1, the second terminal 5, and the like) via the communication interface 33. The second server 3 may be operated via the input device 34 and the output device 35.

Note that, concerning a specific hardware configuration of the second server 3, components can be omitted, substituted, and added as appropriate according to an embodiment. For example, the controller 31 may include a plurality of hardware processors. The hardware processor may be configured by a microprocessor, an FPGA, a DSP, a GPU, an ASIC, or the like. At least any one of the input device 34, the output device 35, and the drive 36 may be omitted. The second target information O20 may be stored not in the storage 32 but in an external computer (for example, a NAS) accessible by the second server 3. The second server 3 may be configured by a plurality of computers. In this case, hardware configurations of the computers may coincide or may not coincide. The second server 3 may be a general-purpose server device, a general-purpose computer, or the like besides an information processing device designed exclusively for a service to be provided.

### (First Terminal)

FIG. 6D schematically illustrates an example of a hardware configuration of the first terminal 4 according to the present embodiment. The first terminal 4 according to the present embodiment is a computer in which a controller 41, a storage 42, a communication interface 43, an input device 44, an output device 45, and a drive 46 are electrically connected. The controller 41 to the drive 46 of the first terminal 4 and a storage medium 94 may be respectively configured the same as the controller 11 to the drive 16 of the management server 1 and the storage medium 91.

The controller 41 (the CPU) is an example of a processor resource of the first terminal 4. The storage 42 (and the RAM and the ROM) is an example of a memory resource of the first terminal 4. In the present embodiment, the storage 42 stores various kinds of information such as a program 84, the first time limit certificate C10, and the first identifier I10. The program 84 is a program for causing the first terminal 4 to execute information processing concerning linking (FIGS. 8A to 8C referred to later). The program 84 includes a series of instructions of the information processing. At least any one of the program 84, the first time limit certificate C10, and the first identifier I10 may be stored in the storage medium 94 instead of the storage 42 or in addition to the storage 42. The first terminal 4 may acquire at least any one of the program 84, the first time limit certificate C10, and the first identifier I10 from the storage medium 94. The first terminal 4 may perform data communication between the first terminal 4 and other computers (the management server 1, the first server 2, the second terminal 5, and the like) via the communication interface 43. The first terminal 4 may be operated via the input device 44 and the output device 45.

Note that, concerning a specific hardware configuration of the first terminal 4, components can be omitted, substituted, and added as appropriate according to an embodiment. For example, the controller 41 may include a plurality of hardware processors. The hardware processor may be configured by a microprocessor, an FPGA, a DSP, a GPU, an ASIC, an ECU (Electronic Control Unit), or the like. At least any one of the input device 44, the output device 45, and the drive 46 may be omitted. The first identifier I10 may not be stored in the storage 42. The first identifier I10 may be acquired every time. In order to acquire data such as an identifier and a certificate, the first terminal 4 may further include a data acquisition device such as a sensor or a reading device. The communication interface 43 may be configured by a plurality of kinds of modules. For example, the communication interface 43 may include a short-range wireless communication module and a wireless communication module. The first terminal 4 may perform data communication with the second terminal 5 via the short-range wireless communication module and perform data communication with the management server 1 via the wireless communication module. The first terminal 4 may be configured by a plurality of computers. In this case, hardware configurations of the computers may coincide or may not coincide. The first terminal 4 may be a general-purpose computer or a terminal device (for example, a smartphone or a tablet PC) besides an information processing device designed exclusively for a service to be provided.

### (Second Terminal)

FIG. 6E schematically illustrates an example of a hardware configuration of the second terminal 5 according to the present embodiment. The second terminal 5 according to the present embodiment is a computer in which a controller 51, a storage 52, a communication interface 53, an input device 54, an output device 55, and a drive 56 are electrically connected. The controller 51 to the drive 56 of the second terminal 5 and a storage medium 95 are respectively configured the same as the controller 11 to the drive 16 of the management server 1 and the storage medium 91.

The controller 51 (the CPU) is an example of a processor resource of the second terminal 5. The storage 52 (the RAM and the ROM) is an example of a memory resource of the second terminal 5. In the present embodiment, the storage 52 stores various kinds of information such as a program 85, the second time limit certificate C20, and the second identifier I20. The program 85 is a program for causing the second terminal 5 to execute information processing concerning linking (FIGS. 8A to 8C referred to later). The program 85 includes a series of instructions of the information processing. At least any one of the program 85, the second time limit certificate C20, and the second identifier I20 may be stored in the storage medium 95 instead of the storage 52 or in addition to the storage 52. The second terminal 5 may acquire at least any one of the program 85, the second time limit certificate C20, and the second identifier I20 from the storage medium 95. The second terminal 5 may perform data communication between the second terminal 5 and other computers (the management server 1, the second server 3, the first terminal 4, and the like) via the communication interface 53. The second terminal 5 may be operated via the input device 54 and the output device 55.

Note that, concerning a specific hardware configuration of the second terminal 5, components can be omitted, substituted, and added as appropriate according to an embodiment. For example, the controller 51 may include a plurality of hardware processors. The hardware processor may be configured by a microprocessor, an FPGA, a DSP, a GPU, an ASIC, an ECU, or the like. At least any one of the input device 54, the output device 55, and the drive 56 may be omitted. The second identifier I20 may not be stored in the storage 52. The second identifier I20 may be acquired every time. In order to acquire data such as an identifier and a certificate, the second terminal 5 may further include a data acquisition device such as a sensor or a reading device. As in the first terminal 4 explained above, the communication interface 53 may be configured by a plurality of kinds of modules. The second terminal 5 may be configured by a plurality of computers. In this case, hardware configurations of the computers may coincide or may not coincide. The second terminal 5 may be a general-purpose computer, a terminal device, or the like besides an information processing device designed exclusively for a service to be provided.

### [Software Configuration Example]

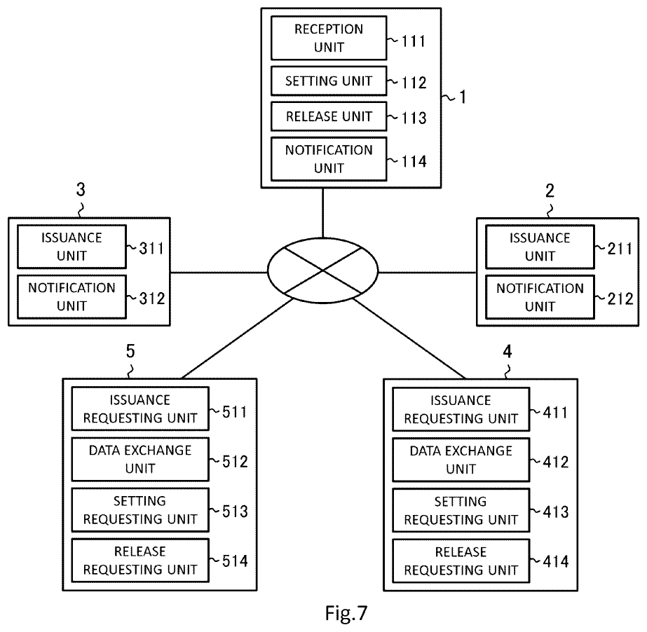

FIG. 7 schematically illustrates an example of software configurations of the devices (the management server 1, the first server 2, the second server 3, the first terminal 4, and the second terminal 5) according to the present embodiment.

### (Management Server)

The controller 11 of the management server 1 loads, in the RAM, the management program 81 stored in the storage 12 and executes, with the CPU, an instruction included in the management program 81. Accordingly, the management server 1 operates as a computer including a collation unit 111, a setting unit 112, a release unit 113, and a notification unit 114 as software modules.

The collation unit 111 is configured to receive, according to a use relation occurring between the first target and the second target, from at least one of the first terminal 4 and the second terminal 5, the first certificate C1 submitted to correspond to the first time limit certificate C10 and the second certificate C2 submitted to correspond to the second time limit certificate C20. The collation unit 111 is configured to collate the received certificates (C1 and C2) and the time limit certificates (C10 and C20) notified from the servers (2 and 3).

The setting unit 112 is configured to, when both of the collations of the certificates (C1 and C2) and the time limit certificates (C10 and C20) (authentications of the first target and the second target) are successful, set a correspondence relation between the first identifier I10 and the second identifier I20. The release unit 113 is configured to release the correspondence relation according to reception of a release request from at least one of the first terminal 4 and the second terminal 5 or satisfaction of a predetermined release condition. The notification unit 114 is configured to transmit notification indicating a result of the processing for setting the correspondence relation to at least one of the first terminal 4 and the second terminal 5. The notification unit 114 is configured to transmit notification indicating a result of the processing for releasing the correspondence relation to at least one of the first terminal 4 and the second terminal 5.

### (First Server)

The controller 21 of the first server 2 executes, with the CPU, an instruction included in the program 82. Accordingly, the first server 2 operates as a computer including an issuance unit 211 and a notification unit 212 as software modules. The issuance unit 211 is configured to issue the first time limit certificate C10 of the first target. The first time limit certificate C10 may be generated in response to an issuance request from the first target or may be spontaneously generated. The notification unit 212 is configured to notify the issued first time limit certificate C10.

### (Second Server)

The controller 31 of the second server 3 executes, with the CPU, an instruction included in the program 83. Accordingly, the second server 3 operates as a computer including an issuance unit 311 and a notification unit 312 as software modules. The issuance unit 311 is configured to issue the second time limit certificate C20 of the second target. The second time limit certificate C20 may be generated in response to an issuance request from the second target or may be spontaneously generated. The notification unit 312 is configured to notify the issued second time limit certificate C20.

### (First Terminal)

The controller 41 of the first terminal 4 executes, with the CPU, an instruction included in the program 84. Accordingly, the first terminal 4 operates as a computer including an issuance requesting unit 411, a data exchange unit 412, a setting requesting unit 413, and a release requesting unit 414 as software modules. The issuance requesting unit 411 is configured to request the first server 2 to issue the first time limit certificate C10. The data exchange unit 412 is configured to execute data exchange with the second terminal 5. The setting requesting unit 413 is configured to transmit data used for authentication to the management server 1 to request the management server 1 to set a correspondence relation between the first target and the second target. The release requesting unit 414 is configured to request the management server 1 to release the correspondence relation.

### (Second Terminal)

The controller 51 of the second terminal 5 executes, with the CPU, an instruction included in the program 85. Accordingly, the second terminal 5 operates as a computer including an issuance requesting unit 511, a data exchange unit 512, a setting requesting unit 513, and a release requesting unit 514 as software modules. The issuance requesting unit 511 is configured to request the second server 3 to issue the second time limit certificate C20. The data exchange unit 512 is configured to execute data exchange with the first terminal 4. The setting requesting unit 513 is configured to transmit data used for authentication to the management server 1 to request the management server 1 to set a correspondence relation between the first target and the second target. The release requesting unit 514 is configured to request the management server 1 to release the correspondence relation.

### (Others)

In the present embodiment, an example is explained in which all of the software modules of the devices are implemented by the general-purpose CPUs. However, some or all of the software modules may be implemented by one or a plurality of dedicated processors. The modules explained above may be implemented as hardware modules. Concerning the software configurations of the devices, modules may be omitted, substituted, and added as appropriate according to an embodiment. For example, when the mode of the collective transmission explained above is adopted as a transmission mode of data used for authentication, the setting requesting unit (413 or 513) may be omitted from one of the first terminal 4 and the second terminal 5 (a terminal not in charge of data transmission). For example, when a mode of transmitting a release request from only one of the first terminal 4 and the second terminal 5 is adopted, the release requesting unit (414 or 514) may be omitted from the other terminal.

### 3 Operation Example

### (Linking Setting)

FIG. 8A and FIG. 8B illustrate examples of processing procedures of linking setting by the management system 100 according to the present embodiment. The processing procedures explained below are examples of a management method executed by a computer. Note that, in the examples illustrated in FIG. 8A and FIG. 8B, a scene in which a mode in which the first pattern of the divided transmission is adopted as a transmission mode of data used for authentication, the time limit certificates (C10 and C20) are issued beforehand prior to a request for linking setting, and the terminals (4 and 5) acquire data used for authentication in data exchange is adopted is assumed.

In step SA10, the controller 41 of the first terminal 4 operates as the issuance requesting unit 411 and transmits an issuance request for the first time limit certificate C10 to the first server 2. In step SA20, the controller 21 of the first server 2 operates as the issuance unit 211 and issues the time limit certificate C10 in relation to the first identifier I10 in response to reception of the issuance request. Note that an individual of the first target may be identified as appropriate between the first terminal 4 and the first server 2. In a typical example, the first terminal 4 may transmit an issuance request including the first identifier I10 to the first server 2. The individual of the first target may be identified in the first server 2 with the first identifier I10 included in the issuance request.

The controller 21 operates as the notification unit 212 and returns the issued first time limit certificate C10 to the first terminal 4. In response to the return, in step SA201, the controller 41 of the first terminal 4 receives the issued first time limit certificate C10 from the first server 2 and store the received first time limit certificate C10 to be usable as the first certificate C1. In step SA30, the controller 21 of the first server 2 operates as the notification unit 212 and notifies the issued first time limit certificate C10 to the management server 1. In response to the notification, in step SA301, the controller 11 of the management server 1 receives the issued first time limit certificate C10 from the first server 2 and stores the received first time limit certificate C10. In an example, the controller 21 may transmit the first time limit certificate 10 to the management server 1 with the first identifier I10 added to the first time limit certificate C10. The management server 1 may store the first time limit certificate C10 in correlation with the first identifier I10.

In step SB10, the controller 51 of the second terminal 5 operates as the issuance requesting unit 511 and transmits an issuance request for the second time limit certificate C20 to the second server 3. In step SB20, the controller 31 of the second server 3 operates as the issuance unit 311 and issues the second time limit certificate C20 in relation to the second identifier I20 in response to reception of the issuance request. Note that, like the first target, an individual of the second target may be identified as appropriate between the second terminal 5 and the second server 3. In a typical example, the issuance request may include the second identifier I20. The individual of the second target may be identified in the second server 3 with the second identifier I20 included in the issuance request.

The controller 31 operates as the notification unit 312 and returns the issued second time limit certificate C20 to the second terminal 5. In response to the return, in step SB201, the controller 51 of the second terminal 5 receives the issued second time limit certificate C20 from the second server 3 and stores the received second time limit certificate C20 to be usable as the second certificate C2. In step SB30, the controller 31 of the second server 3 operates as the notification unit 312 and notifies the issued second time limit certificate C20 to the management server 1. In response to the notification, in step SB301, the controller 11 of the management server 1 receives the issued second time limit certificate C20 from the second server 3 and stores the received second time limit certificate C20. In an example, the controller 31 may transmit the second time limit certificate C20 to the management server 1 with the second identifier I20 added to the second time limit certificate C20. The management server 1 may store the second time limit certificate C20 in correlation with the second identifier I20.

In step SAB400, the controller 41 of the first terminal 4 operates as the data exchange unit 412 and executes data exchange with the second terminal 5. The controller 51 of the second terminal 5 operates as the data exchange unit 512 and executes data exchange with the first terminal 4. The data exchange may be executed as appropriate according to a use relation occurring between the first target and the second target. In step SA40, the controller 41 of the first terminal 4 gives the first identifier I10 and the first certificate C1 corresponding to the first time limit certificate C10 to the second terminal 5. In response to this, the controller 51 of the second terminal 5 acquires the first identifier I10 and the first certificate C1 from the first target. In step SB40, the controller 51 of the second terminal 5 gives the second identifier I20 and the second certificate C2 corresponding to the second time limit certificate C20 to the first terminal 4. In response to this, the controller 41 of the first terminal 4 acquires the second identifier I20 and the second certificate C2 from the second target. The processing in step SA40 and step SB40 may be executed in the processing of the data exchange.

In step SA50, the controller 51 of the second terminal 5 operates as the setting requesting unit 513 and transmits a request for linking setting including an authentication demand configured by the first identifier I10 and the first certificate C1 to the management server 1. In response to the transmission, the controller 11 of the management server 1 receives the first identifier I10 and the first certificate C1. In step SB50, the controller 41 of the first terminal 4 operates as the setting requesting unit 413 and transmits a request for linking setting including an authentication demand configured by the second identifier I20 and the second certificate C2 to the management server 1. In response to the transmission, the controller 11 of the management server 1 receives the second identifier I20 and the second certificate C2. The controller 11 associates, as appropriate, the data respectively received from the first terminal 4 and the second terminal 5 and specifies a combination of the first target and the second target that are requesting setting of a correspondence relation.

In step SC10, the controller 11 of the management server 1 operates as the collation unit 111 and collates the first certificate C1 of the first target and the effective first time limit certificate C10. The controller 11 collates the second certificate C2 of the second target and the effective second time limit certificate C20. In step S101, the controller 11 determines whether both of the collations of the first target and the second target are successful. When both of the collations of the first target and the second target are successful, the controller 11 advances the processing to the next step SC20. On the other hand, when the collation of at least one of the first target and the second target is unsuccessful, the controller 11 omits the processing in step SC20 and advances the processing to step SC30. Note that, when the first time limit certificate C10 and the second time limit certificate C20 are expired because the expiration date has elapsed, the collations of the first target and the second target are unsuccessful.

In step SC20, the controller 11 operates as the setting unit 112 and sets a correspondence relation between the first identifier I10 and the second identifier I20. In an example, the controller 11 generates the linking information D10 indicating the correspondence relation between the first identifier I10 and the second identifier I20 and stores the generated linking information D10. In step SC30, the controller 11 operates as the notification unit 114 and transmits notification indicating a result of the processing for setting a correspondence relation to at least one of the first terminal 4 and the second terminal 5. When the notification of the result is completed, the processing procedure concerning the linking setting according to this operation example ends.

Note that the processing procedure explained above is only an example. The steps may be changed as much as possible. Concerning the processing procedure explained above, steps can be omitted, substituted, and added as appropriate according to an embodiment.

For example, order of issuing the first time limit certificate C10 and the second time limit certificate C20 may not be particularly limited and may be changed as appropriate according to an embodiment. Whichever of the first time limit certificate C10 and the second time limit certificate C20 may be issued first. The processing for issuing the first time limit certificate C10 (step SA10 to step SA30) and the processing for issuing the second time limit certificate C20 (step SB10 to step SB30) may be at least partially executed in parallel. Order of transmitting the issued time limit certificates (C10 and C20) may not be limited to the example explained above. The servers (2 and 3) may at least partially transmit the time limit certificates (C10 and C20) in parallel to the terminals (4 and 5) and the management server 1. The servers (2 and 3) may transmit the time limit certificates (C10 and C20) to the management server 1 before the terminals (4 and 5). When the first server 2 spontaneously generates the first time limit certificate C10, the processing in step SA10 may be omitted. When the second server 3 spontaneously generates the second time limit certificate C20, the processing in step SB10 may be omitted.

For example, the processing in step SA50 may be executed at any timing after step SA40. The processing in step SB50 may be executed at any timing after step SB40. The processing in step SA40 and step SA50 may be at least partially executed in parallel to the processing in step SB40 and step SB50. The processing in step SA50 may be executed before step SB40. The processing in step SB50 may be executed before step SA40. The processing in step SA20 may be executed at any timing before step SA40. The processing in step SB20 may be executed at any timing before step SB40. The processing in step SA30 may be executed before step SA50 or may be executed in response to an inquiry from the management server 1 after step SA50. The processing in step SB30 may be executed before step SB50 or may be executed in response to an inquiry from the management server 1 after step SB50.

The transmission mode of data used for authentication may not be limited to the first pattern of the divided transmission and may be selected as appropriate according to an embodiment. In another example, as the transmission mode of data used for authentication, a mode other than the first pattern of the divided transmission (the second to fourth patterns of the divided transmission, the others of the divided transmission, or the collective transmission) among the transmission modes explained above may be adopted. Accordingly, the processing in step SA40, step SA50, step SB40, and step SB50 may be changed as appropriate.

### (Linking Release)

FIG. 8C illustrates an example of a processing procedure of linking release by the management system 100 according to the present invention. The processing procedure explained below is an example of a management method executed by a computer. Note that, in the example illustrated in FIG. 8C, a scene in which a mode of omitting the authentication processing and directly transmitting a release request from the first terminal 4 to the management server 1 is adopted is assumed.

In step SZ10, the controller 41 of the first terminal 4 operates as the release requesting unit 414 and transmits a request (a demand) for releasing a correspondence relation to the management server 1. In response to the transmission, the controller 11 of the management server 1 receives the release request. The correspondence relation for which the release is requested may be designated as appropriate. A trigger for the release request may be selected as appropriate according to an embodiment.

In step SZ20, the controller 11 operates as the release unit 113 and releases the correspondence relation designated by the received release request. The releasing may be configured by generating information indicating that the correspondence relation has been released and recording the generated information. In an example, when the linking information D10 has the configuration illustrated in FIG. 3A, the controller 11 may add release time to the corresponding linking information D10 or setting a flag of release to release the target correspondence relation. When the linking information D10 is configured by a blockchain base, the controller 11 may generate a transaction indicating the linking release and add the generated transaction to a blockchain to release the target correspondence relation.

In step SZ30, the controller 11 operates as the notification unit 114 and transmits a processing result of the linking release to the first terminal 4. When the notification of the result is completed, the processing procedure concerning the linking release according to this operation example ends.

Note that the processing procedure explained above is only an example. The steps may be changed as much as possible. Concerning the processing procedure explained above, steps can be omitted, substituted, and added as appropriate according to an embodiment.

For example, as explained above, a transmission route for the release request may not be limited to the example illustrated in FIG. 8C and may be selected as appropriate according to an embodiment. The release request may be transmitted from the second terminal 5 (the release requesting unit 514). The processing of the release request may include authentication processing for at least one of the first target and the second target. Instead of step SZ20 explained above, the controller 11 of the management server 1 may operate as the release unit 113 and release the correspondence relation according to satisfaction of a predetermined release condition.

### [Characteristics]

In the present embodiment, according to a use relation occurring between the first target and the second target, authentications of the respective first and second targets are performed using the time limit certificates (C10 and C20) by the processing in step SC10. The time limit certificates (C10 and C20) are configured to expire when the expiration date elapses. For that reason, it is possible to prevent the same time limit certificate from being permanently used. Accordingly, it can be expected that security is ensured. When both of the authentications of the first target and the second target are successful by the processing in step SC20, a correspondence relation between the first identifier and the second identifier is set. A record of the linking setting (the linking information D10) makes it possible to track the use relation between the first target and the second target. Therefore, according to the present embodiment, it is possible to track the use relation between the first target and the second target while ensuring security.

### 4 Modifications

The embodiment of the present disclosure is explained in detail above. However, the above explanation is only exemplification of the present disclosure in all aspects. It goes without saying that various improvements or modifications can be made without departing from the scope of the present disclosure. For example, changes explained below are possible. Note that, in the following explanation, the same reference numerals and signs are used concerning the same components as the components in the embodiment and explanation is omitted as appropriate concerning similarities to the embodiment. Modifications explained below can be combined as appropriate.

<4.1>

In the embodiment explained above, as one of utilization examples, the linking information D10 may be utilized in order to exercise an authority correlated with one of the first target and the second target from the other. In the examples illustrated in FIG. 2 and FIG. 5, as an example of modes of the utilization, a scene in which one target (a user) exercises an authority of the target via the other target (an object to be used/a mobile body) is assumed. However, a mode of exercising the authority may not be limited to such an example. In another example, the management system 100 may be configured to enable the first target to exercise an authority of the other first target by proxy via the second target. In addition or alternatively, the management system 100 may be configured to enable the second target to exercise an authority of the other second target by proxy via the first target. That is, a proxy individual of one target of the first target and the second target may be configured to be capable of exercising an authority of a proxy requesting individual (a target individual) of one target by proxy via (any individual of) the other target. In the examples illustrated in FIG. 2 and FIG. 5, the management system 100 may be configured to enable a proxy user to exercise an authority of a target user (a proxy requester) from an object to be used (a mobile body).

An authority proxy method may be configured as appropriate. As an example, any one of the following three methods may be adopted as the authority proxy method. Note that, in the following explanation, for convenience of explanation, a case in which the first target and the second target are a user and an object to be used (a mobile body) is assumed. That is, the proxy patterns in the examples illustrated in FIG. 2 and FIG. 5 are explained. However, an application range of the proxy patterns may not be limited to the case in which the first target and the second target are the user and the object to be used. In the proxy patterns explained below, the user (the first target) may be replaced with one of the first target and the second target and the object to be used (the second target) may be replaced with the other of the first target and the second target. Typically, the object to be used may be the mobile body explained above.

### (1) First Proxy Pattern (Proxy Authentication/Proxy Linking)

As a first proxy pattern, the management system 100 may be configured to set a correspondence relation between the target user (the proxy requester) and the object to be used according to authentication of the first user (the first target) and the object to be used (the second target) being successful by authentication processing for a proxy by the proxy user. The management system 100 may be configured to be capable of permitting the proxy user to exercise an authority correlated with the target user by proxy via the object to be used while the correspondence relation is set. The proxy user is an example of the proxy individual and the target user (the proxy requester) is an example of the proxy requesting individual (the target individual).

That is, a user terminal (in the example illustrated in FIG. 2, the first terminal 4) relating to a user may be a proxy user terminal carried by a proxy user who represents the user. In this case, data exchange may be executed as appropriate among the target user terminal, the proxy user terminal, and the loading terminal when a use relation occurs between the first target and the second target. In an example, the use relation between the first target and the second target may occur at least through data communication between the target user terminal carried by the user and the proxy user terminal and data communication between the proxy user terminal and the loading terminal.

A method of the proxy authentication may not be particularly limited and may be set as appropriate according to an embodiment. The method of the proxy authentication only has to be configured such that, in place of the target user terminal, the proxy user terminal executes at least a part of authentication processing for the target user (the first target) and the object to be used (the second target) in the embodiment explained above. As an example, as the method of the proxy authentication, one of the following two methods may be adopted.

### (1-1) 1-1-Th Proxy Pattern

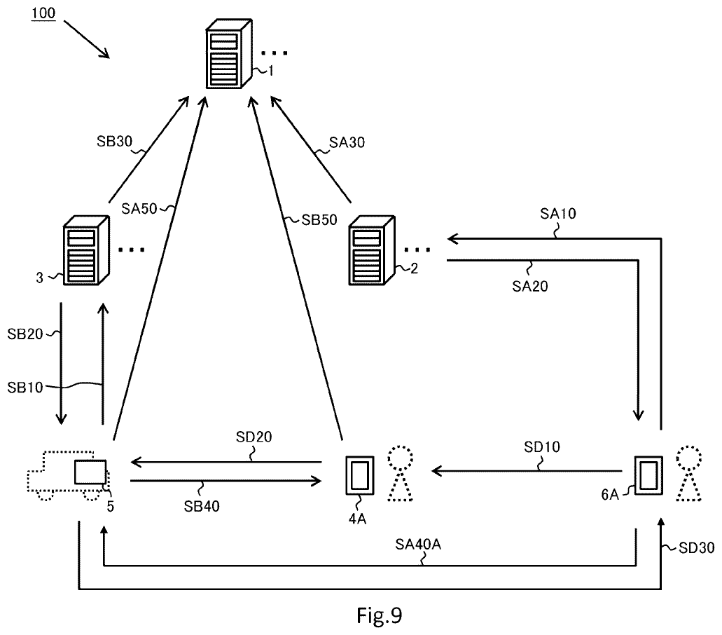

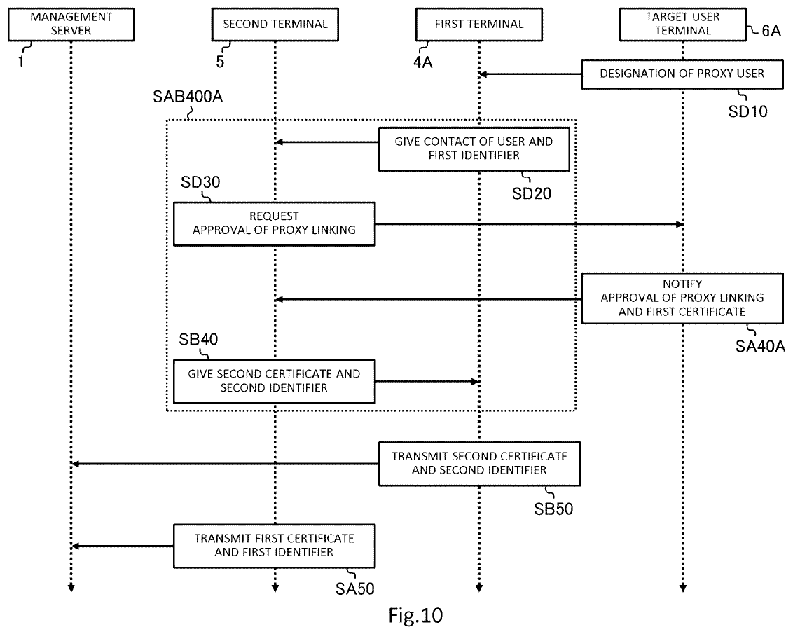

FIG. 9 schematically illustrates an example of a process of linking setting in a 1-1-th proxy pattern according to the present embodiment. FIG. 10 illustrates an example of a processing procedure of the linking setting in the 1-1-th proxy pattern according to the present embodiment. In the examples illustrated in FIG. 9 and FIG. 10, a first terminal 4A is the proxy user terminal and corresponds to the first terminal 4 in the examples illustrated in FIG. 2 and FIG. 5 in the embodiment explained above. The first target is a target user (a proxy requester) who requests a proxy. A target user terminal 6A is a terminal carried by the target user. Hardware configurations of the first terminal 4A and the target user terminal 6A may be the same as the hardware configurations of the first terminal 4 and the like in the embodiment explained above. In the examples illustrated in FIG. 9 and FIG. 10, a scene in which a mode of adopting the first pattern of the divided transmission as a transmission mode of data used for authentication and transmitting the first identifier I10 through the first terminal 4A and not transmitting the first certificate C1 through the first terminal 4A is adopted is assumed.

First, the processing in step SA10 to step SA30 is executed between the target user terminal 6A and the first server 2 as in the embodiment explained above. As a result of the execution, the first time limit certificate C10 is issued. The issued first time limit certificate C10 is notified to the target user terminal 6A and the management server 1. Step SB10 to step SB30 may be executed between the second terminal 5 and the second server 3 as in the embodiment explained above. As a result of the execution, the second time limit certificate C20 is issued. The issued second time limit certificate C20 is notified to the second terminal 5 and the management server 1.

In step SD10, a controller of the target user terminal 6A operates as a proxy designation unit and receives designation of a proxy user with respect to the target user. The proxy user may be designated as appropriate. In a typical example, the target user terminal 6A may store an address book. The proxy user may be selected from users registered in the address book. In another example, the target user terminal 6A may access a list of users via the external computer such as the first server 2 and receive selection of the proxy user from the users registered in the list. When the proxy user is designated, the controller of the target user terminal 6A operates as a notification unit, performs data exchange with the first terminal 4A of the proxy user designated by the target user, and notifies that an agency is imparted. In response to the notification, a controller of the first terminal 4A of the proxy user receives the notification of the agency imparting from the target user terminal 6A. In an example, this notification may include the first identifier I10 (a user identifier) and a contact of the target user. The contact may be a telephone number, an electronic mail address, account information of a contact system application (for example, an application of a Social Networking Service), an identification number, or the like. Like the data exchange between the first terminal 4 and the second terminal 5, data exchange between the target user terminal 6A and the first terminal 4A may be performed by wireless or wired data communication or may be performed by a method other than the data communication such as two-dimensional code reading. The target user terminal 6A may directly give the notification of the agency imparting to the first terminal 4A or may indirectly transmit the notification of the agency imparting via the external computer such as the first server 2. When the data communication is adopted as the method of the data exchange, the notification of the agency imparting is an example of data communication between the target user terminal carried by the user and the proxy user terminal. Accordingly, the target user terminal 6A imparts an authority for authentication by proxy to the first terminal 4A and causes the first terminal 4A to execute processing for setting a correspondence relation between the first terminal 4A and the object to be used.

In step SAB400A, the controller of the first terminal 4A of the proxy user, to whom the agency has been imparted, operates as a data exchange unit and executes data exchange with the second terminal 5. The controller 51 of the second terminal 5 operates as the data exchange unit 512 and executes data exchange with the first terminal 4A. Like the data exchange between the first terminal 4 and the second terminal 5, the data exchange between the first terminal 4A and the second terminal 5 may be performed by wireless or wired data communication or may be performed by a method other than the data communication such as two-dimensional code reading. When the data communication is adopted as the method of data exchange, the data exchange between the first terminal 4A and the second terminal 5 is an example of data communication between the proxy user terminal and the loading terminal.

In step SD20, the controller of the first terminal 4A gives the first identifier I10 and the contact to the second terminal 5. In response to this, the controller 51 of the second terminal 5 acquires the first identifier I10 and the contact from the proxy user. Accordingly, the first terminal 4A causes the second terminal 5 to notify an approval request for proxy linking including an inquiry for the first certificate C1 of the target user to the target user terminal 6A and causes the second terminal 5 to transmit a request for linking setting including an authentication request configured by the acquired first certificate C1 and the acquired first identifier I10 to the management server 1. Note that a method in which the second terminal 5 acquires these may not be limited to such an example. In another example, at least one of the first identifier I10 and the contact may be input to the second terminal 5 when the proxy user operates the second terminal 5.

In step SD30, the controller 51 of the second terminal 5 operates as the data exchange unit 512 and notifies the approval request for the proxy linking including the inquiry for the first certificate C1 to the target user terminal 6A. In response to the notification, in step SA40A, the controller of the target user terminal 6A receives operation for determining whether to approve proxy linking for the target user. In response to the target user performing the operation for approval, the controller of the target user terminal 6A operates as a data exchange unit and gives a result of the approval of the proxy linking and the first certificate C1 of the target user to the second terminal 5. Accordingly, the target user terminal 6A causes the second terminal 5 to cooperate with the first terminal 4A and causes the second terminal 5 to transmit a request for linking setting to the management server 1. On the other hand, when the target user does not approve, the processing procedure of the linking setting by the proxy authentication may end as appropriate.

Note that, basically, the data exchange in step SD30 and step SA40A may be performed by direct or indirect data communication by radio or wire. In step SA40A, the controller of the target user terminal 6A may directly or indirectly transmit the first time limit certificate C1 issued by the first server 2 to the second terminal 5 as the first certificate C1. However, a method of the data exchange between the second terminal 5 and the target user terminal 6A may not be limited to such an example. In some case, a method other than the data communication such as two-dimensional code reading may be used.

In step SB40, as in the embodiment explained above, the controller 51 of the second terminal 5 gives the second identifier I20 and the second certificate C2 to the first terminal 4A. The controller of the first terminal 4A acquires the second identifier I20 and the second certificate C2 from the object to be used as appropriate. Accordingly, the second terminal 5 may cause the first terminal 4A to transmit a request for linking setting including an authentication request configured by the second identifier I20 and the second certificate C2 to the management server 1.

In step SB50, the controller of the first terminal 4A operates as a setting requesting unit and transmits the request for the linking setting including the second identifier I20 and the second certificate C2 to the management server 1. In step SA50, the controller 51 of the second terminal 5 operates as the setting requesting unit 513 and transmits the request for the linking setting including the first identifier I10 and the first certificate C1 to the management server 1. In response to the transmission, the management server 1 receives the first identifier I10, the first certificate C1, the second identifier I20, and the second certificate C2.

Thereafter, as in the embodiment explained above, the management server 1 may execute the processing in step SC10 and subsequent steps. According to both of the collations of the certificates (C1 and C2) and the time limit certificates (C10 and C20) being successful as a result of the execution, a correspondence relation between the target user (the first identifier I10) and the object to be used (the second identifier I20) is set. When the correspondence relation is set, the processing procedure of the linking setting by the proxy authentication ends. While the correspondence relation is set, the proxy user can exercise an authority of the target user (the proxy requester) from the object to be used.

Note that, in the 1-1-th proxy pattern explained above, a notification route for the first identifier I10 and the first certificate C1 may not be limited to the example explained above. The first identifier I10 may be directly or indirectly notified from the target user terminal 6A to the second terminal 5 not through the first terminal 4A at any timing such as step SA40A. In this case, the first identifier I10 may be omitted from the notification of the agency imparting. The first certificate C1 may be given to the first terminal 4A at any timing such as step SD10. Accordingly, the first certificate C1 may be given from the first terminal 4A to the second terminal 5. In this case, the first certificate C1 may be omitted from data given to the second terminal 5 in step SA40A. The approval processing for the proxy linking may be omitted. When a mode of omitting the approval processing for the proxy linking and giving the first certificate C1 from the first terminal 4A to the second terminal 5 is adopted, the processing in step SD30 and step SA40A may be omitted. In this case, information concerning the contact of the target user may be omitted from the notification of the agency imparting and the data given to the second terminal 5 in step SD20.

In the 1-1-th proxy pattern explained above, a transmission mode of the data used for the authentication may not be limited to the first pattern of the divided transmission and may be selected as appropriate according to an embodiment. In another example, as the transmission mode of the data used for the authentication, a mode other than the first pattern of the divided transmission (the second to fourth patterns of the divided transmission, the others of the divided transmission, or the collective transmission) among the transmission modes explained above may be adopted. Accordingly, the processing in step SD10 to step SD30, step SA40A, step SA50, step SB40, and step SB50 may be changed as appropriate. When a mode in which the second terminal 5 transmits at least parts of the data (the first identifier I10 and the first certificate C1) of the target user is adopted, as explained above, the second terminal 5 may acquire the data of the target user through the first terminal 4A or may acquire the data of the target user from the target user (the target user terminal 6A) not through the first terminal 4A. When a mode in which the first terminal 4A transmits at least parts of the data of the target user is adopted, the first terminal 4A may acquire the data of the target user through the second terminal 5 or may acquire the data of the target user from the target user (the target user terminal 6A) not through the second terminal 5. For example, the first terminal 4A may acquire the data of the target user through the second terminal 5 on a route of step SA40A and step SB40. The first terminal 4A may acquire the data of the target user from the target user (the target user terminal 6A) not through the second terminal 5 on a route of step SD10. When a mode in which the first terminal 4A transmits at least parts of data (the second identifier I20 and the second certificate C2) of the object to be used is adopted, as explained above, the first terminal 4A may acquire the data of the object to be used from the object to be used as appropriate. Similarly, the second terminal 5 may acquire the data of the object to be used as appropriate. In all the modes, when a mode in which the approval of the proxy linking is omitted and the target user terminal 6A gives the data to the second terminal 5 is not adopted, the processing in step SD30 and step SA40A may be omitted.

In the 1-1-th proxy pattern explained above, in step SD10, at least one of an expiration date of proxy exercise and an authority (an effective authority) for permitting the proxy exercise may be designated together with the designation of the proxy user. In response to the designation, designation information configured to indicate at least one of the designated expiration date and the designated effective authority may be generated. The designation information of at least one of the designated expiration date and the effective authority may be managed as appropriate. In an example, the designation information may be transmitted from the target user terminal 6A to the first server 2 and managed in correlation with the first target information O10 (the user information O10A) in the first server 2. The first server 2 may notify the designation information to the management server 1 as appropriate. In another example, the designation information may be notified from the target user terminal 6A to the management server 1 through at least one of the first terminal 4A and the second terminal 5 (that is, together with the transmission of the data used for the authentication) and managed in correlation with the linking information D10 in the management server 1. In still another example, the designation information may be directly or indirectly transmitted from the target user terminal 6A to the management server 1 and managed in the management server 1. In this case, as in the mode of the divided transmission, the management server 1 may associate, as appropriate, the data used for the authentication received from at least one of the first terminal 4A and the second terminal 5 and the designation information. A method of the association may be the same as the method of the association in the mode of the divided transmission explained above. In an example, the data received from at least one of the first terminal 4A and the second terminal 5 and the designation information may include agent information as shared information. The association of the data used for the authentication and the designation information may be performed using the agent information. The agent information may be any information concerning the proxy user. The agent information may include, for example, attribute information (for example, personal information such as a name, an address, age, sex, and a contact) of the proxy user and identification information (for example, an account name and an identifier). The agent information may include specific information of the agent. The specific information may be configured by any information such as information deriving from targets, information deriving from terminals, temporarily generated information, and information generated by any other method. The information deriving from targets may be, for example, biological information and specifically imparted identification information. The biological information may be, for example, a face image, a fingerprint, or a voiceprint. The temporarily generated information may be the same as the time limit certificates (C10 and C20) explained above. The information generated by the any other method may include, for example, a password, a passcode, or information other than a symbol string. Note that timing for designating the effective authority and the expiration date may not be limited to step SD10. At least one of the effective authority and the expiration date may be designated at any timing until the correspondence relation is released.

In the 1-1-th proxy pattern explained above, the first terminal 4A may directly transmit the agent information to the management server 1 or may indirectly transmit the agent information via the external computer such as the second terminal 5. For example, the first terminal 4A may transmit the agent information to the management server 1 in step SB50. The first terminal 4A may give the agent information to the second terminal 5 in the data exchange and cause the second terminal 5 to transmit the agent information to the management server 1. Accordingly, the management server 1 may generate the linking information D10 including agent information to distinguish whether the set correspondence relation is a correspondence relation by proxy linking. Since the linking information D10 includes the agent information, it is possible to track the proxy user who has set the correspondence relation. A user capable of exercising the authority of the target user by proxy may be limited to a designated proxy user (a user identified by the agent information) using the agent information. Note that a method of distinguishing whether the correspondence relation is a correspondence relation by proxy linking may not be limited to such an example. In another example, whether the correspondence relation is requested by the proxy linking may be distinguishable as appropriate in data from the terminals (4 and 5). Accordingly, the management server 1 may generate the linking information D10 including information indicating whether the correspondence relation is the correspondence relation set by the proxy linking.

In the 1-1-th proxy pattern explained above, the second terminal 5 may acquire the agent information from the first terminal 4A. In the approval request for the proxy linking in step SD30, the second terminal 5 may notify the acquired agent information to the target user terminal 6A. Accordingly, it is possible to inform the target user of the proxy user who is executing the proxy linking. In addition, in step SD10, the target user terminal 6A may generate designated agent information indicating the designated agent. The agent information notified from the second terminal 5 may correspond to the designated agent information. The target user terminal 6A may collate the designated agent information and the agent information notified from the second terminal 5 to determine whether the proxy user who is executing the proxy linking and the designated proxy user coincide. When determining that the proxy user who is executing the proxy linking and the designated proxy user coincide, the target user terminal 6A may automatically give an approval notification of the proxy linking including the first certificate to the second terminal 5 or may permit operation of approval by the target user. Note that the second terminal 5 may not always acquire the agent information from the first terminal 4A. For example, the second terminal 5 may acquire, not with the first terminal 4A, the agent information from the proxy user with a method of, for example, imaging the proxy user with an image sensor. The collation of the proxy user and the notification of the approval including the first certificate C1 may not always executed by the target user terminal 6A. At least one of the collation of the proxy user and the notification of the approval may be executed by the external computer such as the first server 2.

Note that the designated agent information may include authentication information and the agent information may include agent authentication information corresponding to the authentication information. The authentication information may be the same as the specific information. In an example, the authentication information may be temporarily generated information configured by, for example, a timestamp, a random number, or a hash value. In this case, the authentication information may be generated as appropriate by the target user terminal 6A or the external computer when the agent is designated in step SD10. The target user terminal 6A may give the authentication information to the first terminal 4A at any timing such as step SD10. The first terminal 4A may retain the authentication information as the agent authentication information and give the agent information including the agent authentication information to the second terminal 5. According to collation of the authentication information and the agent authentication information, it may be determined whether the proxy user who is executing the proxy linking and the designated proxy user coincide. A method of collating the designated agent information and the agent information may be selected as appropriate according to an embodiment. In an example, success of the collation may be determined according to a degree of coincidence of the designated agent information and the agent information. A trained model generated by machine learning may be used for the collation. In the collation, the designated agent information and the agent information may be directly compared or may be indirectly compared after being converted into feature values or the like. In another example, the method of collating the designated agent information and the agent information may be the same as the method of collating the certificates explained above.

In the 1-1-th proxy pattern explained above, after the approval request is notified in step SD30, when the target user terminal 6A does not response within a fixed period, the second terminal 5 may notify a reminder to the target user terminal 6A and urge the target user terminal 6A to respond in step SA40A. In addition, the approval processing for the proxy linking by the designated agent information and the agent information may be executed not by the target user terminal 6A but by the external computer such as the first server 2. In this case, in the designation of the proxy user in step SD10, the designated agent information may be given to the external computer. When the target user terminal 6A does not respond, the second terminal 5 may inquire the external computer to substitute the approval processing. In addition, the first certificate C1 may also be given to the external computer. According to the proxy linking being approved, the second terminal 5 may acquire the first certificate C1 from the external computer.

In the 1-1-th proxy pattern explained above, the correspondence relation set according to the request for the proxy linking may be released as appropriate. As in the embodiment explained above, the management server 1 may be configured to release the correspondence relation according to reception of a release request from at least one of the first terminal 4A and the second terminal 5 or satisfaction of a predetermined release condition. The release request and the predetermined release condition according to the embodiment explained above may be applied in this modification as well. In addition, in this modification, the predetermined release condition may be set according to at least one of the expiration date and the effective authority of the agency explained above. For example, a release condition may be defined to release the correspondence relation according to arrival of a designated expiration date. The release condition may be defined to release the correspondence relation (that is, extinguish or disable the authority) by exercising the designated expiration date. When setting of correspondence relations for the target user overlaps because the target user is attempting setting of a correspondence relation with the object to be used in order to exercise the effective authority by himself or herself, the release condition may be defined to release the preceding correspondence relation by the proxy linking.

The management server 1 may be configured to release the correspondence relation in response to reception of the release request from the target user terminal 6A. The target user terminal 6A may directly transmit the release request to the management server 1 or may indirectly transmit the release request via the external computer such as the first server 2. As in the embodiment explained above, the release request from the target user terminal 6A may include at least one of the first identifier I10 and the second identifier I20 for designating release or may not include both of the first identifier I10 and the second identifier I20. When it has been identified whether the correspondence relation is the correspondence relation set by the proxy linking, the release request from the target user terminal 6A may not include the second identifier I20 and may include only the first identifier I10 to thereby designate release of the correspondence relation by the proxy linking designated by the first identifier I10.

In the 1-1-th proxy pattern explained above, after the setting processing for the correspondence relation by the proxy linking is completed, the controller 11 of the management server 1 may operate as the notification unit 114 and directly or indirectly transmit notification indicating an execution result of the setting processing by the proxy linking to at least one of the first terminal 4A, the second terminal 5, and the target user terminal 6A. When the notification is directly transmitted to the target user terminal 6A, the management server 1 may acquire a contact of the target user terminal 6A at any timing. In an example, when a mode in which data exchange of the contact of the target user terminal 6A is performed between the first terminal 4A and the second terminal 5 explained above is adopted, at least one of the first terminal 4A and the second terminal 5 may transmit the contact of the target user terminal 6A to the management server 1 in the linking request. When a mode in which the target user terminal 6A performs data communication with the management server 1 is adopted, in the data communication, the management server 1 may acquire the contact of the target user terminal 6A.

The processing procedure illustrated in FIG. 10 explained above is only an example. The steps may be changed as much as possible. Concerning the processing procedure explained above, steps can be omitted, substituted, and added as appropriate according to an embodiment. For example, when a mode in which the first certificate C1 is notified from the target user terminal 6A to the second terminal 5 by the processing in step SA40A is adopted, the processing in step SA10 to step SA20 may be executed at any timing before step SA40A. The processing in steps SB10 to SB20 may be executed at any timing before step SB40. Step SB50 may be executed at any timing after step SB40. When not on standby until completion of the approval of the proxy, the processing in step SB40 and step SB50 may be executed at any timing after the data exchange with the first terminal 4A is started. The processing in step SB40 and step SB50 may be executed before step SD20. The processing in step SB40 may be executed before step SD20 and the processing in step SB50 may be executed after step SD20. When a mode in which at least one of the first certificate C1 and the first identifier I10 is notified by the processing in step SA40A is adopted, the processing in step SA50 may be executed at any timing after step SA40A. The processing in step SA50 may be executed before step SB40.

### (1-2) 1-2-Th Proxy Pattern

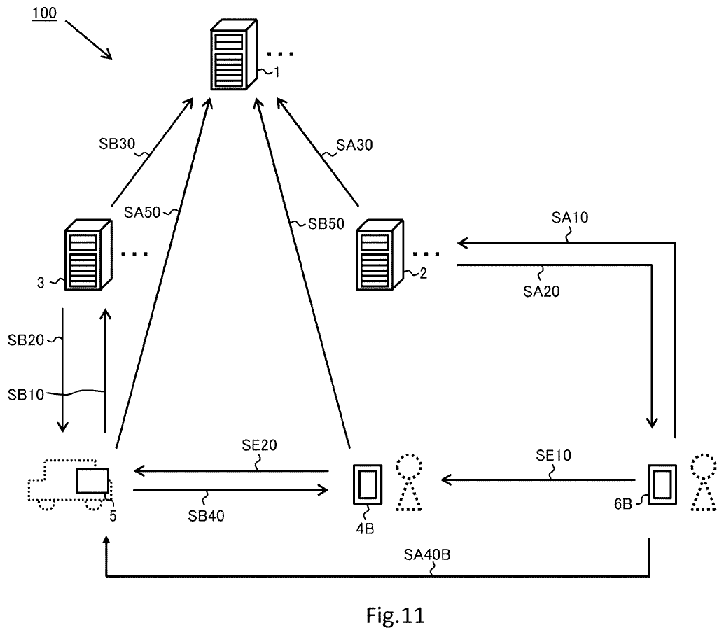

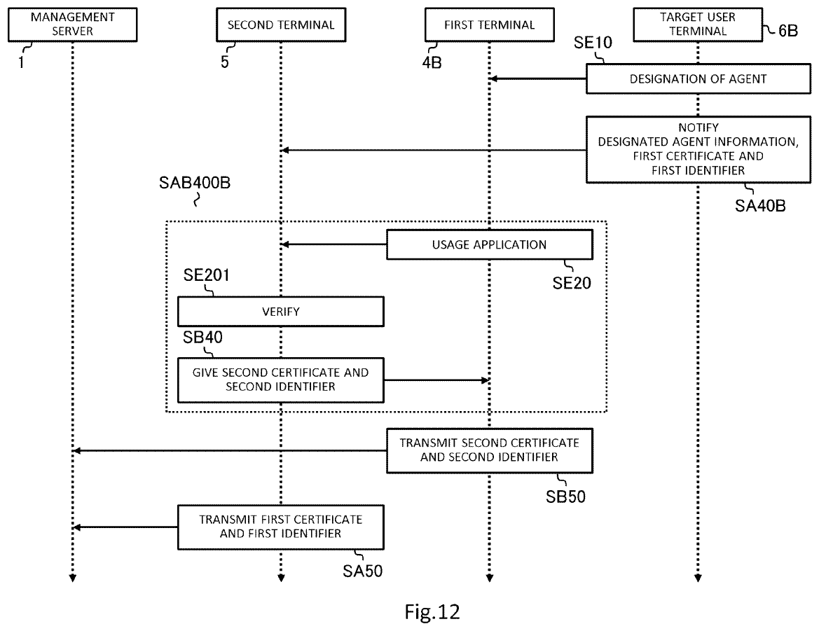

FIG. 11 schematically illustrates an example of a process of linking setting in a 1-2-th proxy pattern according to the present embodiment. FIG. 12 illustrates an example of a processing procedure of the linking setting in the 1-2-th proxy pattern according to the present embodiment. In the examples illustrated in FIG. 11 and FIG. 12, a first terminal 4B is a proxy user terminal and corresponds to the first terminal 4 in the examples illustrated in FIG. 2 and FIG. 5 in the embodiment explained above and the first terminal 4A of the 1-1-th proxy pattern. The first target is a target user (a proxy requester) who requests a proxy. A target user terminal 6B is a terminal carried by the target user and corresponds to the target user terminal 6A of the 1-1-th proxy pattern. Hardware configurations of the first terminal 4B and the target user terminal 6B may be the same as the hardware configurations of the first terminal 4 and the like in the embodiment explained above. In the examples illustrated in FIG. 11 and FIG. 12, a scene in which a mode of adopting the first pattern of the divided transmission as a transmission mode of data used for authentication and not transmitting the first identifier I10 and the first certificate C1 through the first terminal 4B is adopted is assumed.

First, the processing in step SA10 to step SA30 may be executed as in the embodiment explained above between the target user terminal 6B and the first server 2. As a result of the execution, the first time limit certificate C10 is issued and the issued first time limit certificate C10 is notified to the target user terminal 6B and the management server 1. Step SB10 to step SB30 may be executed as in the embodiment explained above between the second terminal 5 and the second server 3. As a result of the execution, the second time limit certificate C20 is issued and the issued second time limit certificate C20 is notified to the second terminal 5 and the management server 1.

In step SE10, a controller of the target user terminal 6B operates as a proxy designation unit and receives designation of the proxy user with respect to the target user. The controller of the target user terminal 6B operates as a notification unit, performs data exchange with the first terminal 4B of the proxy user designated by the target user, and notifies that an agency has been imparted. In response to the notification, a controller of the first terminal 4B of the proxy user receives the notification of the agency imparting from the target user terminal 6B. In an example, this notification may include authentication information. The authentication information may be the same as the authentication information in the 1-1-th proxy pattern. For example, the authentication information may be temporarily generated information. The first terminal 4B may retain the authentication information included in the received notification as agent authentication information. The other processing in step SE10 may be the same as step SD10 explained above. When data communication is adopted as a method of the data exchange, the notification of the agency imparting is an example of data communication between the target user terminal carried by the user and the proxy user terminal. Accordingly, the target user terminal 6B imparts an authority for authentication by proxy to the first terminal 4B and causes the first terminal 4B to execute processing for setting a correspondence relation between the first terminal 4B and an object to be used.

In step SA40B, the controller of the target user terminal 6B receives designation of an object to be used for which proxy linking by the proxy user is permitted. The object to be used for which the proxy linking is permitted may be designated as appropriate according to an embodiment. In an example, by causing the target user terminal 6B and the second terminal 5 to directly perform data exchange with a method such as short-range wireless communication, an object to be used of the second terminal 5, which is a counterparty of the data exchange, may be designated as the object to be used for which the proxy linking is permitted. In another example, the target user terminal 6B may access a list of objects to be used via an external computer and designate, from the objects to be used registered in the list, the object to be used for which the proxy linking is permitted. The list may include identification information of the objects to be used and information such as a contact of the second terminal 5. The list may be stored in the target user terminal 6B. The object to be used may be manually designated by the target user or may be designated by any information processing for, for example, selecting an object to be used corresponding to a condition. After the object to be used is designated, the controller of the target user terminal 6B operates as a data exchange unit and notifies designated agent information including authentication information, the first identifier I10, and the first certificate C1 corresponding to the issued first time limit certificate C10 to the second terminal 5 of the designated object to be used. The designated agent information may be acquired as appropriate according to the designation of the proxy user explained above. The designated agent information may be the same as the designated agent information in the 1-1-th proxy pattern explained above. Accordingly, the second terminal 5 of the designated object to be used receives the designated agent information including the authentication information, the first identifier I10, and the first certificate C1. Note that information concerning the designated object to be used may be give as appropriate from the target user terminal 6B or the external computer to the first terminal 4B in order for the proxy user to specify the designated object to be used. According to the processing in step SA40B, the target user terminal 6B causes the second terminal 5 of the designated object to be used to execute verification processing for authenticity of the proxy user corresponding to a use application for the object to be used, cooperate with the first terminal 4B of the proxy user, and transmit a request for linking setting to the management server 1.

In step SAB400B, the controller of the first terminal 4B of the proxy user, to whom the agency has been imparted, operates as a data exchange unit and executes data exchange with the second terminal 5 of the designated object to be used. The controller 51 of the second terminal 5 operates as the data exchange unit 512 and executes data exchange with the first terminal 4B. A method of the data exchange in step SAB400B may be the same as step SAB400A explained above. When data communication is adopted as the method of the data exchange, the data exchange between the first terminal 4B and the second terminal 5 is an example of data communication between the proxy user terminal and the loading terminal.

In step SE20, the controller of the first terminal 4B gives the agent information including the agent authentication information to the second terminal 5 to perform a use application for the object to be used. Accordingly, the first terminal 4B causes the second terminal 5 to verify authenticity of the agent and, according to success of the verification of the agent, causes the second terminal 5 to transmit a request for linking setting by the retained first identifier I10 and the retained certificate C1 to the management server 1.

In step SE201, the controller 51 of the second terminal 5 collates the agent information included in the use application and the designated agent information received from the target user terminal 6B to verify the authenticity of the proxy user (that is, executes authentication processing for the proxy user). The collating the agent information and the designated agent information includes collating the agent authentication information and the authentication information. The controller 51 of the second terminal 5 determines success of the verification of the proxy user according to a result of the collation. When the verification of the proxy user is successful, the controller 51 of the second terminal 5 permits use by the proxy user of the object to be used and enables the following processing concerning proxy linking. On the other hand, when the verification of the proxy user is unsuccessful, the processing procedure of the linking setting by the proxy authentication may end as appropriate.

In step SB40, as in the embodiment explained above, the controller of the second terminal 5 gives the second identifier I20 and the second certificate C2 to the first terminal 4B. The controller of the first terminal 4B acquires the second identifier I20 and the second certificate C2 from the object to be used as appropriate. Accordingly, the second terminal 5 may cause the first terminal 4B to transmit a request for linking setting including an authentication request configured by the second identifier I20 and the second certificate C2 to the management server 1.

In step SB50, the controller of the first terminal 4B operates as a setting requesting unit and transmits the request for the linking setting including the second identifier I20 and the second certificate C2 to the management server 1. In step SA50, the controller 51 of the second terminal 5 operates as the setting request unit 513 and transmits the request for the linking setting including the first identifier I10 and the first certificate C1 to the management server 1. In response to the transmission, the management server 1 receives the first identifier I10, the first certificate C1, the second identifier I20, and the second certificate C2.

Thereafter, as in the embodiment explained above, the management server 1 may execute the processing in step SC10 and subsequent steps. As a result of the execution, a correspondence relation between the target user (the first identifier I10) and the object to be used (the second identifier I20) is set according to both of the collations of the certificates (C1 and C2) and the time limit certificates (C10 and C20) being successful. When the correspondence relation is set, the processing procedure of the linking setting by the proxy authentication ends. While the correspondence relation is set, the proxy user can exercise the authority of the target user (the proxy requester) from the object to be used.

Note that, in the 1-2-th proxy pattern explained above, a notification route for the first identifier I10 and the first certificate C1 may not be limited to the example explained above. At least one of the first identifier I10 and the first certificate C1 may be given to the second terminal 5 through the first terminal 4B. In this case, at least one of the first identifier I10 and the first certificate C1 may be omitted from the data given to the second terminal 5 in step SA40B.

In the 1-2-th proxy pattern explained above, a transmission mode of the data used for the authentication may not be limited to the first pattern of the divided transmission and may be selected as appropriate according to an embodiment. In another example, as the transmission mode of the data used for the authentication, a mode other than the first pattern of the divided transmission (the second to fourth patterns of the divided transmission, the others of the divided transmission, or the collective transmission) among the transmission modes explained above may be adopted. Accordingly, the processing in step SE10, step SE20, step SA40B, step SA50, step SB40, and step SB50 may be changed as appropriate. When a mode in which the second terminal 5 transmits at least parts of the data (the first identifier I10 and the first certificate C1) of the target user is adopted, as explained above, the second terminal 5 may acquire the data of the target user through the first terminal 4B or may acquire the data of the target user from the target user (the target user terminal 6B) not through the first terminal 4B. When a mode in which the first terminal 4B transmits at least parts of the data of the target user is adopted, the first terminal 4B may acquire the data of the target user through the second terminal 5 or may acquire the data of the target user from the target user (the target user terminal 6B) not through the second terminal 5. For example, the first terminal 4B may acquire the data of the target user through the second terminal 5 on a route of step SA40B and step SB40. The first terminal 4B may acquire the data of the target user from the target user (the target user terminal 6B) not through the second terminal 5 on a route of step SE10. When a mode in which the first terminal 4B transmits at least parts of the data (the second identifier I20 and the second certificate C2) of the object to be used is adopted, as explained above, the first terminal 4B may acquire the data of the object to be used from the object to be used as appropriate. Similarly, the second terminal 5 may acquire the data of the object to be used as appropriate.

In the 1-2-th proxy pattern explained above, in the designation of the object to be used in step SA40B, typically, a specific individual may be designated. However, a method of designating the object to be used may not be limited to such an example. In another example, the object to be used may not be designated as the specific individual and may be designated in any range such as a range belonging to a specific operating institution. As an example in this case, data sent in advance such as the designated agent information may be retained in the external computer such as the first server 2. As pre-processing of step SE20, the second terminal 5 may download, from the external computer, data from the target user terminal 6B. The data to be downloaded may be selected as appropriate. For example, the target user may be designated by operation by the proxy user, data from the first terminal 4B, or the like. The second terminal 5 may download data corresponding to the designated target user. The target user may be designated as appropriate by the first identifier I10 or the like. After downloading the data, the second terminal 5 may receive a use application by the proxy user and execute processing in step SE201 and subsequent steps. Note that, when the object to be used is designated by the specific individual, the second terminal 5 may also download the data from the target user terminal 6B when the data is used by the proxy user. For example, when a use period of the object to be used by the proxy user is designated in advance, the second terminal 5 may download the data from the target user terminal 6B before arrival of the use period.

The processing procedure illustrated in FIG. 12 explained above is only an example. The steps may be changed as much as possible. Concerning the processing procedure explained above, steps can be omitted, substituted, and added as appropriate according to an embodiment. For example, when a mode in which the first certificate C1 is notified from the target user terminal 6B to the second terminal 5 by the processing in step SA40B is adopted, the processing in step SA10 to step SA20 may be executed at any timing before step SA40B. The processing in step SB10 to step SB20 may be executed at any timing before step SB40. The notification of the agency imparting in step SE10 may be executed after step SA40B. The processing in step SE10 and the processing in step SA40B may be at least partially executed in parallel. The processing in step SA40B may be executed before step SE10. The processing in step SA50 may be executed at any timing after step SE201. The processing in step SA20 may be executed before step SB40. The processing in step SA50 and the processing in step SB40 and step SB50 may be at least partially executed in parallel.

The configuration of the 1-1-th proxy pattern explained above may be applied as appropriate to a configuration other than the above of the 1-2-th proxy pattern. For example, in the 1-2-th proxy pattern as well, at least one of an expiration date of proxy exercise and an authority (an effective authority) for permitting the proxy exercise may be designated. The management server 1 may generate the linking information D10 including agent information. The management server 1 may generate the linking information D10 including information indicating whether a correspondence relation is a correspondence relation set by the proxy linking. A correspondence relation set in response to a request for the proxy linking may be released by the same method as the method in the 1-1-th proxy pattern explained above. The controller 11 of the management server 1 may transmit notification indicating an execution result of the setting processing by the proxy linking to at least any one of the first terminal 4B, the second terminal 5, and the target user terminal 6B.

### (2) Second Proxy Pattern

As a second proxy pattern, the management system 100 may be configured such that an agency is imparted to the proxy user but the authentication processing is performed by the target user. That is, the user terminal (in the example illustrated in FIG. 2, the first terminal 4) relating to the user may be a target user terminal carried by the target user. In an example, a use relation between the first target and the second target may occur when data communication is executed between the target user terminal and the loading terminal by being mediated by the proxy user terminal carried by the proxy user who represents the target user.

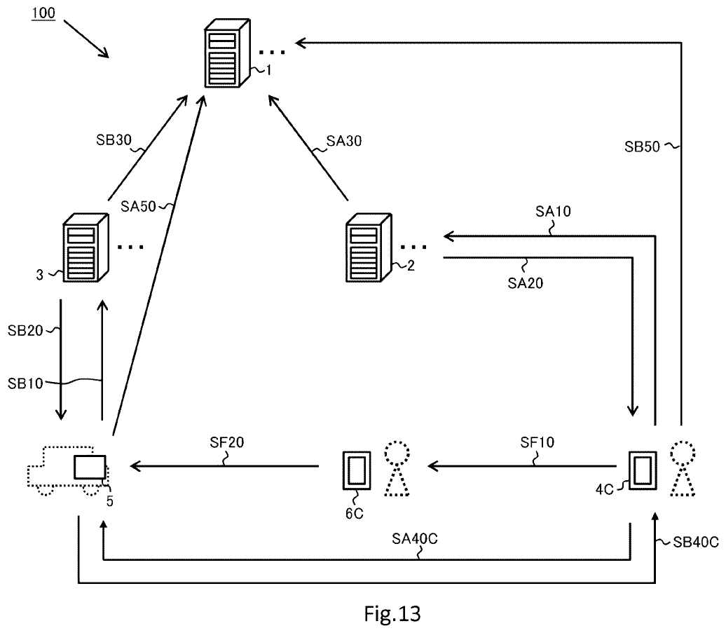

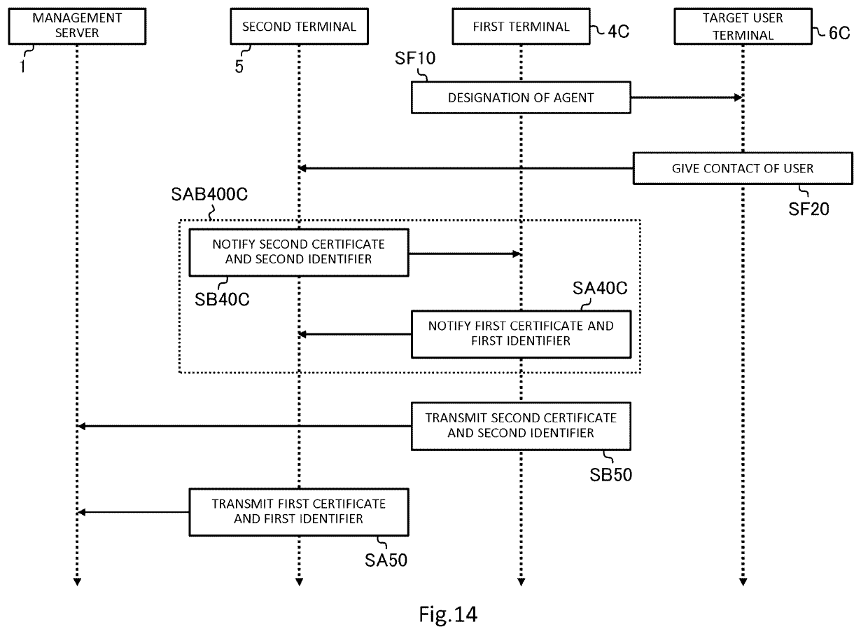

FIG. 13 schematically illustrates an example of a process of linking setting in the second proxy pattern according to the present embodiment. FIG. 14 illustrates an example of a processing procedure of the linking setting in the second proxy pattern according to the present embodiment. In FIG. 13 and FIG. 14, the first target is the target user (the proxy requester) who requests a proxy. A first terminal 4C is the target user terminal and corresponds to the first terminal 4 in the examples illustrated in FIG. 2 and FIG. 5 in the embodiment explained above. A proxy user terminal 6C is a terminal carried by the proxy user. The proxy user is an example of a proxy individual. The target user (the proxy requester) is an example of a proxy requesting individual (a target individual). Hardware configurations of the first terminal 4C and the proxy user terminal 6C may be the same as the hardware configurations of the first terminal 4 and the like in the embodiment explained above. In the examples illustrated in FIG. 13 and FIG. 14, a scene in which the first pattern of the divided transmission is adopted as a transmission mode of data used for authentication is assumed.

First, the processing in step SA10 to step SA30 may be executed as in the embodiment explained above between the first terminal 4C and the first server 2. As a result of the execution, the first time limit certificate C10 is issued and the issued first time limit certificate C10 is notified to the first terminal 4C and the management server 1. Step SB10 to step SB30 may be executed as in the embodiment explained above between the second terminal 5 and the second server 3. As a result of the execution, the second time limit certificate C20 is issued and the issued second time limit certificate C20 is notified to the second terminal 5 and the management server 1.

In step SF10, a controller of the first terminal 4C operates as a proxy designation unit and receives designation of the proxy user with respect to the target user. The designation of the proxy user may be performed as in step SD10 explained above. When the proxy user is designated, the controller of the first terminal 4C operates as a notification unit, performs data exchange with the proxy user terminal 6C of the designated proxy user, and notifies agency imparting. In response to the notification, the proxy user terminal 6C receives the notification of the agency imparting from the first terminal 4C. In an example, this notification may include a contact of the target user. As in the data exchange between the first terminal 4 and the second terminal 5, the data exchange between the proxy user terminal 6C and the first terminal 4C may be performed by wireless or wired data communication or may be performed by a method other than the data communication such as two-dimensional code reading. The first terminal 4C may directly give the notification of the agency imparting to the proxy user terminal 6C or may indirectly transmit the notification of the agency imparting via the external computer such as the first server 2. Accordingly, the first terminal 4C may cause the proxy user terminal 6C to execute mediation processing for the data exchange with the second terminal 5.

In step SF20, a controller of the proxy user terminal 6C operates as a data exchange unit and executes data exchange with the second terminal 5. The controller 51 of the second terminal 5 operates as the data exchange unit 512 and executes data exchange with the proxy user terminal 6C. Like the data exchange between the first terminal 4 and the second terminal 5 explained above, the data exchange between the proxy user terminal 6C and the second terminal 5 may be performed by wireless or wired data communication or may be performed by a method other than the data communication such as two-dimensional code reading. The controller of the proxy user terminal 6C gives a contact of the target user to the second terminal 5. Accordingly, the proxy user terminal 6C causes the second terminal 5 to start data exchange with the first terminal 4C and cooperate with the first terminal 4C to transmit a request for linking setting to the management server 1. The processing in step SF10 and step SF20 is an example of the proxy user terminal carried by the proxy user mediating.

In step SAB400C, the controller 51 of the second terminal 5 operates as the data exchange unit 512 and accesses a contact received from the proxy user terminal 6C to execute the data exchange with the first terminal 4C. The controller of the first terminal 4C operates as a data exchange unit and executes the data exchange with the second terminal 5 in response to access of the second terminal 5. Basically, the data exchange between the first terminal 4C and the second terminal 5 may be performed by wireless or wired data communication. However, the data exchange in step SAB400C does not always have to be performed by the data communication. In another example, the data exchange between the first terminal 4C and the second terminal 5 may be performed by a method other than data communication such as two-dimensional code reading. In this case, a contact of the target user may be omitted from the data in step SF10 and step SF20. The processing in step SF20 may be a mere trigger for the data exchange in step SAB400C.

The processing in step SA40C and step SB40C may be the same as the processing in step SA40 and step SB40 in the present embodiment. Step SA50 and step SB50 may be executed as in the embodiment and the like explained above. As a result of the execution, the management server 1 receives the first identifier I10, the first certificate C1, the second identifier I20, and the second certificate C2.

Thereafter, as in the embodiment explained above, the management server 1 may execute the processing in step SC10 and subsequent steps. According to both of the collations of the certificates (C1 and C2) and the time limit certificates (C10 and C20) being successful as a result of the execution, a correspondence relation between the target user (the first identifier I10) and the object to be used (the second identifier I20) is set. When the correspondence relation is set, the processing procedure of the linking setting by the second proxy pattern ends. While the correspondence relation is set, the proxy user can exercise an authority of the target user (the proxy requester) from the object to be used.

Note that the processing procedure illustrated in FIG. 14 explained above is only an example and may be changed as much as possible. Concerning the processing procedure explained above, steps can be omitted, substituted, and added as appropriate according to an embodiment. For example, the processing in step SA10 to step SA20 may be executed at any timing before step SA40C. The processing in step SB10 to step SB20 may be executed at any timing before step SB40C. The processing in step SB50 may be executed before step SA40C. When a mode in which the data exchange between the first terminal 4C and the second terminal 5 is performed by data communication is adopted, the processing in step SA40C and step SA50 may be executed at any timing after access from the second terminal 5. The processing in step SA40C and step SA50 may be executed at least partially executed in parallel to the processing in step SB40C and step SB50. At least a part of the processing in step SA40C and step SA50 may be executed before step SB50. The processing in step SA50 may be executed before step SB50. When the first terminal 4C and the second terminal 5 are connected before the processing in step SB40C, the processing in step SA40C and step SA50 may be executed before step SB40C.

The configuration of the embodiment explained above may be applied as appropriate to a configuration other than the above of the second proxy pattern. For example, as the transmission mode of the data used for the authentication, a mode other than the first pattern of the divided transmission (the second to fourth patterns of the divided transmission, the others of the divided transmission, or the collective transmission) among the transmission modes explained above may be adopted. Accordingly, the processing in step SA40C, step SA50, step SB40C, and step SB50 may be changed as appropriate.

As the configuration other than the above of the second proxy pattern, the configurations of the 1-1-th proxy pattern and the 1-2-th proxy pattern may be applied as appropriate. For example, in the second proxy pattern as well, at least one of the expiration date of the proxy exercise and the authority (the effective authority) for permitting the proxy exercise may be designated. The management server 1 may generate the linking information D10 including agent information. The management server 1 may generate the linking information D10 including information indicating whether a correspondence relation is a correspondence relation set by proxy linking. The agent information may be provided from the proxy user terminal 6C to the first terminal 4C through the second terminal 5 in step SB40C. Accordingly, the first terminal 4C may check whether the access of the second terminal 5 is access by mediation of the proxy user. The management server 1 may transmit notification indicating an execution result of the linking setting to at least any one of the first terminal 4C, the second terminal 5, and the proxy user terminal 6C. The set correspondence relation may be released by the same method as the method of the 1-1-th proxy pattern explained above. In another example, the management server 1 may be configured not to receive a release request from the proxy user terminal 6C. In still another example, the management server 1 may be configured to receive a release request from the proxy user terminal 6C through the first terminal 4C or the second terminal 5.

### (3) Third Proxy Pattern

In the first proxy pattern and the second proxy pattern, the exercise of the authority of the target user by the proxy user is enabled while the correspondence relation between the target user who requests a proxy and the object to be used is set. In contrast, as a third proxy pattern, the management system 100 may be configured to enable a target user to exercise an agency imparted by another user while a correspondence relation between the target user and the object to be used is set. That is, the management system 100 may be configured not to link the proxy requester and the object to be used but link a proxy user and the object to be used. In the third proxy pattern, a user terminal (in the example illustrated in FIG. 2, the first terminal 4) relating to the user may be a target user terminal carried by the user. An agency of another user other than the user may be correlated with, of the first identifier I10 and the second identifier I20, one identifier (in the example illustrated in FIG. 2, the first identifier I10) corresponding to the user.

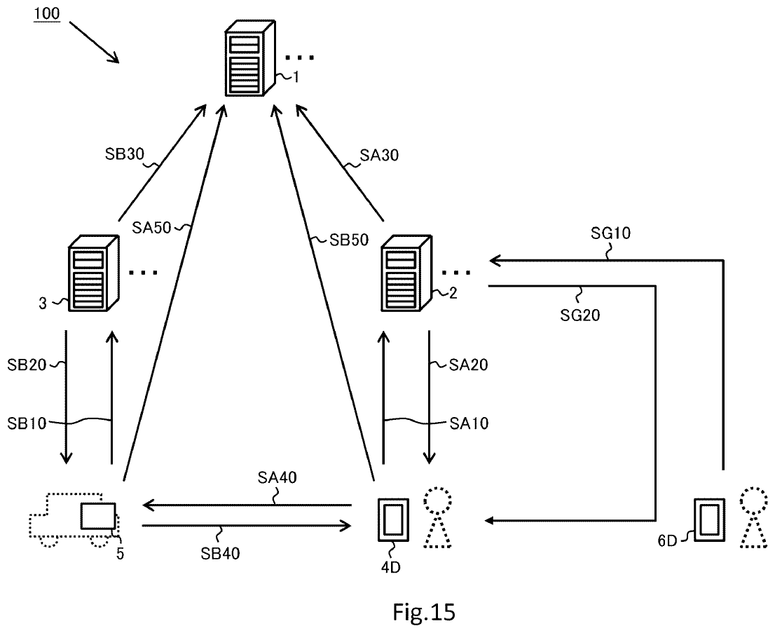

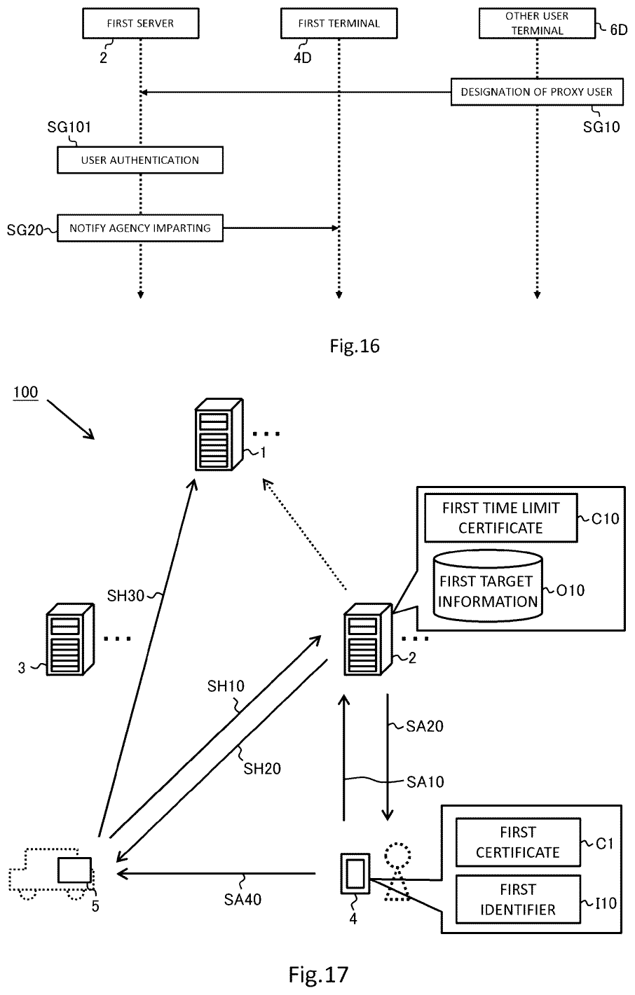

FIG. 15 schematically illustrates an example of a process of linking setting in the third proxy pattern according to the present embodiment. FIG. 16 illustrates an example of a processing procedure of agency imparting in the third proxy pattern according to the present embodiment. In FIG. 15 and FIG. 16, the first target is a target user to whom an agency is imparted. A first terminal 4D is a target user terminal and corresponds to the first terminal 4 in the examples illustrated in FIG. 2 and FIG. 5 in the embodiment explained above. Another user terminal 6D is a terminal carried by another user (a proxy requester) who requests a proxy to the target user. Typically, the other user is a user different from the target user having an account in the same service (the first server 2) as the target user. The target user is an example of a proxy individual and the other user (the proxy requester) is an example of a proxy requesting individual (another individual). Hardware configurations of the first terminal 4D and the other user terminal 6D may be the same as the hardware configurations of the first terminal 4 and the like in the embodiment explained above.

First, in step SG10, a controller of the other user terminal 6D operates as a proxy designation unit and receives designation of a proxy user with respect to the proxy requester (the other user). The designation of the proxy user may be performed as in step SD10 and the like explained above.

In step SG101, the controller of the other user terminal 6D accesses the first server 2. The controller 21 of the first server 2 operates as an authentication unit and executes user authentication for the other user terminal 6D from which the access is received. The user authentication may be performed as appropriate. Typically, authentication processing in step SG101 is login processing. When the authentication is successful, in response to a request from the other user terminal 6D, the controller 21 of the first server 2 imparts an agency to the target user designated as the proxy user. The imparting of the agency may be expressed in any data format. In an example, as processing for agency imparting, the controller 21 may correlate information concerning the proxy requester (for example, an identifier of the proxy requester) with the user information O10A of the target user designated as the proxy user. The correlating the information concerning the proxy requester with the user information O10A of the target user is an example of correlating an agency of the other user other than the target user with the first identifier I10 of the target user. The management system 100 may be configured as appropriate to enable exercise of an authority by a proxy mode because the information concerning the proxy requester is correlated.

In step SG20, the controller 21 of the first server 2 transmits, to the first terminal 4D of the target user designated as the proxy user, notification for informing that the agency of the other user has been imparted. The controller 21 may directly transmit the notification of the agency imparting to the first terminal 4D or may indirectly transmit the notification of the agency imparting via an external computer such as the other user terminal 6D. When the notification of the agency imparting is completed, the processing procedure of the agency imparting in the third proxy pattern ends. In an example, the first terminal 4D may execute, with the target user, irrelevantly to the processing of the agency imparting illustrated in FIG. 16, linking processing for setting a correspondence relation with the object to be used. In another example, the linking processing may be executed with the notification of the agency imparting as a trigger. The processing from step SA10 and step SB10 may be executed before the processing in step SG10 to step SG20 of the agency imparting, may be at least partially executed in parallel to the processing in step SG10 to step SG20 of the agency imparting, or may be executed after the processing in step SG10 to step SG20 of the agency imparting. A series of processing for setting a correspondence relation between the target user (the first terminal 4D) and the object to be used (the second terminal 5) from step SA10 and step SB10 may be the same as the processing in the embodiment explained above. A correspondence relation between the target user and the object to be used is set according to both of the authentications of the target user and the object to be used (collations of the certificates) being successful as a result of executing the linking processing. When the correspondence relation is set, the processing procedure of the linking setting by the third proxy pattern ends. While the correspondence relation is set, the target user (the proxy user) can exercise the authority of the other user (the proxy requester) from the object to be used.

Note that the processing procedure illustrated in FIG. 16 explained above is only an example. The steps may be changed as much as possible. Concerning the processing procedure explained above, steps can be omitted, substituted, and added as appropriate according to an embodiment. For example, when a mode in which a list of users is retained to be accessible from the first server 2 and designation of the proxy user is performed on the first server 2 is adopted, the processing in step SG10 may be executed in the first server 2 via the other user terminal 6D after the other user terminal 6D accesses the first server 2. In this case, the processing in step SG101 may be executed before step SG10.

The configuration of the 1-1-th proxy pattern and the like may be applied as appropriate to a configuration other than the above of the third proxy pattern. For example, in the third proxy pattern as well, the management server 1 may generate the linking information D10 including agent information. At least one of the expiration date of the proxy exercise and the authority (the effective authority) for permitting the proxy exercise may be designated. In this case, the agency imparted by the other user may be extinguished according to arrival of the designated effective authority. The imparted agency may be extinguished by exercise of the designated effective authority. The first server 2 may be configured to delete, in response to a request from the other user (the proxy requester), the agency imparted from the other user.

In the third proxy pattern, in the processing in step SG10 to step SG20, the first server 2 may issue a time limit certificate to the other user in relation to the agency imparting. An expiration date of the time limit certificate may be set according to the expiration date of the agency. The time limit certificate may be notified to at least one of the first terminal 4D and the management server 1. When the agency is exercised, authentication by the time limit certificate may be performed at any timing. For example, the time limit certificate of the other user may be included in the notification of the agency imparting. The target user may give, to the external system SY1, with any method, a certificate corresponding to the time limit certificate included in the notification of the agency imparting. The external system SY1 may send the certificate to the management server 1 or the first server 2 and request collation with the time limit certificate. When the collation of the time limit certificate and the certificate is successful, the external system SY1 may permit the proxy exercise of the target authority.

### (Characteristics)

According to this modification, the users can exercise the authority of the proxy requester by proxy via the object to be used. Accordingly, it is possible to improve extensibility of the authority exercise. For example, a scene in which the authority information includes information concerning an electronic prescription and the target authority is reception of a drug prescribed by the electronic prescription is assumed. In this case, even if the user does not go for the prescribed drug by himself or herself, by imparting an agency to another user such as a driver of a taxi, the user can request, via a mobile body, the other user to receive the prescribed drug.

<4.2>

In the embodiment explained above, the collations of the certificates (C1 and C2) and the time limit certificates (C10 and C20) (the authentications of the targets) are executed by the management server 1. However, an entity that executes the collation processing may not be limited to the management server 1. In another example, the management server 1 may transmit the certificates (C1 and C2) to the servers (2 and 3) to request the servers (2 and 3) to perform the collation processing. Accordingly, the collation processing may be executed by the servers (2 and 3).

In the embodiment explained above, the authentication processing for the first target and the second target is executed according to the request for the linking setting from at least one of the first terminal 4 (4A to 4D) and the second terminal 5. However, timing for executing the authentication processing may not be limited to such an example. Before the request for the linking setting is transmitted to the management server 1, the authentication processing for the targets may be executed with the servers (2 and 3) in advance by at least one of the first terminal 4 (4A to 4D) and the second terminal 5. The authentication processing for one of the first target and the second target may be omitted.

For example, a management system may include a first server and a management server. The first server may be configured to issue a first time limit certificate in relation to a first identifier of a first target, transmit the issued first time limit certificate to a first terminal of the first target, and, according to a use relation occurring between the first target and a second target, receive a first certificate corresponding to the first time limit certificate from a second terminal of the second target, collate the received first certificate and the issued first time limit certificate, and return a result of the collation to the second terminal. The first time limit certificate may be configured to expire when an expiration date elapses. The management server may be configured to, when the collation is successful, set a correspondence relation between the first identifier and a second identifier in response to a request from the second terminal.

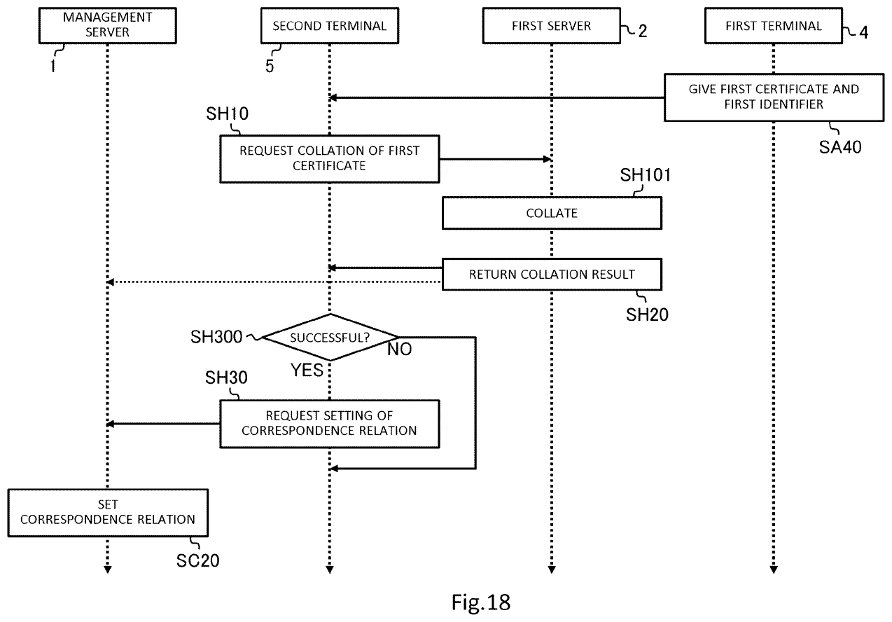

FIG. 17 schematically illustrates an example of a process of linking setting according to this example. FIG. 18 illustrates an example of a processing procedure of the linking setting according to this modification. In the examples illustrated in FIG. 17 and FIG. 18, a scene in which a mode of executing the authentication processing for the first target and omitting the authentication processing for the second target is adopted is assumed.

First, the processing in step SA10 and step SA20 may be executed as in the embodiment explained above between the first terminal 4 and the first server 2. As a result of the execution, the first time limit certificate C10 is issued and the issued first time limit certificate C10 is notified to the first terminal 4. At this time, the first server 2 may store the issued first time limit certificate C10 in correlation with the first identifier I10 (the first target information O10 of the first target corresponding thereto). That is, the first time limit certificate C10 may be stored as the first target information O10. The notification to the management server 1 (step SA30) may be omitted. In step SA40, the controller 41 of the first terminal 4 operates as the data exchange unit 412 and gives the issued first time limit certificate C10 to the second terminal 5 as the first certificate C1. The controller 41 gives the first identifier I10 to the second terminal 5. Accordingly, the controller 51 of the second terminal 5 acquires the first identifier I10 and the first certificate C1 from the first target as appropriate. A method of acquiring the first identifier I10 and the first certificate C1 may be the same as the method in the embodiment explained above.

In step SH10, the controller 51 of the second terminal 5 operates as an authentication request unit and transmit an authentication request including the first identifier I10 and the first certificate C1 to the first server 2. In step SH101, in response to reception of the authentication request, the controller 21 of the first server 2 operates as a collation unit and collates the received first certificate C1 and the first time limit certificate C10 corresponding thereto. The corresponding first time limit certificate C10 may be acquired as appropriate. In an example, the issued first time limit certificate C10 may be stored as the first target information O10. The controller 21 may search through the first target information O10 using the first identifier I10 as a query to extract the corresponding first time limit certificate C10. In step SH20, the controller 21 operates as the notification unit 212 and returns a result of the collation to the second terminal 5. In response to the return, the controller 51 of the second terminal 5 receives the result of the collation.

In step SH300, the controller 51 determines whether the collation of the first certificate C1 and the first time limit certificate C10 is successful in the received result of the collation. When the collation is successful, the controller 51 advances the processing to the next step SH30. On the other hand, when the collation is unsuccessful, the controller 51 may omit the processing in step SH30 and end the processing procedure of the linking setting according to this modification as appropriate.

In step SH30, the controller 51 operates as the setting requesting unit 513 and transmits a request for linking setting including the first identifier I10 and the second identifier I20 to the management server 1. In response to the transmission, the management server 1 receives the request for the linking setting from the second terminal 5. In step SC20, the controller 11 of the management server 1 operates as the setting unit 112 and sets a correspondence relation (linking) between the first identifier I10 and the second identifier I20 designated by the request for the linking setting. After setting the correspondence relation, the controller 11 may operate as the notification unit 114 and transmit notification indicating a processing result of the linking setting to the second terminal 5. When the linking setting is completed, the processing procedure of the linking setting according to this modification ends.

Note that, in this modification, the management server 1 may verify, as appropriate, that the collation is successful in the first server 2. In an example, the controller 21 of the first server 2 may transmit the result of the collation to the management server 1 as well. For example, the second identifier I20 may be further included in the authentication request. When the collation is successful, the controller 21 may transmit the result of the collation including the first identifier I10 and the second identifier I20 to the management server 1. Accordingly, the controller 21 may cause the management server 1 to enable a request for linking setting for a combination of the first identifier I10 and the second identifier I20 designated in the result of the collation. That is, in an example, the verification of the collation success may be configured by reception of the collation result. The management server 1 may be configured to retain the result of the collation from the first server 2, receive a request for linking setting for a combination of the first identifier I10 and the second identifier I20 designated by the result of the collation, and discard a request for the other linking setting.

In the present embodiment, a target to be authenticated may not be limited to the first target. In another example, authentication processing for the second target may be executed instead of the authentication processing for the first target. In still another example, the authentication processing for the second target may be executed together with the authentication processing for the first target.

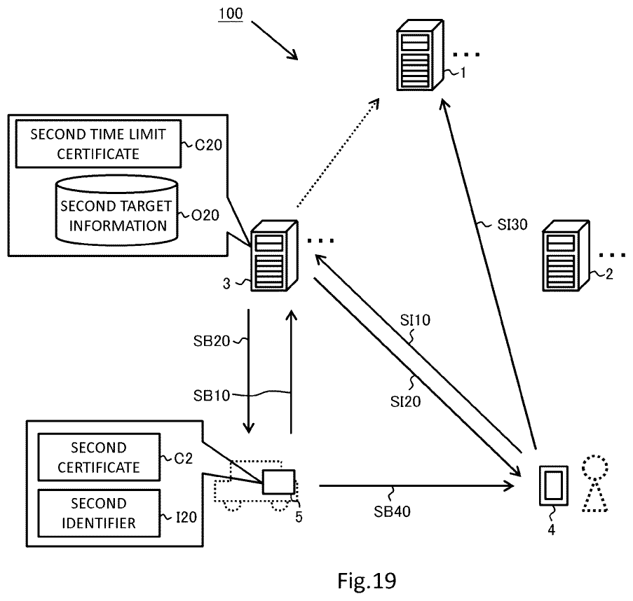

FIG. 19 schematically illustrates another example of a process of linking setting according to this modification. In the example illustrated in FIG. 19, a scene in which a mode of executing the authentication processing on the second target instead of the authentication processing for the first target is adopted is assumed. A processing procedure illustrated in FIG. 19 may be the same as the processing procedure illustrated in FIG. 17 except that the first target and the second target are changed. That is, the processing in step SB10 and step SB20 is executed between the second terminal 5 and the second server 3, whereby the second time limit certificate C20 is issued and the issued second time limit certificate C20 is notified to the second terminal 5. In step SB40, the controller 51 of the second terminal 5 gives the issued second time limit certificate C20 to the first terminal 4 as the second certificate C2. The controller 51 gives the second identifier I20 to the first terminal 4. In step SI10, the controller 41 of the first terminal 4 transmits an authentication request including the second identifier I20 and the second certificate C2 to the second server 3. In response to the transmission, the controller 31 of the second server 3 executes collation processing for the second certificate C2 and the second time limit certificate C20. In step SI20, the controller 31 returns a result of the collation to the first terminal 4. When the collation of the second certificate C2 and the second time limit certificate C20 is successful in the result of the collation, the controller 41 of the first terminal 4 transmits a request for linking setting including the first identifier I10 and the second identifier I20 to the management server 1. In response to the transmission, the controller 11 of the management server 1 sets a correspondence relation between the first identifier I10 and the second identifier I20 designated by the request for the linking setting. In another example, authentication processing for the first target and the second target may be executed by a series of processing illustrated in FIG. 17 and FIG. 19 being executed.

### (Characteristics)

In this modification, the authentication processing is executed before the request for the linking setting. Accordingly, it is possible to reduce a processing load of the management server 1. It is possible to reduce a processing time from the request for the linking setting to the setting (generation of the linking information D10).

### 5 Supplement

The processing and the means explained in the present disclosure can be freely combined and carried out as long as a technical contradiction does not occur.

The processing explained as being performed by one device may be shared and executed by a plurality of devices. Alternatively, the processing explained as being performed by different devices may be executed by one device. In a computer system, it is possible to flexibly change what kinds of hardware configurations are used to implement respective functions.

The present disclosure can also be implemented by supplying a computer program implemented with the functions explained in the embodiment to a computer and one or more processors included in the computer reading out and executing the program. Such a computer program may be provided to the computer by a non-transitory computer-readable storage medium connectable to a system bus of the computer or may be provided to the computer via a network. The non-transitory computer-readable storage medium includes, for example, disks/discs of any types such as a magnetic disk (a floppy (registered trademark) disk, a hard disk drive (HDD), and the like), and an optical disc (a CD-ROM, a DVD disc, a Blu-ray disc, and the like), a read only memory (ROM), a random access memory (RAM), an EPROM, an EEPROM, a magnetic card, a flash memory, an optical card, a semiconductor drive (a solid state drive and the like), and a medium of any type suitable for storing an electronic instruction.

What is claimed is:

1. A system comprising:
a first server;
a second server; and
a third server, wherein
the first server is configured to:
issue a first time limit certificate in relation to a first identifier; and
notify the issued first time limit certificate to the third server,
the second server is configured to:
issue a second time limit certificate in relation to a second identifier; and
notify the issued second time limit certificate to the third server,
the third server is configured to:
receive a first certificate corresponding to the first time limit certificate and a second certificate corresponding to the second time limit certificate from at least a first terminal of the first target and a second terminal of the second target;
collate the received first certificate and the received second certificate and the first time limit certificate and the second time limit certificate notified from the first server and the second server; and
activate a correspondence relation between the first identifier and the second identifier when the collation is successful, and
the first time limit certificate and the second time limit certificate are configured to expire when an expiration date elapses.

2. A management system comprising:
a first server;
a second server; and
a management server, wherein
the first server is configured to:
issue a first time limit certificate in relation to a first identifier of a first target; and
notify the issued first time limit certificate to the management server,
the second server is configured to:
issue a second time limit certificate in relation to a second identifier of a second target; and
notify the issued second time limit certificate to the management server,
the management server is configured to:
according to a use relation occurring between the first target and the second target, receive a first certificate corresponding to the first time limit certificate and a second certificate corresponding to the second time limit certificate from at least a first terminal of the first target and a second terminal of the second target;
collate the received first certificate and the received second certificate and the first time limit certificate and the second time limit certificate notified from the first server and the second server; and
set a correspondence relation between the first identifier and the second identifier when the collation is successful, and
the first time limit certificate and the second time limit certificate are configured to expire when an expiration date elapses.

3. The management system according to claim 2, wherein the management server is further configured to release the correspondence relation according to reception of a release request from at least one of the first terminal and the second terminal or satisfaction of a predetermined release condition.

4. The management system according to claim 2, wherein the receiving the first certificate and the second certificate from at least one of the first terminal and the second terminal includes receiving the first identifier and the second identifier from at least one of the first terminal and the second terminal.

5. The management system according to claim 4, wherein the receiving the first certificate and the second certificate from at least one of the first terminal and the second terminal is configured by:
receiving the second certificate and the second identifier from the first terminal; and
receiving the first certificate and the first identifier from the second terminal.

6. The management system according to claim 4, wherein the receiving the first certificate and the second certificate from at least one of the first terminal and the second terminal is configured by:
receiving the second certificate and the first identifier from the first terminal; and
receiving the first certificate and the second identifier from the second terminal.

7. The management system according to claim 4, wherein the receiving the first certificate and the second certificate from at least one of the first terminal and the second terminal is configured by:
receiving the first certificate and the second identifier from the first terminal; and
receiving the second certificate and the first identifier from the second terminal.

8. The management system according to claim 2, wherein the receiving the first certificate and the second certificate from at least one of the first terminal and the second terminal is configured by receiving the first certificate and the second certificate from one of the first terminal and the second terminal.

9. The management system according to claim 2, wherein
one of the first target and the second target is a user,
of the first terminal and the second terminal, one terminal corresponding to the user is a user terminal relating to the user,
another of the first target and the second target is an object to be used by the user, and
of the first terminal and the second terminal, one terminal corresponding to the object to be used is a loading terminal loaded on the object to be used.

10. The management system according to claim 9, wherein the object to be used is a mobile body.

11. The management system according to claim 9, wherein the user terminal relating to the user is a proxy user terminal carried by a proxy user who represents the user.

12. The management system according to claim 11, wherein the use relation between the first target and the second target occurs through data communication between a target user terminal carried by the user and the proxy user terminal and data communication between the proxy user terminal and the loading terminal.

13. The management system according to claim 9, wherein the use relation between the first target and the second target occurs when data communication between a target user terminal carried by the user and the loading terminal is executed according to mediation of a proxy user terminal carried by a proxy user representing the user.

14. The management system according to claim 9, wherein
the user terminal relating to the user is a target user terminal carried by the user, and
an agency of another user other than the user is correlated with, of the first identifier and the second identifier, one identifier corresponding to the user.

15. A management method comprising a management server executing:
receiving, from a first server, a first time limit certificate issued in relation to a first identifier of a first target, the first time limit certificate being configured to expire when an expiration date elapses;
receiving, from a second server, a second time limit certificate issued in relation to a second identifier of a second target, the second time limit certificate being configured to expire when the expiration date elapses;
receiving, according to a use relation occurring between the first target and the second target, a first certificate corresponding to the first time limit certificate and a second certificate corresponding to the second time limit certificate from at least one of a first terminal of the first target and a second terminal of the second target;
collating the received first certificate and the received second certificate and the first time limit certificate and the second time limit certificate notified from the first server and the second server; and
setting, when the collation is successful, a correspondence relation between the first identifier and the second identifier.

16. The management method according to claim 15, further comprising the management server releasing the correspondence relation according to reception of a release request from at least one of the first terminal and the second terminal or satisfaction of a predetermined release condition.

17. The management method according to claim 15, wherein
the receiving the first certificate and the second certificate from at least one of the first terminal and the second terminal is configured by:
receiving the second certificate and the second identifier from the first terminal; and
receiving the first certificate and the first identifier from the second terminal.

18. The management method according to claim 15, wherein the receiving the first certificate and the second certificate from at least one of the first terminal and the second terminal is configured by:
receiving the second certificate and the first identifier from the first terminal; and
receiving the first certificate and the second identifier from the second terminal.

19. The management method according to claim 15, wherein the receiving the first certificate and the second certificate from at least one of the first terminal and the second terminal is configured by:
receiving the first certificate and the second identifier from the first terminal; and
receiving the second certificate and the first identifier from the second terminal.

20. The management method according to claim 15, wherein
one of the first target and the second target is a user,
of the first terminal and the second terminal, one terminal corresponding to the user is a user terminal relating to the user,
another of the first target and the second target is an object to be used by the user, and
of the first terminal and the second terminal, one terminal corresponding to the object to be used is a loading terminal loaded on the object to be used.
